(19) United States
(12) Patent Application Publication
(10) Pub. No.: US 2026/0246949 A1
(43) Pub. Date: Aug. 20, 2026

(54) ENCODING METHOD, DECODING METHOD, ENCODER, DECODER AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/641,260

(22) Filed: Apr. 7, 2026

Related U.S. Application Data
(63) Continuation of application No. PCT/CN2023/123639, filed on Oct. 9, 2023.

(51) Int. Cl. H04N 19/159; H04N 19/103; H04N 19/30; H04N 19/503; H04N 19/593; H04N 19/597; H04N 19/60; H04N 19/70

(52) U.S. Cl. CPC H04N 19/159; H04N 19/103; H04N 19/30; H04N 19/503; H04N 19/593; H04N 19/597; H04N 19/60; H04N 19/70

(57) ABSTRACT

Disclosed in the present application is a decoding method, which includes: decoding a bitstream to determine a first syntax element flag; in a case of determining, according to the first syntax element flag, to enable a mode selection when RAHT decoding is performed on a current layer, determining neighborhood geometry distribution information of a node of the current layer; in response to the neighborhood geometry distribution information meeting a first prediction condition, determining neighborhood attribute distribution information of the node of the current layer; determining a target decoding mode of the node of the current layer from candidate decoding modes according to the neighborhood attribute distribution information; and performing attribute decoding on the node of the current layer according to the target decoding mode, to determine an attribute reconstructed value of the node of the current layer.

### CROSS-REFERENCE TO RELATED APPLICATION

This application is a Continuation application of International Application No. PCT/CN2023/123639 filed on Oct. 9, 2023, which is incorporated herein by reference in its entirety.

### TECHNICAL FIELD

Embodiments of the present disclosure relate to the technical field of point cloud encoding and decoding, and in particular, to an encoding method, a decoding method, an encoder, a decoder, and a storage medium.

### RELATED ART

In the geometry-based point cloud compression (G-PCC) codec framework provided by the moving picture experts group (MPEG), geometry information and attribute information of a point cloud are encoded separately. The attribute encoding of G-PCC may include: predicting transform (PT), lifting transform (LT), and region adaptive hierarchical transform (RAHT). The first two perform predictive encoding on the point cloud based on the generation order of level of detail (LOD), whereas the RAHT performs an adaptive transform on the attribute information from the bottom to top based on the construction hierarchy of the octree.

In G-PCC attribute RAHT encoding, syntax element in an attribute parameter set (APS) may be used to determine whether to use a predictive encoding scheme to perform intra prediction on an attribute of a current sequence. However, in the attribute encoding scheme, attribute encoding is performed without considering distribution characteristics of the attribute of each node itself, thereby resulting in relatively low intra encoding efficiency of point cloud attributes.

### SUMMARY OF THE INVENTION

Embodiments of the present disclosure provide an encoding method, a decoding method, an encoder, a decoder, and a storage medium.

The technical solutions of the embodiments of the present disclosure can be implemented as follows.

In a first aspect, the embodiments of the present disclosure provide a decoding method, which is applied to a decoder and includes:
decoding a bitstream to determine a first syntax element flag;
in a case of determining, according to the first syntax element flag, to enable a mode selection when region adaptive hierarchical transform decoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target decoding mode of the node of the current layer from candidate decoding modes according to the neighborhood attribute distribution information, where the candidate decoding modes include: an attribute prediction and transform mode, and an attribute transform mode; and
performing attribute decoding on the node of the current layer according to the target decoding mode, to determine an attribute reconstructed value of the node of the current layer.

In a second aspect, the embodiments of the present disclosure provide an encoding method, which is applied to an encoder and includes:
determining a first syntax element flag;
in a case of determining, according to the first syntax element flag, to enable a mode selection when region adaptive hierarchical transform encoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target encoding mode of the node of the current layer from candidate encoding modes according to the neighborhood attribute distribution information, where the candidate encoding modes include: an attribute prediction and transform mode, and an attribute transform mode;
performing attribute encoding on the node of the current layer according to the target encoding mode, to determine an attribute reconstructed value of the node of the current layer; and
encoding the first syntax element flag, and signalling obtained encoded bits into a bitstream.

In a third aspect, the embodiments of the present disclosure provide an encoder, where the encoder includes a first determination unit, a second determination unit, and an encoding unit; where
the first determination unit is configured to determine a first syntax element flag;
the first determination unit is further configured to: in a case of determining, according to the first syntax element flag, to enable a mode selection when region adaptive hierarchical transform encoding is performed on a current layer, determine neighborhood geometry distribution information of a node of the current layer;
the first determination unit is further configured to: in response to the neighborhood geometry distribution information meeting a first prediction condition, determine neighborhood attribute distribution information of the node of the current layer;
the second determination unit is configured to determine a target encoding mode of the node of the current layer from candidate encoding modes according to the neighborhood attribute distribution information, where the candidate encoding modes include: an attribute prediction and transform mode, and an attribute transform mode;
the second determination unit is configured to: perform attribute encoding on the node of the current layer according to the target encoding mode, to determine an attribute reconstructed value of the node of the current layer; and
the encoding unit is configured to encode the first syntax element flag, and signal obtained encoded bits into a bitstream.

In a fourth aspect, the embodiments of the present disclosure provide an encoder, where the encoder includes a first memory and a first processor; where
the first memory is configured to store a computer program executable on the first processor; and
the first processor is configured to, when executing the computer program, perform the method as described in the second aspect.

In a fifth aspect, the embodiments of the present disclosure provide a decoder, where the decoder includes a decoding unit, a third determination unit, and a fourth determination unit; where
the decoding unit is configured to decode a bitstream to determine a first syntax element flag;
the third determination unit is configured to: in a case of determining, according to the first syntax element flag, to enable a mode selection when region adaptive hierarchical transform decoding is performed on a current layer, determine neighborhood geometry distribution information of a node of the current layer;
the third determination unit is further configured to: in response to the neighborhood geometry distribution information meeting a first prediction condition, determine neighborhood attribute distribution information of the node of the current layer;
the fourth determination unit is configured to determine a target decoding mode of the node of the current layer from candidate decoding modes according to the neighborhood attribute distribution information, where the candidate decoding modes include: an attribute prediction and transform mode, and an attribute transform mode; and
the fourth determination unit is further configured to perform attribute decoding on the node of the current layer according to the target decoding mode, to determine an attribute reconstructed value of the node of the current layer.

In a sixth aspect, the embodiments of the present disclosure provide a decoder, where the decoder includes a second memory and a second processor; where
the second memory is configured to store a computer program executable on the second processor; and
the second processor is configured to, when executing the computer program, perform the method as described in the first aspect.

In a seventh aspect, the embodiments of the present disclosure provide a non-transitory computer-readable storage medium, where the non-transitory computer-readable storage medium stores a bitstream generated according to the encoding method.

In an eighth aspect, the embodiments of the present disclosure provide a non-transitory computer-readable storage medium, which stores a computer program, where the computer program, when executed, implements the method as described in the first aspect or the method as described in the second aspect.

### BRIEF DESCRIPTION OF THE DRAWINGS

FIG. 1A is a schematic diagram of a three-dimensional point cloud picture.

FIG. 1B is a partially enlarged diagram of a three-dimensional point cloud picture.

FIG. 2A is a schematic diagram of a point cloud picture at six viewing angles.

FIG. 2B is a schematic diagram of a data storage format corresponding to a point cloud picture.

FIG. 3 is a schematic diagram of network architecture for point cloud encoding and decoding.

FIG. 4A is a schematic diagram of a composition framework of a G-PCC encoder.

FIG. 4B is a schematic diagram of a composition framework of a G-PCC decoder.

FIG. 5A is a schematic diagram of a low planar position in a Z-axis direction.

FIG. 5B is a schematic diagram of a high planar position in a Z-axis direction.

FIG. 6 is a schematic diagram of a node encoding sequence.

FIG. 7A is a schematic diagram of planar flag information.

FIG. 7B is another schematic diagram of planar flag information.

FIG. 8 is a schematic diagram of sibling nodes of a current node.

FIG. 9 is a schematic diagram of an intersection of a laser radar (LiDAR) and a node.

FIG. 10 is a schematic diagram of a neighborhood node at the same partitioning depth and the same coordinate.

FIG. 11 is a schematic diagram in which a current node is located at a low planar position of a parent node.

FIG. 12 is a schematic diagram in which a current node is located at a high planar position of a parent node.

FIG. 13 is a schematic diagram of predictive encoding of planar position information of a laser radar point cloud.

FIG. 14 is a schematic diagram of infer direct coding model (IDCM) encoding.

FIG. 15 is a schematic diagram of coordinate transform for a point cloud obtained by a rotating laser radar.

FIG. 16 is a schematic diagram of predictive encoding in an X-axis direction or a Y-axis direction.

FIG. 17A is a schematic diagram of predicting an angle of a Y-plane through a horizontal azimuth angle.

FIG. 17B is a schematic diagram of predicting an angle of an X-plane through a horizontal azimuth angle.

FIG. 18 is another schematic diagram of predictive encoding in an X-axis direction or a Y-axis direction.

FIG. 19A is a schematic diagram of three vertexes included in a sub-block.

FIG. 19B is a schematic diagram of approximating a triangle soup using three vertexes.

FIG. 19C is a schematic diagram of upsampling of a triangle soup.

FIG. 20 is a schematic diagram of a distance-based LOD construction process.

FIG. 21 is a schematic diagram of a visualization result of an LOD generation process.

FIG. 22 is a schematic diagram of a flowchart of attribute prediction encoding.

FIG. 23 is a schematic diagram of a composition of a pyramid structure.

FIG. 24 is another schematic diagram of a composition of a pyramid structure.

FIG. 25 is a schematic diagram of an LOD structure for inter-level nearest neighbor search.

FIG. 26 is a schematic structural diagram of performing a nearest neighbor search based on a spatial relationship.

FIG. 27A is a schematic diagram of a co-planar spatial relationship.

FIG. 27B is a schematic diagram of co-planar and co-edge spatial relationships.

FIG. 27C is a schematic diagram of co-planar, co-edge, and co-vertex spatial relationships.

FIG. 28 is a schematic diagram of inter-level prediction based on fast search.

FIG. 29 is a schematic diagram of an LOD structure for attribute intra-level nearest neighbor search.

FIG. 30 is a schematic diagram of intra-level prediction based on fast search.

FIG. 31A is a schematic diagram of attribute inter prediction based on fast search.

FIG. 31B is a schematic structural diagram of performing a block-based neighborhood search structure.

FIG. 32 is a schematic diagram of a flowchart of lifting transform encoding.

FIG. 33 is a schematic structural diagram of an RAHT transform.

FIG. 34 is a schematic diagram of an RAHT transform process along x, y, and z directions.

FIG. 35A is a schematic diagram of an RAHT forward transform process.

FIG. 35B is a schematic diagram of an RAHT inverse transform process.

FIG. 36 is a schematic diagram of an attribute encoding block.

FIG. 37 is a schematic diagram illustrating a principle of RAHT-based attribute predicting transform encoding.

FIG. 38 is a schematic diagram of a neighborhood prediction relationship for attribute prediction.

FIG. 39 is a schematic diagram of a flowchart of a decoding method provided in an embodiment of the present disclosure.

FIG. 40 is a schematic diagram of an RAHT encoding layer.

FIG. 41 is a schematic flowchart of an encoding method provided in an embodiment of the present disclosure.

FIG. 42 is a schematic structural diagram of a composition of an encoder provided in an embodiment of the present disclosure.

FIG. 43 is a schematic structural diagram of a hardware of an encoder provided in an embodiment of the present disclosure.

FIG. 44 is a schematic structural diagram of a composition of a decoder provided in an embodiment of the present disclosure.

FIG. 45 is a schematic structural diagram of a hardware of a decoder provided in an embodiment of the present disclosure.

FIG. 46 is a schematic structural diagram of a composition of an encoding and decoding system provided in an embodiment of the present disclosure.

### DETAILED DESCRIPTION OF EMBODIMENTS

To provide a more detailed understanding of the features and technical contents of the embodiments of the present disclosure, the implementations of the embodiments of the present disclosure are described in detail below with reference to the drawings. The drawings are for reference and illustration only and are not intended to limit the embodiments of the present disclosure.

Unless defined otherwise, all technical and scientific terms used herein have the same meaning as commonly understood by those skilled in the art belonging to technical field of the present disclosure. The terms used herein are only for the purpose of describing the embodiments of the present disclosure and not intended to limit the present disclosure.

In the following description, reference is made to “some embodiments”, which describes a subset of all possible embodiments. However, it is to be understood that “some embodiments” may be the same subset or different subsets of all possible embodiments and may be combined with each other without conflict.

It should also be noted that the terms “first\second third” involved in the embodiments of the present disclosure are only used to distinguish similar objects and do not represent a specific ordering for the objects. It is to be understood that the specific order or sequence of “first\second\third” may be interchanged where permitted, so that the embodiments of the present disclosure described here can be implemented in an order other than that illustrated or described here.

A point cloud is a three-dimensional representation form of an object surface, and the point cloud (data) of the object surface may be collected through acquisition devices such as a photoelectric radar, a laser radar, a laser scanner or a multi-view camera.

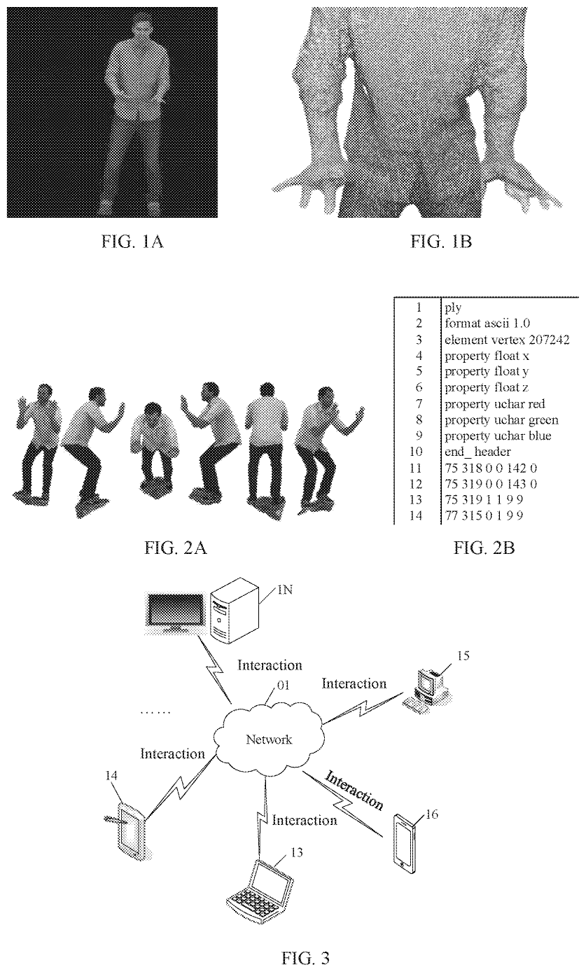

The point cloud refers to a set of discrete points in space that are irregularly distributed and express spatial structures and surface attributes of three-dimensional objects or three-dimensional scenarios. FIG. 1A illustrates a three-dimensional point cloud picture, and FIG. 1B illustrates a partially enlarged diagram of the three-dimensional point cloud picture. It can be seen that a point cloud surface is composed of densely distributed points.

A two-dimensional picture has information expression at each sample point, which is also referred to as pixel point, and the distribution is regular, so there is no need to record position information of each point additionally. However, distribution of points in a point cloud is random and irregular in three-dimensional space, so it is necessary to record a position of each point in space to completely express the entire point cloud. Similar to the two-dimensional picture, during a capturing process, each position has corresponding attribute information, which is typically an RGB color value, and the color value reflects the color of an object. For a point cloud, in addition to the color information, the attribute information corresponding to each point also commonly includes a reflectance value, and the reflectance value reflects the surface material of the object. Therefore, point cloud data typically includes the position information of a point and the attribute information of a point. The position information of the point may also be referred to as geometry information of the point. For example, the geometry information of the point may be three-dimensional coordinate information (x, y, z) of the point. The attribute information of the point may include the color information and/or reflectance, etc. For example, the reflectance may be one-dimensional reflectance information (r); and the color information may be information in any type of color space, or the color information may be three-dimensional color information, e.g., RGB information. Here, R represents Red, G represents Green, and B represents Blue. For another example, the color information may be luma-chroma (YCbCr, YUV) information, where Y represents luma, Cb (U) represents blue chromatic aberration, and Cr (V) represents red chromatic aberration.

For a point cloud obtained based on the principle of laser measurement, the points in the point cloud may include three-dimensional coordinate information of the points and the reflectance values of the points. For another example, for a point cloud obtained based on the principle of photogrammetry, the points in the point cloud may include three-dimensional coordinate information of the points and three-dimensional color information of the points. For yet another example, for a point cloud obtained based on the combination of the principles of laser measurement and photogrammetry, the points in the point cloud may include three-dimensional coordinate information of the points, the reflectance values of the points, and three-dimensional color information of the points.

FIG. 2A and FIG. 2B illustrate a point cloud picture and a data storage format corresponding to the point cloud picture. FIG. 2A provides six viewing angles of the point cloud picture, and FIG. 2B consists of a file header information part and a data part. The header information includes a data format, a data representation type, a total number of points in the point cloud, and content represented by the point cloud. For example, the point cloud is in “.ply” format, represented by ASCII code, with a total number of 207,242 points, and each point has three-dimensional coordinate information (x, y, z) and three-dimensional color information (r, g, b).

Point clouds may be classified into the following based on acquisition approaches:
static point cloud: that is, an object is static, and a device for acquiring the point cloud is also static;
dynamic point cloud: an object is in motion, but a device for acquiring the point cloud is static; and
dynamically acquired point cloud: a device for acquiring the point cloud is in motion.

For example, point clouds may be divided into two major types based on purposes:
type I: a machine perception point cloud, which may be used for scenarios such as, an autonomous navigation system, a real-time inspection system, a geographic information system, a visual sorting robot, and a disaster relief robot; and
type II: a human eye perception point cloud, which may be used for point cloud application scenarios such as, digital cultural heritage, free viewpoint broadcasting, 3D immersive communication, and 3D immersive interaction.

The point cloud can express the spatial structures and the surface attributes of three-dimensional objects or three-dimensional scenarios flexibly and conveniently; moreover, since the point cloud is acquired by directly sampling real objects, the point cloud can provide a strong sense of reality under the premise of ensuring accuracy; and therefore, the point cloud is widely applied, and its application range includes virtual reality games, computer-aided design, geographic information systems, automatic navigation systems, digital cultural heritage, free-viewpoint broadcasting, three-dimensional immersive remote presentation, and three-dimensional reconstruction of biological tissues and organs, or the like.

The main approach for acquiring a point cloud includes: computer generation, 3D laser scanning, and 3D photogrammetry. A computer can generate a point cloud of a virtual 3D object and scene. 3D laser scanning can acquire a point cloud of a static real-world 3D object or scene, capturing millions of points per second. 3D photogrammetry can acquire a point cloud of a dynamic real-world 3D object or scene, capturing tens of millions of points per second. These technologies have reduced the cost and time period required for point cloud data acquisition and improved the accuracy of data. The change in the acquisition approach for point cloud data has made it possible to acquire a large amount of point cloud data. With the growth of application demands, the processing of massive 3D point cloud data has encountered bottlenecks of the limitation in storage space and transmission bandwidth.

Exemplarily, taking a point cloud video with a frame rate of 30 frames per second (fps) as an example, the number of points of the point cloud per frame is 700,000, and each point has coordinate information xyz (float) and color information RGB (uchar); and thus, the data volume of a 10 s point cloud video is approximately 0.7 million×(4Byte×3+1Byte×3)×30 fps×10 s=3.15 GB, where 1 Byte is 10 bit. For a two-dimensional video with a YUV sampling format of 4:2:0, a resolution of 1280×720 and a frame rate of 24 fps, the data volume of a 10 s video is approximately 1280×720×12 bit×24 frames×10 s≈0.33 GB, and the data volume of a 10 s three-dimensional video with two-viewpoints is approximately 0.33×2-0.66 GB. It can be seen that, for videos with the same length, the data volume of point cloud video is much larger than that of two-dimensional video or that of three-dimensional video. Therefore, in order to better realize data management, save server storage space and reduce the transmission traffic and transmission time between the server and the client, point cloud compression has become a key issue to promote the development of the point cloud industry.

In other words, since a point cloud is a collection of a massive number of points, storing the point cloud not only consumes a large amount of storage but is also inconvenient for transmission, and there is also no sufficient bandwidth to support the direct transmission of an uncompressed point cloud over the network layer. Therefore, it is necessary to compress the point cloud.

Currently, the point cloud encoding framework capable of compressing the point cloud may be a geometry-based point cloud compression (G-PCC) codec framework or a video-based point cloud compression (V-PCC) codec framework proposed by the moving picture experts group (MPEG), or may be an audio video coding standard point cloud compression (AVS-PCC) codec framework proposed by AVS. The G-PCC codec framework may be used to compress the static point cloud of the first type and the dynamically acquired point cloud of the third type, and may be based on a test model for point cloud compression (test model compression 13, TMC13). The V-PCC codec framework may be used to compress the dynamic point cloud of the second type, and may be based on a test model for point cloud compression (TMC2). Therefore, the G-PCC codec framework is also referred to as the point cloud codec TMC13, and the V-PCC codec framework is also referred to as the point cloud codec TMC2.

The embodiments of the present disclosure provide network architecture for a point cloud encoding and decoding system that includes a decoding method and an encoding method. FIG. 3 is a schematic diagram of network architecture for point cloud encoding and decoding provided by the embodiments of the present disclosure. As illustrated in FIG. 3, the network architecture includes one or more electronic devices 13 to IN and a communication network 01, where the electronic devices 13 to IN may perform video interaction through the communication network 01. During the process of implementation, the electronic devices may be various types of devices with point cloud encoding and decoding functions, for example, the electronic device may include a mobile phone, a tablet computer, a personal computer, a personal digital assistant, a navigation device, a digital phone, a video phone, a television, a sensing device, a server, etc., which are not limited in the embodiments of the present disclosure. Here, the decoder or the encoder in the embodiments of the present disclosure may be the electronic device.

The electronic device in the embodiments of the present disclosure has the point cloud encoding and decoding function, and generally includes a point cloud encoder (i.e., encoder) and a point cloud decoder (i.e., decoder).

The related art is described below by taking the G-PCC codec framework as an example.

It can be understood that in the point cloud G-PCC codec framework, for point cloud data to be encoded, the point data is first divided into multiple slices through slice partitioning. In each slice, geometry information of the point cloud and attribute information corresponding to each point are encoded separately.

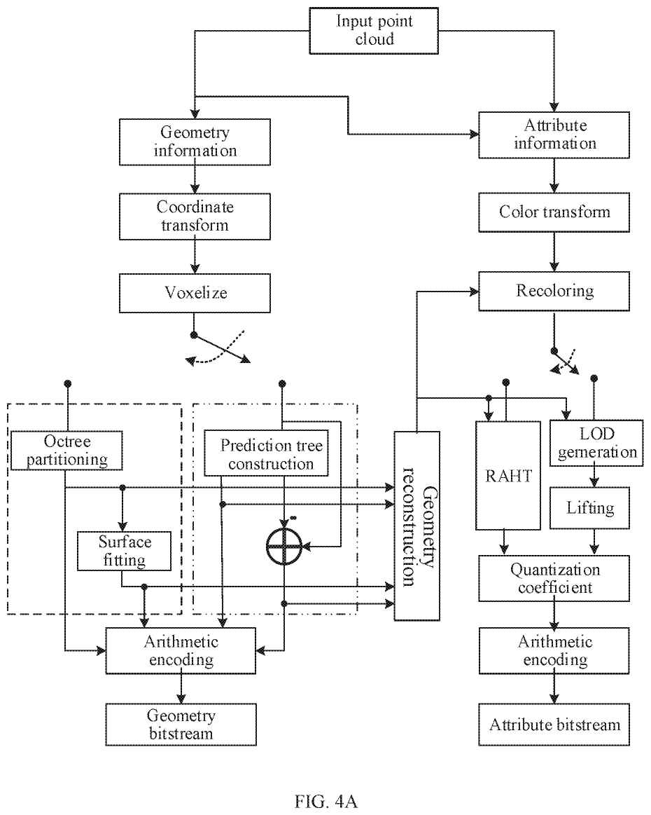

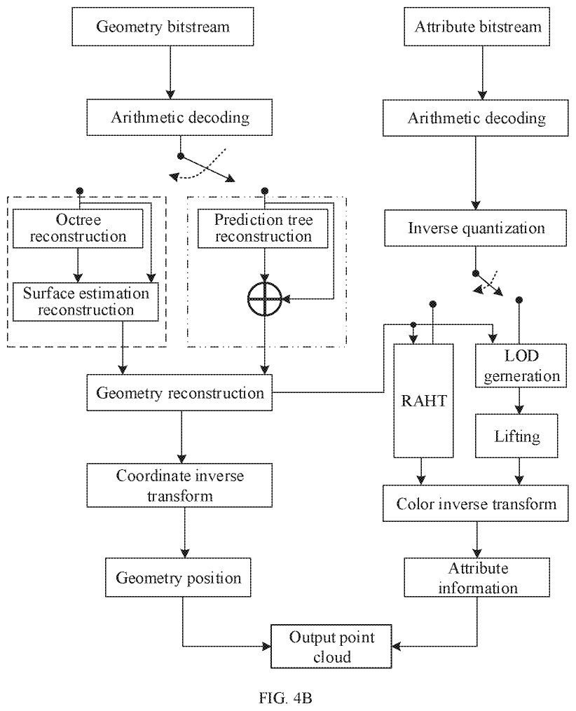

FIG. 4A illustrates a schematic diagram of a composition framework of a G-PCC encoder. As illustrated in FIG. 4A, during the process of geometry encoding, a coordinate transform is performed on the geometry information, so that the entire point cloud is included in a bounding box. Then, quantization is performed, and the quantization operation mainly plays the role of scaling. Due to quantization and rounding, the geometry information of a part of the point cloud is the same, and it is determined whether to remove duplicate points based on parameters. This process of quantization and duplicate point removal is also referred to as voxelization process. Next, octree partitioning or prediction tree construction is performed on the bounding box. In this process, arithmetic encoding is performed on the points in the leaf node obtained through the partitioning, to generate a binary geometry bitstream. Alternatively, arithmetic encoding is performed on the vertex generated through the partitioning (surface fitting is performed based on the vertex), to generate a binary geometry bitstream. During the process of attribute encoding, after the geometry encoding is completed and the geometry information is reconstructed, a color transform is first performed to transform the color information (i.e., the attribute information) from the RGB color space to the YUV color space. Next, the point cloud is re-colored by using the reconstructed geometry information, so that the unencoded attribute information corresponds to the reconstructed geometry information. Attribute encoding mainly targets the color information. During the encoding process of the color information, there are two main transform manners, one is a distance-based lifting transform that relies on level of detail (LOD) partitioning, and the other is that a region adaptive hierarchical transform (RAHT) is performed directly. Both the two manners can transform the color information from the spatial domain to the frequency domain, and a high-frequency coefficient and a low-frequency coefficient are obtained through the transform. Finally, the coefficients are quantized, and arithmetic encoding is performed on the quantized coefficients to generate a binary attribute bitstream.

FIG. 4B illustrates a schematic diagram of a composition framework of a G-PCC decoder. As illustrated in FIG. 4B, for the obtained binary bitstream, the geometry bitstream and the attribute bitstream in the binary bitstream are first decoded independently. When performing decoding on the geometry bitstream, the geometry information of the point cloud is obtained through arithmetic decoding, octree reconstruction or prediction tree reconstruction, geometry reconstruction, and inverse coordinate transform. When performing decoding on the attribute bitstream, the attribute information of the point cloud is obtained through arithmetic decoding, inverse quantization, LOD partitioning or RAHT, and inverse color transform. The point cloud data to be encoded (i.e., the output point cloud) is restored based on the geometry information and the attribute information.

It should be noted that, as illustrated in FIG. 4A or FIG. 4B, the current G-PCC geometry encoding and decoding may be categorized into octree-based geometry encoding and decoding (identified by the dashed box) and prediction tree-based geometry encoding and decoding (identified by the dot-dashed box).

For octree-based geometry encoding (octree geometry encoding, OctGeomEnc), the geometry encoding based on octree includes the following operations. First, the coordinate transform is performed on the geometry information, so that all point clouds are included in a bounding box. Then, quantization is performed, and the quantization operation mainly plays the role of scaling. Due to quantization and rounding, the geometry information of a part of points is the same, and it is determined whether to remove duplicate points based on parameters, and the process of quantization and duplicate points removal is also referred to as voxelization process. Next, tree partitioning (e.g., octree, quadtree, binary tree, etc) is performed on the bounding box continually in the order of breadth-first traversal, and the occupancy code of each node is encoded. In the relate art, an implicit geometry partitioning manner is proposed by a certain company, where the bounding box of the point cloud (2^{d}^{ₓ}, 2^{d}^{_{y}}, 2^{d}^{_{z}}) is calculated first; and assuming that dₓ>d_{y}>d_{z}, the bounding box corresponds to a cuboid. During the geometry partitioning, binary tree partitioning is performed first based on the x axis to obtain two child nodes; and the binary tree partitioning continues until the condition of dₓ=d_{y}>d_{z} is met, then quadtree partitioning is performed continually based on the x axis and y axis to obtain four child nodes; and then, when the condition of dₓ=d_{y}=d_{z} is met, octree partitioning is performed continually until the leaf node obtained through partitioning is a unit cube with a size of 1×1×1, at which the partitioning operation terminates. After that, the points in the leaf nodes are encoded to generate a binary bitstream. During the process of binary tree/quadtree/octree-based partitioning, two parameters, K and M, are introduced. Parameter K indicates the maximum number of binary tree/quadtree partitioning before octree partitioning is performed; and parameter M is used to indicate that the side length of the corresponding minimum block is 2M when binary tree/quadtree partitioning is performed. At the same time, K and M must meet the condition: assuming that dₘₐₓ=max (dₓ, d_{y}, d_{z}), dₘᵢₙ=min(dₓ, d_{y}, d_{z}), parameter K meets the condition of K≥dₘₐₓ−dₘᵢₙ; and parameter M meets the condition of M≥dₘᵢₙ. The reason why parameters K and M meet the above conditions is that, during the current process of G-PCC geometry implicit partitioning, the priority of partitioning manners is binary tree, quadtree and octree. Only when the block size of the node does not meet the condition of binary tree/quadtree, octree partitioning will be performed on the node and continues until the minimum unit of the partitioned leaf node has a size of 1×1×1. The geometry information encoding mode based on octree can effectively encode the geometry information of the point cloud by using the correlation between neighboring points in space, but for some nodes that are relatively flat or nodes with planar characteristics, the encoding efficiency of the geometry information of point cloud can be further improved by using planar encoding.

Exemplarily, FIG. 5A and FIG. 5B provide schematic diagrams of planar positions. FIG. 5A illustrates a schematic diagram of a low planar position in the Z-axis direction, and FIG. 5B illustrates a schematic diagram of a high planar position in the Z-axis direction. As illustrated in FIG. 5A, (a), (a0), (a1), (a2), and (a3) all belong to low planar positions in the Z-axis direction. Taking (a) as an example, it can be seen that the four occupied child nodes of the current node are all located at low planar positions of the current node in the Z-axis direction. Therefore, it may be considered that the current node belongs to the Z-plane and is a low plane in the Z-axis direction. Similarly, as illustrated in FIG. 5B, (b), (b0), (b1), (b2), and (b3) all belong to high planar positions in the Z-axis direction. Taking (b) as an example, it can be seen that the four occupied child nodes of the current node are located at high planar positions of the current node in the Z-axis direction. Therefore, it may be considered that the current node belongs to the Z-plane and is a high plane in the Z-axis direction.

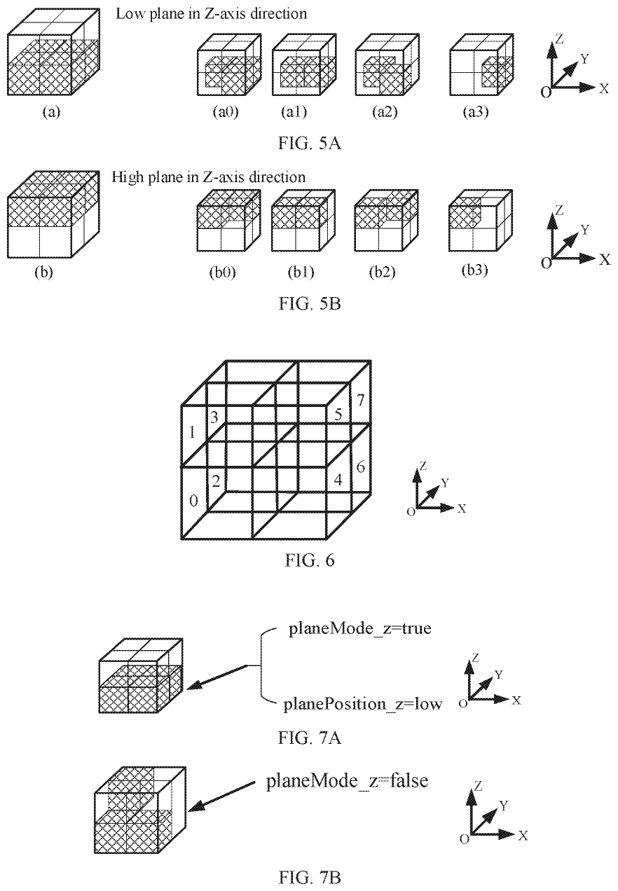

In addition, taking (a) in FIG. 5A as an example to compare the efficiency of octree encoding and the efficiency of planar encoding. FIG. 6 provides a schematic diagram illustrating a node encoding sequence, that is, node encoding is performed in the sequence of 0, 1, 2, 3, 4, 5, 6, and 7 as illustrated in FIG. 6. Here, if the octree encoding manner is used for (a) in FIG. 5A, the occupancy information of the current node is represented as 11001100. However, if the planar encoding manner is used, first, a flag needs to be encoded to represent that the current node is a plane in the Z-axis direction; second, if the current node is a plane in the Z-axis direction, the planar position of the current node also needs to be represented; and then only the occupancy information of the low plane nodes in the Z-axis direction (i.e., the occupancy information of the four child nodes 0, 2, 4, and 6) needs to be encoded. Therefore, performing encoding on the current node using the planar encoding manner only needs to encode 6 bits, which can reduce 2 bits of representation compared to the octree encoding in the related art. Based on this analysis, the planar encoding has more significant coding efficiency than the octree encoding. Therefore, for an occupied node, if the planar encoding manner is used in a certain dimension, first, the planar flag (planeMode) information and planer position (PlanePos) information of the current node in that dimension needs to be represented; and then the occupancy information of the current node is encoded based on the planar information of the current node. Exemplarily, FIG. 7A illustrates a schematic diagram of the planar flag information. As illustrated in FIG. 7A, it is a low plane in the Z-axis direction; accordingly, the value of the planar flag information is true or 1, i.e., planeMode_z=true; and the planar position information is low plane, i.e., PlanePosition_z=low. FIG. 7B illustrates a schematic diagram of another planar flag information. As illustrated in FIG. 7B, it is not a plane in the Z-axis direction; accordingly, the value of the planar flag information is false or 0, i.e., planeMode_z=false.

It should be noted that for PlaneMode_i, 0 represents that the current node is not a plane in the i-axis direction, and 1 represents that the current node is a plane in the i-axis direction. If the current node is a plane in the i-axis direction, then for PlanePosition_i, 0 represents that the current node is a plane in the i-axis direction and the planar position is a low plane, and 1 represents that the current node is a high plane in the i-axis direction. Here, i represents the coordinate dimension, which may be the X-axis direction, Y-axis direction, or Z-axis direction, and thus, i=0, 1, 2.

In the G-PCC standard, it is necessary to determine whether a node meets the condition for planar encoding, and if the node meets the condition for planar encoding, it is necessary to perform predictive encoding on the planar flag information and the planar position information of the current node.

In the embodiments of the disclosure, there are three types of determination conditions in the current G-PCC standard for determining whether a node meets the condition for planar encoding, which are described in detail below.

I. Determination is performed according to a planar probability of the node in each dimension.

(1) Determination of a local node density (local_node_density) of the current node.

(2) Determination of a probability Prob (i) of the current node in each dimension.

In a case where the local node density of the node is less than a threshold Th (e.g., Th=3), the planar probabilities Prob (i) of the current node in three coordinate dimensions are compared with thresholds Th0, Th1, and Th2, where Th0<Th1<Th2 (e.g., Th0=0.6, Th1=0.77, and Th2=0.88). Eligibleᵢ (i=0, 1, 2) may be used to represent whether planar encoding is enabled in each dimension, where Eligiblei=Prob (i)>=threshold.

It should be noted that the threshold is adaptively changed. For example, when Prob(0)>Prob(1)>Prob(2), Eligibleᵢ is set as follows:

$${Eligible}_{0} = Prob ( 0 ) >= Th 0 ;$$

$${Eligible}_{1} = Prob ( 1 ) >= Th 1 ; and$$

$${Eligible}_{2} = Prob ( 2 ) >= Th 2.$$

When Prob(1)>Prob(0)>Prob(2), Eligibleᵢ is set as follows:

$${Eligible}_{0} = Prob ( 0 ) >= Th 1 ;$$

$${Eligible}_{1} = Prob ( 1 ) >= Th 0 ; and$$

$${Eligible}_{2} = Prob ( 2 ) >= Th 2.$$

Here, the update of Prob(i) is as follows:

$$Prob {( i )}_{n e w} = ( L \times Prob ( i ) + δ ( coded node ) ) / L + 1 \qquad ( 1 )$$

where L=255. In addition, if the coded node is a plane, δ(coded node) is 1; otherwise, δ(coded node) is 0.

Here, the update of local_node_density is as follows:

$$local\_node {\_density}_{n e w} = local\_node \_density + 4 * numSiblings \qquad ( 2 )$$

where the local_node_density is initialized to 4, and numSiblings is the number of sibling nodes of the node. Exemplarily, FIG. 8 illustrates a schematic diagram of sibling nodes of a current node. As illustrated in FIG. 8, the current node is filled with diagonal lines, and the nodes filled with grids are the sibling nodes. Thus, the number of sibling nodes of the current node is 5 (including the current node itself).

II. It is determined whether the node in the current layer meets planar encoding according to the point cloud density of the current layer.

The density of points in the current layer is used to determine whether to perform the planar encoding on the node of the current layer. Assuming that the number of points in the current to-be-encoded point cloud is pointCount, the number of points reconstructed after infer direct coding model (IDCM) encoding is numPointCountRecon. Because octree encoding is performed based on the order of breadth-first traversal, the number of nodes to be encoded in the current layer is assumed to be nodeCount, and then the determination of whether planar encoding is enabled on the current layer is assumed to be planarEligibleKOctreeDepth, and is:

$$planarEligibleK OctreeDepth = ( pointCount - numPointCountRecon ) < nodeCount \times 1.3 .$$

If (pointCount-numPointCountRecon) is less than nodeCount×1.3, planarEligibleKOctreeDepth is true; and if (pointCount-numPointCountRecon) is not less than nodeCount×1.3, planarEligibleKOctreeDepth is false. Thus, when planarEligibleKOctreeDepth is true, planar encoding is performed on all nodes in the current layer; otherwise, no nodes in the current layer undergo planar encoding, with only octree encoding being adopted.

III. It is determined whether the node in the current layer meets the condition for planar encoding according to collection parameters of the laser radar point cloud.

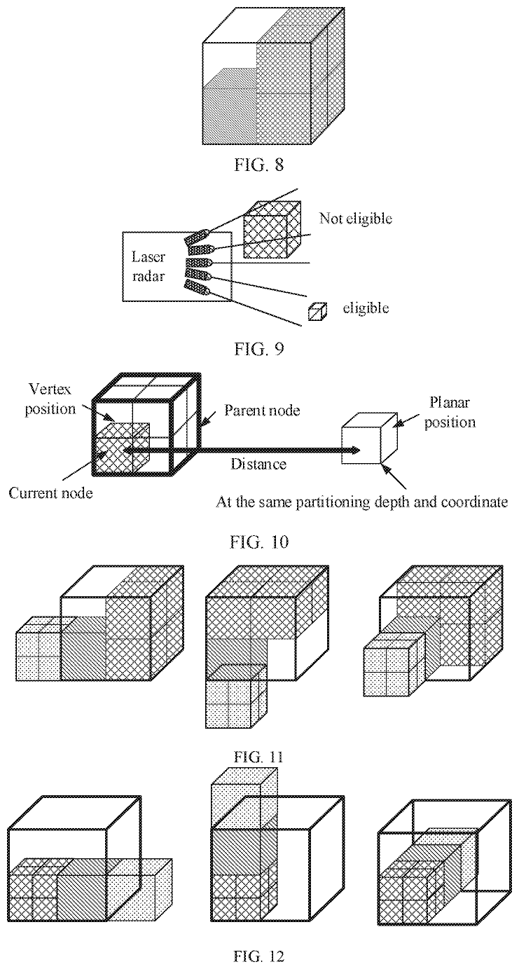

FIG. 9 illustrates a schematic diagram illustrating an intersection of a laser radar and nodes. As illustrated in FIG. 9, the node filled with the grids is traversed by two laser rays at the same time; therefore, the node is not a plane in the direction perpendicular to the Z-axis. The node filled with diagonal lines is small enough to not to be traversed by two laser rays at the same time; therefore, the node may be a plane in the direction perpendicular to the Z-axis.

In addition, for the node that meets the condition for planar encoding, predictive encoding may be performed on the planar flag information and planar position information.

First, the predictive encoding of the planar flag information is introduced.

Here, encoding is performed by using only three pieces of context information. That is, the context is designed separately for the planar flags in each coordinate dimension.

Second, the predictive encoding of the planar position information is introduced.

It should be understood that, for the encoding of planar position information for a non-laser radar point cloud, the predictive encoding of the planar position information may include:
(a) the planar position information of the current node obtained by using the occupancy information of neighborhood nodes for prediction, the planar position information being three elements: predicted as a low plane, predicted as a high plane or unpredictable;
(b) the spatial distance between a node at the same partitioning depth and the same coordinate as the current node and the current node: “near” or “far”;
(c) determining a planar position of the node if the node at the same partition depth and the same coordinate as the current node is a plane; and
(d) coordinate dimension (i=0, 1, 2).

It should be noted that, in the embodiments of the present disclosure, after the spatial distance between the node at the same partitioning depth and at the same coordinate as the current node and the current node is determined, if the spatial distance is less than a preset distance threshold, the spatial distance may be determined as “near”; alternatively, if the spatial distance is greater than the preset distance threshold, the spatial distance may be determined as “far”.

Exemplarily, FIG. 10 illustrates a schematic diagram of a neighborhood node at the same partitioning depth and at the same coordinate. As illustrated in FIG. 10, the large cube with bold lines represents the parent node, the small cube filled with the grids inside the large cube represents the current node, and vertex position of the current node is also illustrated. The small cube filled with white color represents a neighborhood node at the same partitioning depth and at the same coordinate. The distance between the current node and the neighborhood node is the spatial distance, which may be determined as “near” or “far.” In addition, if the neighborhood node is a plane, the planar position of the neighborhood node is also required.

Therefore, as illustrated in FIG. 10, if the current node is the small cube filled with grids, then the neighborhood node is searched for as the small cube filled with white color at the same octree partitioning depth level and at the same vertical coordinate. The distance between the two nodes is determined as “near” or “far”, with reference to the planar position of the node.

In addition, in the embodiments of the present disclosure, FIG. 11 illustrates a schematic diagram in which the current node is located at a low planar position of the parent node. As illustrated in FIG. 11, there are three examples in which the current node is located at the low planar position of the parent node. The descriptions are as follows:
\textcircled{1} if any one of child nodes 4 to 7 of the node filled with dots is occupied, and all nodes filled with grids are not occupied, there is a high probability that a plane exists in the current node (filled with diagonal lines) and the planar position is located lower;
\textcircled{2} if all child nodes 4 to 7 of the node filled with dots are not occupied, and any node filled with grids is occupied, there is a high probability that a plane exists in the current node (filled with diagonal lines) and the planar position is located higher;
\textcircled{3} if all child nodes 4 to 7 of the node filled with dots are empty, and all nodes filled with grids are empty, the planar position cannot be inferred and is therefore marked as unknown; and
\textcircled{4} if any one of the child nodes 4 to 7 of the node filled with dots is occupied, and any one of the nodes filled with grids is occupied, in this case, the planar position also cannot be inferred and is therefore marked as unknown.

In the embodiments of the present disclosure, FIG. 12 illustrates a schematic diagram in which the current node is located at the high planar position of the parent node. As illustrated in FIG. 12, there are three examples in which the current node is located at the high planar position of the parent node. The descriptions are as follows:
\textcircled{1} if any one of child nodes 4 to 7 of the node filled with grids is occupied, and the node filled with dots is not occupied, there is a high probability that a plane exists in the current node (filled with diagonal lines) and the planar position is located lower;
\textcircled{2} if all child nodes 4 to 7 of the node filled with grids are not occupied, and the node filled with dots is occupied, there is a high probability that a plane exists in the current node (filled with diagonal lines) and the planar position is located higher;
\textcircled{3} if all child nodes 4 to 7 of the node filled with grids are not occupied, and the node filled with dots is not occupied, in this case, the planar position cannot be inferred and is therefore marked as unknown; and
\textcircled{4} if there is one of child nodes 4 to 7 of the node filled with grids is occupied, and the node filled with dots is occupied, in this case, the planar position cannot be inferred and is therefore marked as unknown.

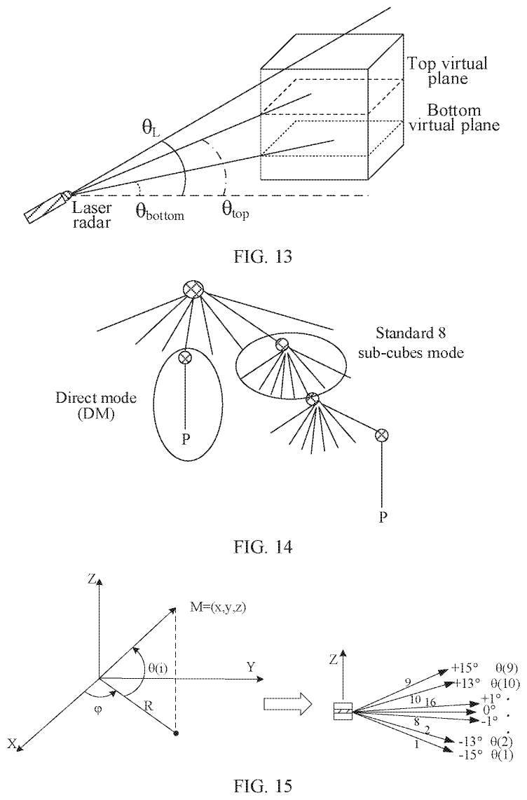

It should also be understood that, for encoding of the planar position information of the laser radar point cloud, FIG. 13 illustrates a schematic diagram of predictive encoding of the planar position information of the laser radar point cloud. As illustrated in FIG. 13, when the emission angle of the laser radar is θ_{bottom}, it may be mapped to a low plane (bottom virtual plane); and when the emission angle of the laser radar is θₜₒₚ, it may be mapped to a high plane (top virtual plane).

In other words, the planar position of the current node is predicted by using collection parameters of the laser radar, and the position is quantized into multiple intervals by using positions intersected by the current node and laser rays, which finally serve as the context information of the planar position of the current node. The calculation process is as follows: assuming that coordinates of the laser radar are (x_{Lidar}, y_{Lidar}, z_{Lidar}) and geometric coordinates of the current node are (x, y, z), a vertical tangent value tan θ of the current node relative to the laser radar is first calculated, with the calculation formula shown as follows:

$$tan θ = \frac{z - {z}_{Lidar}}{{( x - {x}_{Lidar} )}^{2} + {( y - {y}_{Lidar} )}^{2}} \qquad ( 3 )$$

In addition, since each laser has a certain offset angle relative to the laser radar, a relative tangent value tan θ_{corr,L} of the current node relative to the laser is required to be calculated, with the calculation process shown as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

Finally, the planar position of the current node is predicted by using the relative tangent value tan θ_{corr,L} of the current node. Assuming that a tangent value of a lower boundary of the current node is tan (θ_{bottom}), and a tangent value of an upper boundary is tan (θₜₒₚ), the planar position is quantized into 4 quantization intervals based on tan θ_{corr,L}, i.e., determining the context information of the planar position.

However, the octree-based geometry information encoding mode only has an efficient compression rate for points that are correlated in space. For points that are isolated in the geometric space, using the direct coding model (DCM) can greatly reduce complexity. For all nodes in the octree, the use of DCM is not represented by flag information, but is inferred from the parent node and neighboring information of the current node. There are three manners to determine whether the current node is eligible for the DCM encoding. The description is as follows:
(1) the current node has no sibling child nodes, that is, the parent node of the current node has only one child node, and the parent node of the parent node of the current node has only two occupied child nodes, that is, the current node has at most one neighboring node;
(2) the parent node of the current node has only one occupied child node (i.e., the current node), and six neighboring nodes that share a face with the current node also belong to empty nodes; and
(3) the number of sibling nodes of the current node is greater than 1.

Exemplarily, FIG. 14 provides a schematic diagram of an IDCM encoding. If the current node is not eligible for DCM encoding, octree partitioning will be performed on the current node. If the current node is eligible for DCM encoding, the number of points included in the node will be further determined. When the number of points is less than a threshold (e.g., 2), DCM encoding will be performed on the node, otherwise, octree partitioning will continue to be performed on the node. In a case of applying the DCM encoding mode, first, it is necessary to encode whether the current node is a real isolated point, i.e., IDCM_flag. When IDCM_flag is true, the current node adopts DCM encoding, otherwise, it is still adopts octree encoding. In a case where the current node meets the condition for DCM encoding, it is necessary to encode the DCM encoding mode of the current node. At present, there are two DCM modes, which are: (a) existing only one point (or multiple points, but they are duplicate points); and (b) containing two points. Finally, it is necessary to encode the geometry information of each point. Assuming that a side length of the node is 2ª, d bits are required to encode each component of the geometry coordinates of the node, and this bit information is directly encoded into the bitstream. It is to be noted here that when encoding is performed on the laser radar point cloud, predictive encoding is performed on the coordinate information with three dimensions by using the collection parameters of the laser radar, thereby further improving the encoding efficiency of the geometry information.

In addition, the process of IDCM encoding is described below.

In the case where the current node meets the condition for the DCM encoding mode, the number of points (numPoints) of the current node is encoded first. The number of points of the current node is encoded according to different DirectModes.
(1) If the current node does not meet the requirement for a DCM node, the process exits directly (that is, the number of points is greater than 2 and they are not duplicate points).
(2) In the case where the number of points (numPoints) of the current node is less than or equal to 2, the encoding process is as follows:
   i) first, whether numPoints of the current node is greater than 1 is encoded; and
   ii) if the current node has only one point and the geometry encoding environment is geometry lossless encoding, it is necessary to encode that the second point of the current node is not a duplicate point.
(3) If the number of points (numPoints) of the current node is greater than 2, the encoding process is as follows:
i) first, the numPoints of the current node being less than or equal to 1 is encoded; and
ii) second, the second point of the current node being a duplicate point is encoded; and then whether the number of duplicate points of the current node is greater than 1 is encoded. When the number of duplicate points is greater than 1, the exponential-Golomb decoding needs to be performed on the remaining number of duplicate points.

After completing the encoding the number of points of the current node, the coordinate information of the points contained in the current node is encoded. The laser radar point cloud and the human eye-oriented point cloud are respectively introduced below.

### (I) Human Eye-Oriented Point Cloud

(1) If the current node contains only one point, the direct encoding (bypass coding) will be performed on the geometry information of the point in three dimensional directions.
(2) If the current node contains two points, the prioritized encoding coordinate axis dirextAxis will first be obtained by using the geometric coordinates of the points. It should be noted that the currently compared axes only include the x-axis and γ-axis, not including the z-axis. Assuming the geometric coordinate of the current node is nodePos, the determination manner is as follows:

$$directAxis = ! ( nodePos [ 0 ] < nodePos [ 1 ] ) \qquad ( 5 )$$

That is, the axis with the smaller coordinate geometric position of the node will be determined as the prioritized encoding coordinate axis dirextAxis. Then, the geometry information of the prioritized encoding coordinate axis dirextAxis is encoded first as follows. Assuming that the geometry bit depth to be encoded corresponding to the prioritized encoding coordinate axis is nodeSizeLog2, and assuming that the coordinates of the two points are pointPos[0] and pointPos[1], respectively, the coding process is as follows:

```
    Bool sameBit=true;
    while(nodeSizeLog2&& sameBit){
      int mask=1<<nodeSizeLog2;
      --nodeSizeLog2;
      bool bit0=!!( pointPos[0]& mask)
bool bit1 =!!( pointPos[1]& mask)
      sameBits=bit0== bit1;
      entropy CodeSameBit(sameBits); ///<entropy coding
      if(sameBits)
        encodePosBit(bit0);///<Bypass coding
      }
```

After completing the encoding of the prioritized encoding coordinate axis dirextAxis, the direct encoding (bypass coding) is continued to be performed on the geometric coordinate of the current node. Assuming that the remaining bit depth to be encoded of each point is nodeSizeLog2, the coding process is as follows:

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask))

### (II) Laser Radar-Oriented Point Cloud

If the current node contains two points, the prioritized encoding coordinate axis dirextAxis will first be obtained by using the geometric coordinates of the points. Assuming that the geometric coordinate of the current node is nodePos, the determination manner is as follows:

$$directAxis = ! ( nodePos [ 0 ] < nodePos [ 1 ] )$$

That is, the axis with the smaller coordinate geometric position of the node will be determined as the prioritized encoding coordinate axis dirextAxis. It should be noted that the currently compared axes only include the x-axis and γ-axis, not including the z-axis. Then, the geometry information of the prioritized encoding coordinate axis dirextAxis is encoded first as follows. Assuming that the geometric bit depth to be encoded corresponding to the prioritized encoding coordinate axis is nodeSizeLog2, and assuming that the coordinates of the two points are pointPos[0] and pointPos[1], respectively, the coding process is as follows:

```
  Bool sameBit=true;
  while(nodeSizeLog2&& sameBit){
    int mask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropy CodeSameBit(sameBits);
    if(sameBits)
      encodePosBit(bit0);
    }
```

After completing the encoding of the prioritized encoding coordinate axis dirextAxis, the geometric coordinate of the current node is then encoded.

Since the collection parameters of the laser radar point cloud may be obtained by the laser radar point cloud, through using the geometric coordinate information that is capable of predicting the current node, the geometry information encoding efficiency of the point cloud can be further improved. Similarly, first, a primary axis direction for direct encoding is obtained by using the geometry information of the current node nodePos; and then, predictive encoding is performed on the geometry information of another dimension by using the geometry information of the already encoded direction. Also assuming that the direction of the axis for direct encoding is directAxis, and assuming that the bit depth to be encoded in the direct encoding is nodeSizeLog2, the encoding manner is as follows:

for(int mask=(1<< nodeSizeLog2)>>1;mask;mask>>1);
encodePosBit(!!(pointPos[directAxis]&mask)).

It should be noted here that all the geometric precision information in the directAxis direction will be encoded.

Exemplarily, FIG. 15 provides a schematic diagram of the coordinate transformation of a point cloud obtained by a rotating laser radar. In the Cartesian coordinate system, the (x,y,z) coordinates of each node may be transformed to a representation of (R, φ,i). In addition, the laser scanner may perform laser scanning at preset angles, and different values of i may obtain different θ(i). For example, when i is equal to 1, θ(1) is obtained in this case, corresponding to a scanning angle of −15°; when i is equal to 2, θ(2) is obtained in this case, corresponding to a scanning angle of −13°; when i is equal to 10, θ(10) is obtained in this case, corresponding to a scanning angle of +13°; and when i is equal to 9, θ(19) is obtained in this case, corresponding to a scanning angle of +15°.

Thus, after completing the encoding of all precision of the directAxis coordinate direction, first, the LaserIdx corresponding to the current point (i.e., pointLaserIdx in FIG. 15) is calculated, and the LaserIdx of the current node (i.e., nodeLaserIdx) is also calculated; and then predictive encoding is performed on the LaserIdx of the point (i.e., pointLaserIdx) by using the LaserIdx of the node (i.e., nodeLaserIdx). The calculation manner of the LaserIdx of the node or the LaserIdx of the point is as follows. Assuming that the geometric coordinate of the point is pointPos and the origin coordinate of the laser ray is LidarOrigin, and assuming that the number of lasers is LaserNum, the tangent value of each laser is tandi, and the offset position of each laser in the vertical direction is Zi, then:

```
      Int bestLaserIdx = 0;
      Int Distoration = INT_MAX;
For(int LaserIdx = 0; LaserIdx<numLaser; ++ LaserIdx){
$int radius = \sqrt{( pointPos [ 0 ] - LidarOrigin [ 0 ] ) 2 + ( pointPos [ 1 ] - LidarOrigin [ 1 ] ) 2}$
      int invRadius = 1/radius
      int Z-pointPos[2]+ Zi
      int tan Theta = Z × invRadius
      if(std::abs(tanTheta-tanθi) < Distoration){
    Distoration = std::abs(tanTheta-tan0i);
      bestLaserIdx = LaserIdx;
      }
    }
```

After obtaining the LaserIdx of the current point by calculation, predictive encoding is first performed on the pointLaserIdx of the point by using the LaserIdx of the current node. After completing the encoding of the LaserIdx of the current point, predictive encoding is performed on the geometry information in three dimensions of the current point by using the collection parameters of the laser radar.

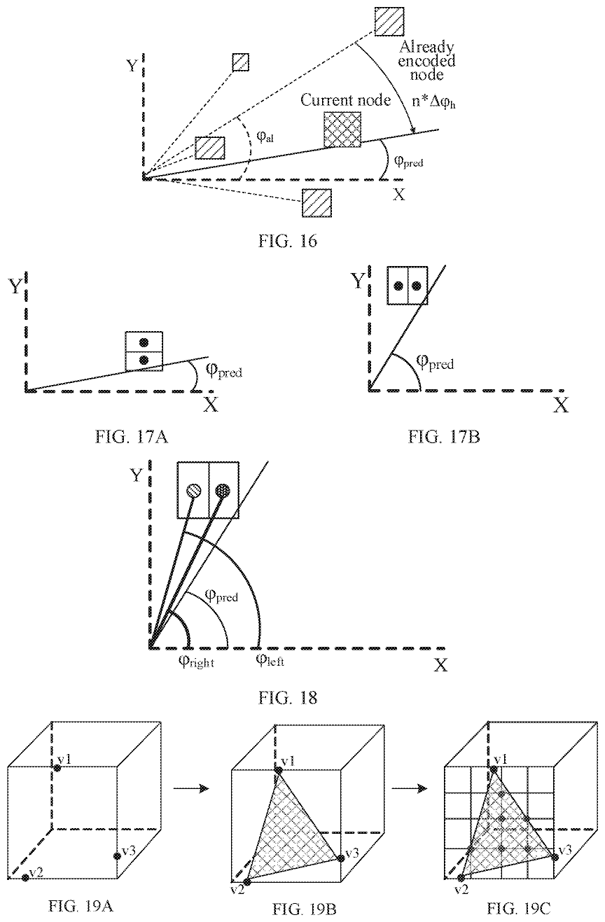

Exemplarily, FIG. 16 illustrates a schematic diagram of predictive encoding in the X-axis or Y-axis direction. As illustrated in FIG. 16, the box filled with grids represents the current point (current node), and the box filled with diagonal lines represents the already coded point (already coded node). Here, first, the prediction value of the horizontal azimuth angle (i.e., φ_{pred}) is obtained by using the LaserIdx corresponding to the current point; and then, the horizontal azimuth angle (i.e., φ_{node}) corresponding to the node is obtained by using the geometry information of node corresponding to the current point. Assuming that the geometric coordinate of the node is nodePos, the calculation between the horizontal azimuth angle φ and the geometry information of the node is as follows:

$$φ = arctan ( nodePos [ 1 ] / nodePos [ 0 ] ) \qquad ( 6 )$$

By using the collection parameters of the laser radar, the number of rotation points of each laser (numPoints) may be obtained, which represents the number of points obtained in one full rotation of each laser ray. Then, the rotational angular velocity (deltaPhi) of each laser may be calculated by using the number of rotation points of each laser, and the calculation manner is as follows:

$$deltaPhi = \frac{2 π}{numPoints} \qquad ( 7 )$$

In addition, the prediction value of the horizontal azimuth angle corresponding to the current point, φ_{predPoint} (that is, the prediction value of the horizontal azimuth angle as illustrated in FIG. 17A and FIG. 17B), is calculated by using the horizontal azimuth angle of the node φ_{node} and the horizontal azimuth angle φ_{pred} of the previously encoded point of the laser corresponding to the current node. FIG. 17A illustrates a schematic diagram in which the angle of Y-plane is predicted through the horizontal azimuth angle, and FIG. 17B illustrates a schematic diagram in which the angle of X-plane is predicted through the horizontal azimuth angle. The calculation manner of the prediction value of the horizontal azimuth angle corresponding to the current point φ_{predPoint} is as follows:

$${φ}_{predPoint} = \frac{φ pred - φnode}{deltaPhi} \times deltaPhi + φ pred \qquad ( 8 )$$

Exemplarily, FIG. 18 illustrates another schematic diagram of predictive encoding in the X-axis direction or the Y-axis direction. As illustrated in FIG. 18, the part filled with diagonal lines (on the left) represents the low plane, the part filled with grids (on the right) represents the high plane, φ_{left} represents the horizontal azimuth angle of the low plane of the current node, φ_{right} represents the horizontal azimuth angle of the high plane of the current node, and φ_{pred} represents the prediction value of the horizontal azimuth angle corresponding to the current node.

Therefore, predictive encoding is performed on the geometry information of the current node by using the prediction value of the horizontal azimuth angle φ_{predPoint}, the horizontal azimuth angle of the low plane φ_{left} of the current node, and the horizontal azimuth angle of the high plane φ_{right}. The process is as follows:

$$int angLel = {φ}_{left} - {φ}_{pred} ;$$

$$int angLeR = {φ}_{right} - {φ}_{pred} ;$$

$$int content = ( angLel \geq 0 \&\& angLeR \geq 0 ) ‖ ( angLel < 0 \&\& angLeR < 0 ) ? 0 : 2 ;$$

$$int min Angle = std ∷ min ( abs ( angLel ) , abs ( angLeR ) ) ;$$

$$int max Angle = std ∷ max ( abs ( angLel ) , abs ( angLeR ) ) ;$$

$$context += max Angle > min Angle ? 0 : 1 ;$$

$$context += max Angle > min Angle ? 0 : 4.$$

After completing the encoding of the LaserIdx of the point, predictive encoding is performed on the Z-axis direction of the current point by using the LaserIdx corresponding to the current point. That is, the depth information (i.e., radius) in the radar coordinate system is calculated by using the x information and y information of the current point, and then, the tangent value of the current point and the offset of the current point in the vertical direction are obtained by using the laser LaserIdx of the current point. Therefore, the prediction value of the current point in the Z-axis direction (i.e., Z_pred) can be obtained. The process is as follows:

$$int radius = \sqrt{{( pointPos [ 0 ] - LidarOrigin [ 0 ] )}^{2} + {( pointPos [ 1 ] - LidarOrigin [ 1 ] )}^{2}} ;$$

$$int tan Theta = {tan}_{θ laserIdx} ;$$

$$int z Offset = {Z}_{laserIdx} ;$$

$$Z\_pred = radius \times tan Theta - z Offset .$$

In addition, predictive encoding is performed on the geometry information of the current point in the Z-axis direction by using the Z_pred, to obtain the prediction residual Z_res. Finally, Z_res is encoded.

It should be noted that when a node is partitioned into leaf nodes, under geometry lossless encoding, the number of duplicate points in the leaf nodes needs to be encoded. Finally, the occupancy information of all nodes is encoded to generate a binary bitstream. In addition, at present, a planar encoding mode is introduced in G-PCC: during the process of geometry partitioning, it will be determined whether the child nodes of the current node are in the same plane; and if the child nodes of the current node meet the condition of being in the same plane, the child nodes of the current node will be represented by the plane.

For the octree-based geometry decoding, before decoding the occupancy information of each node, a decoding side (or referred to as decoder) will first determine, in the order of breadth-first traversal, whether to perform the planar decoding or the IDCM decoding on the current node by using the reconstructed geometry information. If the current node meets a condition for the planar decoding, the decoding side will first decode the planar flag and planar position information of the current node, and then decode the occupancy information of the current node based on the planar information. If the current node meets a condition for the IDCM decoding, the decoding side will first decode whether the current node is a true IDCM node; and if the current node is a true IDCM node, the decoding side will continue to parse the DCM decoding mode of the current node, and then the decoding side may obtain the number of points in the current DCM node and finally decode the geometry information of each point. For a node that does not meet either the planar decoding or the DCM decoding, the occupancy information of the current node will be decoded. By continuously parsing in this manner, an occupancy code of each node is obtained, and the partitioning is continued for the nodes in turn until unit cubes of 1×1×1 are obtained. The number of points included in each leaf node is parsed, and geometric reconstruction point cloud information is restored finally.

The IDCM decoding process is introduced below.

Similar to the processing at the encoding side, the priori information is first used to determine whether to enable the IDCM for a node. That is, the enabling conditions of IDCM are as follows:
(1) the current node has no sibling child nodes, that is, the parent node of the current node has only one child node, and the parent node of the parent node of the current node has only two occupied child nodes, that is, the current node has at most one neighboring node;
(2) the parent node of the current node has only one occupied child node (i.e., the current node), and six neighboring nodes that share a face with the current node also belong to empty nodes; and
(3) the number of sibling nodes of the current node is greater than 1.

In addition, when a node meets the condition for DCM encoding, a flag (IDCM_flag) is first decoded to determine whether the current node is a true DCM node. When the IDCM_flag is true, DCM encoding is performed on the current node; otherwise, octree encoding is still adopted.

Next, the number of points (numPoints) of the current node is decoded. The decoding manner is as follows:
i) first, it is decoded whether the numPoints of the current node is greater than 1;
ii) if the decoded numPoints of the current node is greater than 1, it continues decoding whether the second point is a duplicate point; if the second point is not a duplicate point, it can be implicitly inferred that the second type of the DCM mode is met, with only two points being contained;
iii) if the decoded numPoints of the current node is less than or equal to 1, it continues decoding whether the second point is a duplicate point. If the second point is not a duplicate point, it can be implicitly inferred that the second type of the DCM mode is met, with only one point being contained. If the second point is decoded as a duplicate point, it can be inferred that the third type of the DCM mode is met, with multiple points being contained and all of the multiple points being duplicate points; and in this case, it continues decoding whether the number of duplicate points is greater than 1 (entropy decoding). If the number of duplicate points is greater than 1, it continues decoding the number of remaining duplicate points (using exponential-Golomb encoding).

If the current node does not meet the requirement for the DCM node (i.e., the number of points is greater than two points and they are not duplicate points), the process exits directly.

After completing the decoding of the number of points of the current node, the coordinate information of the points contained in the current node is decoded. The laser radar point cloud and the human eye-oriented point cloud are respectively introduced below.

### (I) Human Eye-Oriented Point Cloud

(1) If the current node contains only one point, the direct decoding (bypass coding) will be performed on the geometry information of the point in three dimensional directions.
(2) If the current node contains two points, the prioritized decoding axis dirextAxis will first be obtained by using the geometric coordinates of the points. It should be noted that the currently compared axes only include the x-axis and γ-axis, not including the z-axis. Assuming the geometric coordinate of the current node is nodePos, the determination manner is as follows:

$$dirextAxis = ! ( node Pos [ 0 ] < node Pos [ 1 ] ) \qquad ( 9 )$$

That is, the axis with the smaller coordinate geometric position of the node will be determined as the prioritized decoding axis dirextAxis. Then, the geometry information of the prioritized decoding axis dirextAxis is decoded first as follows. Assuming that the geometry bit depth to be decoded corresponding to the prioritized decoding axis is nodeSizeLog2, and assuming that the coordinates of the two points are pointPos[0] and pointPos[1], respectively, the coding process is as follows:

```
Bool sameBit=true;
while(nodeSizeLog2&& sameBit){
  pointPos[0][ dirextAxis]<<1;
  pointPos[1][ dirextAxis]<<1;
  --nodeSizeLog2;
    int bit=0;
      deEntropyCodeSameBit(sameBits); ///<entropy coding
    if(sameBits){
        bit =decodePosBit( );///<Bypass coding
        pointPos[0][ dirextAxis]|= bit
        pointPos[1][ dirextAxis]|= bit
    }else
        pointPos[1][ dirextAxis]]= 1/// The reason for this is that during
    encoding, the two points will be sorted along the direction of the
    prioritized encoding axis, so that pointPos[0][dirextAxis] <
    pointPos[1][dirextAxis] is ensured. Therefore, during decoding, if the bit
    information of the two points is different, it can be inferred that the bit of
    the first point is 0 and the bit of the second point is 1.
    }
```

After completing the decoding of the prioritized decoding coordinate axis dirextAxis, the direct decoding (bypass coding) is performed on the geometric coordinate of the current point. Assuming that the remaining bit depth to be decoded of each point is nodeSizeLog2 and assuming that the coordinate information of the point is pointPos, the decoding process is as follows:

```
for(int axisIdx=0;axisIdx<3;++axisIdx)
for(int idx= nodeSizeLog2[axisIdx]; idx; idx--){
    pointPos[axisIdx]<<1;
    pointPos[axisIdx]|=decodePosBit( );
  }
```

### (II) Laser Radar-Oriented Point Cloud

If the current node contains two points, the prioritized decoding coordinate axis dirextAxis will first be obtained by using the geometric coordinates of the points. Assuming that the geometric coordinate of the current node is nodePos, the determination manner is as follows:

$$dirextAxis = ! ( node Pos [ 0 ] < node Pos [ 1 ] ) \qquad ( 10 )$$

That is, the axis with the smaller coordinate geometric position of the node will be determined as the prioritized decoding coordinate axis dirextAxis. It should be noted that the currently compared axes only include the x-axis and γ-axis, not including the z-axis. Then, the geometry information of the prioritized decoding coordinate axis dirextAxis is decoded first as follows. Assuming that the geometric bit depth to be coded corresponding to the prioritized decoding coordinate axis is nodeSizeLog2, and assuming that the coordinates of the two points are pointPos[0] and pointPos[1], respectively, the coding process is as follows:

```
Bool sameBit=true;
while(nodeSizeLog2&& sameBit){
  pointPos[0][ dirextAxis]<<1;
  pointPos[1][ dirextAxis]<<1;
    --nodeSizeLog2;
    int bit=0;
    deEntropy CodeSameBit(sameBits); ///<entropy coding
      if(sameBits){
        bit =decodePosBit( );///<Bypass coding
        pointPos[0][ dirextAxis]|= bit
      pointPos[1][ dirextAxis]|= bit
  }else
    pointPos[1][ dirextAxis]]= 1/// The reason for this is that during
  encoding, the two points will be sorted along the direction of the
  prioritized encoding axis, so that pointPos[0][dirextAxis] <
  pointPos[1][dirextAxis] is ensured. Therefore, during decoding, if the bit
  information of the two points is different, it can be inferred that the bit of
  the first point is 0 and the bit of the second point is 1.
  }
```

After completing the decoding the prioritized decoding axis dirextAxis, the geometric coordinate of the current point is then decoded.

Similarly, first, a primary axis direction for direct decoding is first obtained by using the geometry information of the current node nodePos, and then, decoding is performed on the geometry information of another dimension by using the geometry information of the already decoded direction. Also assuming that the direction of the axis for direct decoding is directAxis, and assuming that the bit depth to be decoded in the direct decoding is nodeSizeLog2, the decoding manner is as follows:

```
for (int idx = nodeSizeLog2[directAxis]; idx; idx--) {
    pointPos[directAxis] <<= 1;
    pointPos[directAxis] |= decodePosBit( );
  }
```

It should be noted here that all geometric precision information of the directAxis direction will be decoded.

After completing the decoding of all precision of the directAxis coordinate direction, first, the LaserIdx of the current node (i.e., nodeLaserIdx) is calculated; and then predictive decoding is performed on the LaserIdx of the point (i.e., pointLaserIdx) by using the LaserIdx of the node (i.e., nodeLaserIdx). The calculation manner of the LaserIdx of node or point is the same as that at the encoding side. Finally, the prediction residual information between the LaserIdx of the current point and the LaserIdx of the node is decoded to obtain ResLaserIdx, and the decoding manner is as follows:

$$PointLaserIdx = node LaserIdx + ResLaserIdx \qquad ( 11 )$$

After completing the decoding of the LaserIdx of the current point, predictive decoding is performed on the geometry information in three dimensions of the current point by using the collection parameters of the laser radar. The algorithm is as follows.

As illustrated in FIG. 11, first, the corresponding prediction value of the horizontal azimuth angle (i.e., φ_{pred}) is obtained by using the LaserIdx corresponding to the current point; and then the horizontal azimuth angle corresponding to the node (i.e., φ_{node}) is obtained by using the geometry information of the node corresponding to the current point. Assuming that the geometric coordinate of the node is nodePos, the calculation between the horizontal azimuth angle φ and the geometry information of the node is as follows:

$$φ = arctan ( node Pos [ 1 ] / node Pos [ 0 ] ) \qquad ( 12 )$$

By using the collection parameters of the laser radar, the number of rotation points of each laser (numPoints) may be obtained, which represents the number of points obtained in one full rotation of each laser ray. Then, the rotational angular velocity (deltaPhi) of each laser may be calculated by using the number of rotation points of each laser, and the calculation manner is as follows:

$$deltaPhi = \frac{2 π}{numPoints} \qquad ( 13 )$$

In addition, the prediction value of the horizontal azimuth angle corresponding to the current point, φ_{predPoint} (that is, the prediction value of the horizontal azimuth angle as illustrated in FIG. 17A and FIG. 17B), is calculated by using the horizontal azimuth angle of the node φ_{node} and the horizontal azimuth angle φ_{pred} of the previously encoded point of the laser corresponding to the current point. The calculation manner is as follows:

$${φ}_{predPoint} = \frac{φ pred - φnode}{deltaPhi} \times deltaPhi + φ pred \qquad ( 14 )$$

Therefore, predictive decoding is performed on the geometry information of the current node by using the prediction value of the horizontal azimuth angle φ_{predPoint}, the horizontal azimuth angle of the low plane left of the current node, and the horizontal azimuth angle of the high plane right of the current node. The process is as follows:

$$int angLe1 = {φ}_{left} - {φ}_{pred} ;$$

$$int angLeR = {φ}_{right} - {φ}_{pred} ;$$

$$int content = ( angLel \geq 0 \&\& angLeR \geq 0 ) ‖ ( angLel < 0 \&\& angLeR < 0 ) ? 0 : 2 ;$$

$$int abs AngleL = abs ( angLel ) ;$$

$$int abs AngleR = abs ( angLeR ) ;$$

$$context += abs AngleL > abs AngleR ? 0 : 1 ;$$

$$context += max Angle > min Angle ≪ 1 ? 4 : 0.$$

After completing the decoding of the LaserIdx of the point, predictive decoding is performed on the Z-axis direction of the current point by using the LaserIdx corresponding to the current point. That is, the depth information (i.e., radius) in the radar coordinate system is calculated by using the x information and y information of the current point, and then, the tangent value of the current point and the offset of the current point in the vertical direction are obtained by using the laser LaserIdx of the current point. Therefore, the prediction value of the current point in the Z-axis direction (i.e., Z_pred) can be obtained. The process is as follows:

$$int radius = \sqrt{( pointPos [ 0 ] - LidarOrigin [ 0 ] ) 2 + ( pointPos [ 1 ] - LidarOrigin [ 1 ] ) 2} ;$$

$$int tan Theta = {t anθ}_{laserIdx} ;$$

$$int z Offset = {Z}_{laserIdx} ;$$

$$Z\_pred = radius \times tan Theta - z Offset .$$

In addition, the geometry information of the current point in the Z-axis direction is reconstructed and restored by using the decoded Z_res and Z_pred.

For the geometry information encoding based on triangle soup (trisoup), in the geometry information encoding architecture based on trisoup, geometric partitioning is also performed first. However, unlike the binary tree/quadtree/octree-based geometry information encoding, this method does not need to partition the point cloud into unit cubes with side lengths of 1×1×1 step by step, but stops partitioning once there exist sub-blocks (blocks) with a side length of W. Based on a surface formed in each block by the distribution of the point cloud, at most twelve vertices generated by this surface and twelve sides of the block are obtained. Vertex coordinates of each block are encoded in turn to generate a binary bitstream.

For trisoup-based point cloud geometry information reconstruction, in response to performing the point cloud geometry information reconstruction, the decoding side first decodes the vertex coordinates to complete triangle soup reconstruction, a process of which is illustrated in FIG. 19A, FIG. 19B and FIG. 19C. Here, there are three vertices (v1, v2, v3) in a block illustrated in FIG. 19A, and the triangle soup, i.e., trisoup, formed by these three vertices in a certain order is illustrated in FIG. 19B. Next, sampling is performed on the triangle soup to obtain samples, which will serve as a reconstructed point cloud within the block, as illustrated in FIG. 19C.

For the prediction tree-based geometry encoding (predictive geometry coding, PredGeomTree), the prediction tree-based geometry encoding includes operations as follows. First, an input point cloud is sorted, and the sorting manners currently used include unordered, Morton order, azimuth order, and radial distance order. An encoding side establishes a prediction tree structure by using two different manners including a high-latency slow mode (KD-Tree), and a low-latency fast mode (in which the laser radar calibration information is used). When using the laser radar calibration information, each point is assigned to a different laser and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration, to generate a binary bitstream.

For the prediction tree-based geometry decoding, the decoding side reconstructs the prediction tree structure by continuously parsing the bitstream, and then obtains the prediction residual information of the geometric position and the quantization parameter of each prediction node through parsing, and performs inverse quantization on the prediction residual for recovering, so as to obtain the reconstructed geometric position information of each node, and finally completes the geometric reconstruction on the decoding side.

The geometry information needs to be reconstructed after the geometry encoding is completed. At present, attribute encoding is mainly performed on color information. First, the color information is transformed from the RGB color space to the YUV color space. Then, the point cloud is re-colored by using the reconstructed geometry information, so that the unencoded attribute information corresponds to the reconstructed geometry information. In color information encoding, there are two main transformation manners: one is distance-based lifting transform that relies on LOD partitioning, and the other is that RAHT transform is performed directly. Both manners can transform the color information from the spatial domain to the frequency domain, the high-frequency coefficient and the low-frequency coefficient are obtained through the transform, and finally the coefficients are quantized and encoded to generate a binary bitstream, which are illustrated in FIG. 4A and FIG. 4B.

In addition, when the attribute information is predicted by using the geometry information, Morton code may be used for performing nearest neighbor search, where the Morton code corresponding to each point in the point cloud may be obtained from the geometric coordinate of this point. A method for calculating the Morton code is described below. For a three-dimensional coordinate with each component represented by a d-bit binary value, its three components may be represented as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} , \qquad ( 15 )$$

where [symbol] , [symbol] , [symbol] ∈{0,1} are binary values corresponding to bits, from the highest ( [symbol] =1) to the lowest ( [symbol] =d), of x, y, z, respectively. For x, y, z, starting from the highest bit, [symbol] , [symbol] , [symbol] are crosswise arranged in e-quaintance by using the Morton code M up to the lowest bit. The calculation formula of M is shown as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 16 )$$

where [symbol] ∈{0, 1} are values of M from the highest bit ( [symbol] ′=1) to the lowest bit ( [symbol] ′=3d). After the Morton code M of each point in the point cloud is obtained, the points in the point cloud are arranged in order of Morton code in an ascending order, and a weight value w of each point is set to 1.

It also should be noted that for the G-PCC codec framework, the general text conditions are as follows.

(1) There are 4 general test conditions:
condition 1: geometry positions with limited loss, and attributes with loss;
condition 2: geometry positions lossless, but attributes with loss;
condition 3: geometry positions lossless, and attributes with limited loss; and
condition 4: geometry positions lossless, and attributes lossless.

(2) The general test sequence includes four categories: Cat1A, Cat1B, Cat3-fused and Cat3-frame. Cat3-frame point cloud only includes reflectance attribute information, Cat1A and Cat1B point clouds only include color attribute information, and Cat3-fused point cloud includes both color attribute information and reflectance attribute information.

(3) There are two technical routes, which are distinguished by the algorithm used for geometry compression.

### Technical Route 1: The Octree Encoding Branch.

At the encoding side, a bounding box is continuously partitioned into sub-cubes; and partitioning is continued for non-empty sub-cubes (including points in the point cloud) until leaf nodes obtained by partitioning are unit cubes of 1×1×1. In a case of geometric lossless encoding, the number of points included in the leaf node needs to be encoded to finally complete the encoding of the geometric octree and generate the binary bitstream.

At the decoding side, the decoding side obtains, in the order of breadth-first traversal, an occupancy code of each node by continuous parsing, and the partitioning is continued for the nodes in turn until unit cubes of 1×1×1 are obtained. In a case of the geometric lossless decoding, the number of points included in each leaf node needs to be parsed, and the geometric reconstruction point cloud information is restored finally.

### Technical Route 2: The Prediction Tree Encoding Branch.

At the encoding side, a prediction tree structure is established by using two different manners including a high-latency slow mode (KD-Tree), and the use of laser radar calibration information (a low-latency fast mode). By using the laser radar calibration information, each point may be assigned into a different laser, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream.

At the decoding side, the decoding side reconstructs the prediction tree structure by continuously parsing the bitstream, and then obtains the prediction residual information of the geometric position and the quantization parameter of each prediction node through parsing, and performs inverse quantization on the prediction residual for recovering, so as to obtain the reconstructed geometric position information of each node, and finally completes the geometric reconstruction on the decoding side.

It also should be noted that, as illustrated in FIG. 4A or FIG. B, the current G-PCC encoding framework includes three attribute encoding methods: predicting transform (PT), lifting transform (LT), and region adaptive hierarchical transform (RAHT). The first two methods perform predictive encoding on the point cloud based on the generation order of LODs, and the RAHT performs an adaptive transforms on the attribute information from bottom to top based on the construction hierarchy of the octree. These three point cloud attribute encoding methods are explained in detail separately below.

### (a) Prediction Encoding of Point Cloud Attribute Information

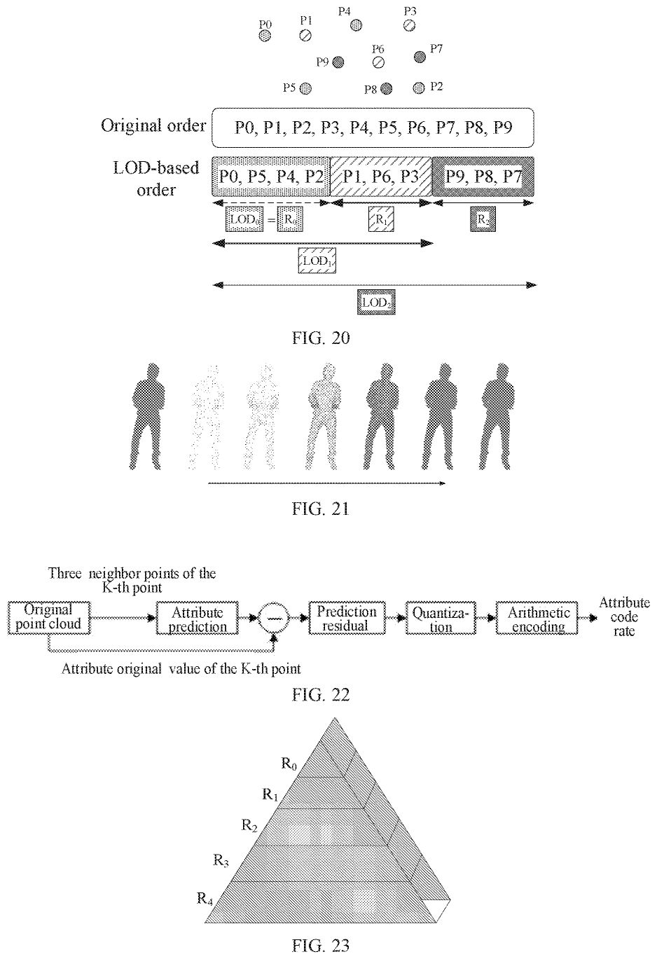

At present, the attribute prediction module of G-PCC uses a nearest neighbor attribute predictive encoding scheme based on a level-of-details (LoDs) structure. The LOD construction methods include a distance-based LOD construction scheme, a fixed sampling rate-based LOD construction scheme, and an octree-based LOD construction scheme. In the LOD construction scheme based on a distance threshold, the point cloud is first Morton sorted before constructing LOD to ensure that there is a strong attribute correlation between neighboring points. FIG. 20 is a schematic diagram of a distance-based LOD construction process. As illustrated in FIG. 20, the point clouds are partitioned into L different point cloud levels of detail (Rl) l=0,1, . . . . L−1 according to L Manhattan distances (dl) l=0,1, . . . . L−1 preset by the user, where (dl) l=0,1, . . . . L−1 meets dl less than dl−1. The construction process of LOD is as follows.

(1) First, all points in the point cloud are marked as unvisited, and a set V is established to store the visited point set. (2) For each iteration l, by traversing the points in the point cloud, if the current point has been visited, the current point is skipped, otherwise the minimum distance D from the current point to the point set V is calculated, if D less than dl, the point is skipped; otherwise, the current point is marked as visited, and the current point is added to the levels of detail Rl and the point set V. (3) The points in the level of detail LODl are composed of the points in the levels of detail R0, R1, R2 . . . . Rl; (4) The above operations are repeated until all points have been marked as visited.

Based on the LOD structure, the attribute value of each point is linearly weighted predicted by using the attribute reconstructed value of the point in the same or higher LOD level, where the maximum number of reference prediction neighbors is determined based on the encoder high-level syntax elements. For the attributes of each point, the rate-distortion optimization algorithm is used at the encoding side to select weighted prediction by using the attributes of the N nearest neighbor points searched or selecting the attributes of a single nearest neighbor point for prediction, and finally the selected prediction mode and prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 17 )$$

where N represents the number of prediction points in the nearest neighbor point set of point i, Pi represents a sum of the N nearest neighbor points of point i, Dm represents a spatial geometry distance from the nearest neighbor point m to the current point i, Attrₘ represents the attribute value of the nearest neighbor point m after reconstruction,

$${Attr}_{i}^{′}$$

represents the attribute prediction value of the current point i, and the number of points N is a preset value.

In order to balance the attribute encoding efficiency and parallel processing between different LOD levels, a switch is introduced in the encoder high-level syntax element to control whether to introduce intra-LOD level prediction. If the switch is turned on, intra-LOD level prediction is started, and points in the same LOD level may be used for prediction. It should be noted that in a case where the number of LOD levels is 1, intra-LOD level prediction is always used.

FIG. 21 is a schematic diagram of a visualization result of an LOD generation process. As illustrated in FIG. 21, a subjective example of a distance-based LOD generation process is provided. From left to right, the points in the first level represent the outer contour of the point cloud; and as the number of refinement levels increases, the described details of the point cloud become progressively clearer.

FIG. 22 is a schematic diagram of a flowchart of the attribute prediction encoding. As illustrated in FIG. 22, in the process of the G-PCC attribute prediction, for an original point cloud, three nearest neighbors of the K-th point are first searched, and then attribute prediction is performed. The prediction residual of the K-th point may be obtained by calculating the difference between the attribute prediction value of the K-th point and the attribute original value of the K-th point. Next, quantization and arithmetic encoding is performed, and the attribute code rate is finally generated.

### (i) Optimal Prediction Value Selection

After the LOD is constructed, the three nearest neighbor points of the current point to be encoded are first found from the encoded data points based on the generation order of the LOD. The attribute reconstructed values of the three nearest neighbor points are used as candidate prediction values of the current point to be encoded; then, the optimal prediction value is selected from the candidate prediction values according to the rate-distortion optimal (RDO). For example, in a case of encoding the attribute value of point P2 in FIG. 20, the predictor variable index of the attribute value of the nearest neighbor point P4 is set to 1; the attribute predictor variable indices of the second neighboring point P5 and the third neighboring point P0 are set to 2 and 3 respectively; and the predictor variable index of the weighted average of points P0, P5 and P4 is set to 0, as shown in Table 1; and finally, the optimal predictor variable is selected by using the RDO. The formula of the weighted average is as follows:

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) ; \qquad ( 18 )$$

where \tilde{w}ᵢⱼ represents the spatial geometric weight from the neighboring point j to the current point i, and

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 19 )$$

where âᵢ represents the attribute prediction value of the current point i, j represents the indices of the three neighboring points, ãⱼ represents the attribute value of a neighboring point after reconstruction, xᵢ, yᵢ, zᵢ are the geometric position coordinates of the current point i, and xᵢⱼ, yᵢⱼ, zᵢⱼ are the geometric coordinates of the neighboring point j.

Exemplarily, Table 1 provides an example of samples of candidate prediction items for attribute encoding.

TABLE 1

| Prediction | |
|---|---|
| mode | Prediction value |
| 0 | Weighted average of attributes of three neighbors |
| 1 | P4 (an attribute value of the first neighbor) |
| 2 | P5 (an attribute value of the second neighbor) |
| 3 | P0 (an attribute value of the third neighbor) |

### (ii) Attribute Prediction Residual and Quantization

Through the above prediction, the attribute prediction value (âᵢ)_{i∈0 . . . k-1} (where k represents a total number of points in the point cloud) of the current point i is obtained. Let (âᵢ)_{i∈0 . . . k-1} be the attribute original value of the current point, then the attribute residual (rᵢ)_{i∈0 . . . k-1} is denoted as:

$${r}_{i} = {a}_{i} - {\hat{a}}_{i} \qquad ( 20 )$$

In addition, the prediction residual is quantified as follows:

$${Q}_{i} = \frac{{r}_{i}}{Qs} ; \qquad ( 21 )$$

where Qᵢ represents the attribute residual of the current point i after quantization, and Qs represents the quantization step, which may be calculated by the quantization parameter (QP) specified by CTC.
(iii) Reconstruction of Attribute Value at Encoding Side

The purpose of reconstruction at the encoding side is to predict subsequent points. Before the reconstruction of the attribute value, the residual needs to undergo inverse quantization, where \hat{r}ᵢ is denoted as the residual after inverse quantization:

$${\hat{r}}_{i} = {Q}_{i} \times Qs ; \qquad ( 22 )$$

where the reconstructed value ãᵢ of the point i is obtained by adding îᵢ to the prediction value âᵢ:

$${\tilde{a}}_{i} = {\hat{r}}_{i} + {\hat{a}}_{i} \qquad ( 23 )$$

When performing attribute nearest neighbor search based on LOD partitioning, there are currently two major types of algorithms: intra nearest neighbor search and inter nearest neighbor search. The algorithm of the inter nearest neighbor search is as follows. The intra nearest neighbor search may be divided into two algorithms: inter-level nearest neighbor search and intra-level nearest neighbor search.

### (i) Intra Nearest Neighbor Search

The intra nearest neighbor search is divided into two algorithms: inter-level nearest neighbor search and intra-level nearest neighbor search. After LOD partitioning, a pyramid structure similar to that illustrated in FIG. 23 is obtained.

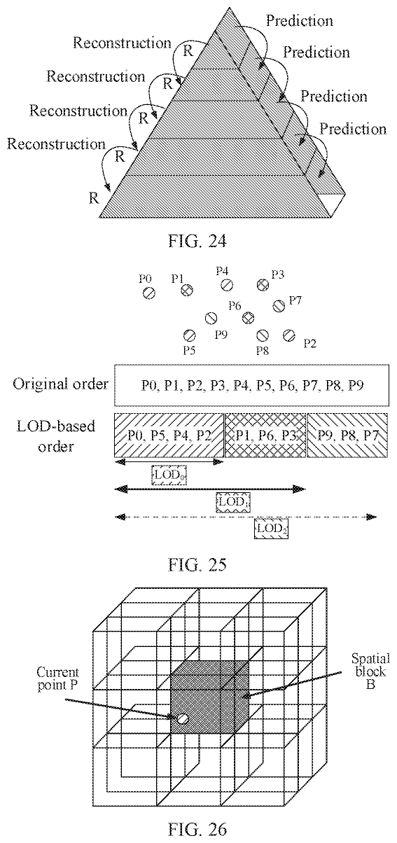

In an implementation, for the inter-level nearest neighbor search, the pyramid structure is illustrated in FIG. 24. FIG. 25 is a schematic diagram of LOD construction process for the inter-level nearest neighbor search. As illustrated in FIG. 25, different LOD levels, namely LOD0, LOD1 and LOD2, are obtained based on the geometry information partitioning, and points in LOD0 are used to predict attributes of points in a next LOD during the process of the inter-level nearest neighbor search.

The entire process of the intra nearest neighbor search is described below.

During the entire process of LOD partitioning, there are three sets O(k), L(k) and I(k), where k is the index of the LOD level during LOD partitioning, and I(k) is the input point set during the current LOD level partitioning. After the LOD partitioning, O(k) set and L(k) set are obtained. The O(k) set stores the sample set, and L(k) is the point set in the current LOD level. That is, the entire process of LOD partitioning is as follows.
(1) Initialization

$$if k = 0 , ( k ) ← \{ \} ; Otherwise ( k ) ← L ( k - 1 )$$

$$O ( k ) ← \{ \} ;$$

(2) Based on the LOD partitioning algorithm, the samples are stored in O(k), and the remaining points are partitioned into L(k).
(3) In a case of performing the next iteration I←O(k)

It should be noted here that since the entire process of LOD partitioning is based on the Morton code, O(k), L(k) and I(k) store the Morton code index corresponding to the point.

When performing the inter-level nearest neighbor search, that is, the points in the L(k) set performing nearest neighbor search in the O(k) set, the search algorithm is as follows.

Taking an example in which the nearest neighbor search is performed based on the spatial relationship, when predicting the current point P, neighbor search is performed by using the parent block (Block B) corresponding to the point P, as illustrated in FIG. 26, to search for points in neighbor blocks that are co-planar or co-edge with the current parent block to perform attribute prediction.

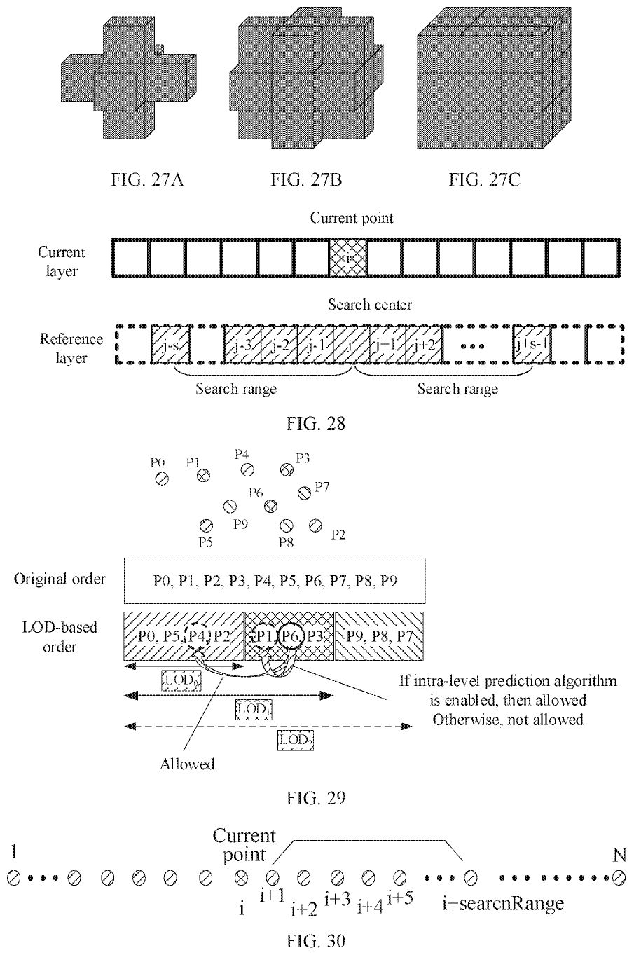

FIG. 27A is a schematic diagram illustrating a co-planar spatial relationship, with a total of 6 spatial blocks have relationship with the current parent block. FIG. 27B is a schematic diagram illustrating co-planar and co-edge spatial relationships, with a total of 18 spatial blocks having relationship with the current parent block. FIG. 27C is a schematic diagram illustrating co-planar, co-edge, and co-vertex spatial relationships, with a total of 26 spatial blocks having relationship with the current parent block.

First, the coordinates of the current point are used to obtain a corresponding spatial block. Then, the nearest neighbor search is performed in the previously encoded LOD level to find spatial blocks that are co-planar, co-edge, and co-vertex with the current block, so as to obtain N neighbors of the current point.

If the N neighbors of the current point are still not obtained after performing co-planar, co-edge and co-vertex nearest neighbor searches, the N neighbors of the current point will be obtained based on a fast search algorithm, and the algorithm is as follows.

As illustrated in FIG. 28, when performing attribute inter-level prediction, the Morton code corresponding to the current point is first obtained using the geometric coordinates of the current point to be encoded. Next, based on the Morton code of the current point, the reference point (j) whose Morton code is a first one greater than the Morton code of the current point is found in the reference picture. Then, the nearest neighbor search is performed in the range of [j-searchRange, j+searchRange].

The rest of the algorithms for updating the nearest neighbor are consistent with the inter nearest neighbor search algorithm, which will not be repeated here. The algorithms will be mentioned in the inter nearest neighbor search algorithm.

In another implementation, for the intra-level nearest neighbor search, FIG. 29 is schematic diagram illustrating the LOD structure of attribute intra-level nearest neighbor search. As illustrated in FIG. 29, if the intra-level prediction algorithm is enabled (i.e., the syntax element EnableRefferingSameLoD=1), the intra-level nearest neighbor search is allowed. For example, for the LOD1 level, the nearest neighbor of the current point P6 may be P1, but other levels are not allowed. If the syntax element EnableRefferingSameLoD=0, the inter-level search is allowed for other levels. For example, for the LOD1 level, the nearest neighbor of the current point P6 may be P4. That is, when the intra-level prediction algorithm is enabled, in the same LOD level, a nearest neighbor search is performed on the set of encoded points in the same level to obtain the N neighbors of the current point (inter-level nearest neighbor search is also performed).

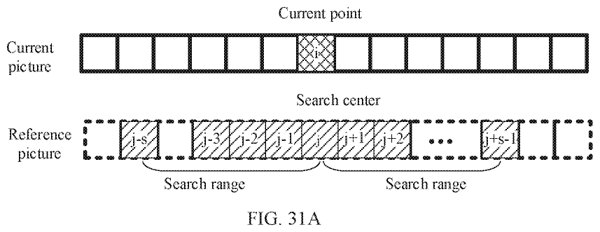

When performing the attribute inter-level prediction, the nearest neighbor search is performed based on the fast search algorithm. The algorithm is illustrated in FIG. 30. Here, the current point is represented by the grid. Assuming that the Morton code index of the current point is i, the nearest neighbor search will be performed in [i+1, i+searchRange]. The nearest neighbor search algorithm is the same as the block-based inter fast search algorithm, which will not be repeated here.

### (ii) Inter Nearest Neighbor Search

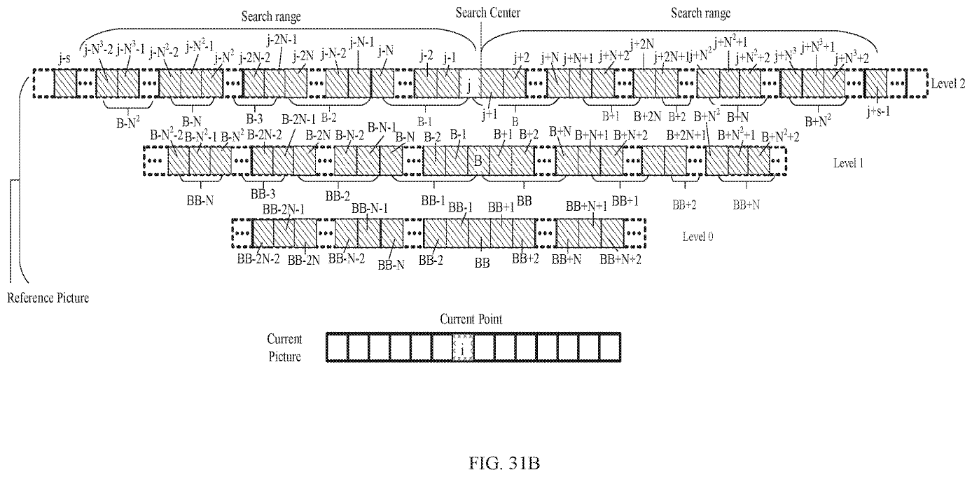

FIG. 31A is a schematic diagram of attribute inter prediction based on the fast search. As illustrated in FIG. 31A, when performing the attribute inter prediction, the Morton code corresponding to the current point is first obtained by using the geometric coordinate of the current point to be encoded. Next, based on the Morton code of the current point, the reference point (j) whose Morton code is a first one greater than the Morton code of the current point is found in the reference picture. Then, the nearest neighbor search is performed in the range of [j−searchRange, j+searchRange].

At present, when performing the intra nearest neighbor search and the inter nearest neighbor search, the neighborhood search is performed based on blocks, see FIG. 31B for details. As illustrated in FIG. 31B, when performing the neighborhood search on the current point (Morton code index is i), the points in the reference picture are first partitioned into N (N is equal to 3) levels according to the Morton code. The partitioning algorithm is as follows:
first level: it is assumed that points contained in the reference picture are numPoints, the points in the reference picture are first partitioned into a block every M (M=2⁵=32) points;
second level: on the basis of the first level, the blocks of the first level are partitioned into one block every M (M=2⁵=32) blocks according to the order of Morton code; and.
third level: on the basis of the second level, the blocks of the second level are partitioned into one block every M (M=2⁵=32) blocks according to the order of Morton code.

Finally, the prediction structure illustrated in FIG. 31B is obtained.

When performing the attribute prediction based on the prediction structure illustrated in FIG. 31B, assuming that the Morton code index of the current point to be encoded is i, firstly, the point in the reference picture whose Morton code is a first one greater than or equal to the Morton code of the current point is obtained, with an index of j. Next, the block index of the reference point is calculated based on j. The calculation manner is as follows;
first level: BucketSize_0=2⁵=32;
second level: BucketSize 1=2⁵=32×BucketSize_0=1024; and
third level: BucketSize 2=2⁵=32×BucketSize 1=32768.

Assuming that the reference range in the prediction picture of the current point is [j−searchRange, j+searchRange], the starting index of the third level is calculated by using j−searchRange, and the ending index of the third level is calculated by using j+searchRange. Next, it is determined whether some blocks of the second level need to undergo the nearest neighbor search in the blocks of the third level; then, moving to the second level, it is determined whether a search is needed for each block of the first level; if some blocks of the first level need to undergo the nearest neighbor search, some points of the blocks of the first level will be determined point by point to update the nearest neighbors.

The index-based calculation block algorithm is introduced below. Assuming that the Morton code index corresponding to the current point is “index”, the index of the corresponding third level block is as follows:

$$idx\_ 2 = index / BucketSize\_ 2 \qquad ( 24 )$$

After the block index idx_2 of the third level is obtained, the starting index and the ending index of the block of the second level corresponding to the current block may be obtained by using idx_2:

$$startIdx 1 = idx\_ 2 \times BucketSize\_ 1 \qquad ( 25 )$$

$$endIdx = idx\_ 2 \times BucketSize\_ 1 + BucketSize\_ 1 - 1 \qquad ( 26 )$$

Similarly, based on the same algorithm, the block index of the first level is obtained based on the block index of the second level.

When performing the nearest neighbor search based on blocks, it is first determined whether the current block needs to undergo the nearest neighbor search, that is, filtering the nearest neighbor search of the block. Each spatial block may be obtained based on two variables minPos and maxPos, where minPos represents the minimum value of the block and maxPos represents the maximum value of the block.

Assuming that the distance of the farthest point among the N neighbors that is searched by the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as follows:

$$int dx = int ( std \text{::} max ( std \text{::} max ( min Pos [ 0 ] - point [ 0 ] , 0 ) , point [ 0 ] - max Pos [ 0 ] ) ) ;$$

$$int dy = int ( std \text{::} max ( std \text{::} max ( min Pos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

where when D is less than or equal to Dist, the points in the current block will be traversed.

### (b) Lifting Transform Encoding of Attribute Information of Point Cloud

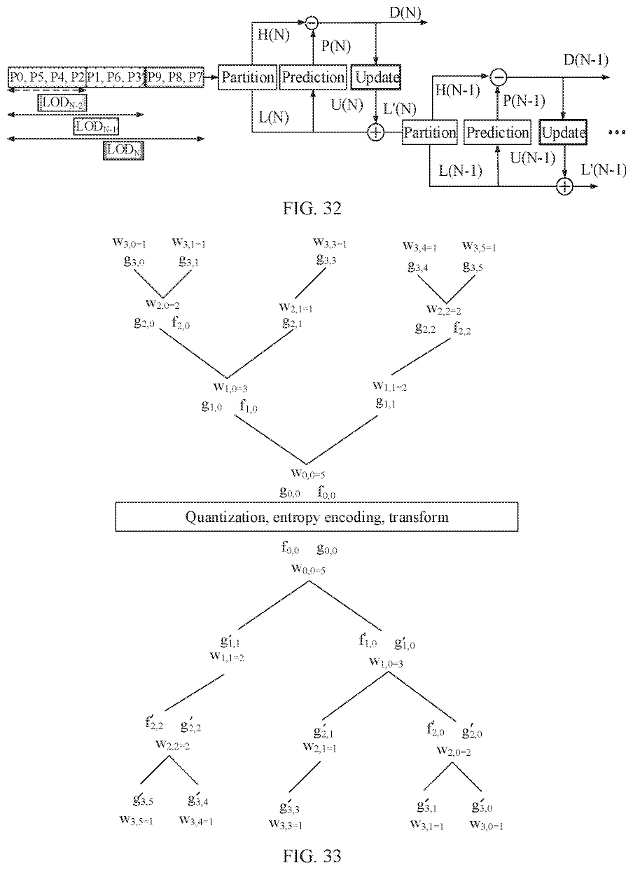

FIG. 32 is a schematic diagram of a flowchart illustrating an encoding process of the lifting transform. The lifting transform also performs predictive encoding on the attributes of the point cloud based on LOD. The difference from the predicting transform is that the lifting transform first partitions the LOD into higher and lower levels, performs prediction in the reversed order of the LOD level generation, and introduces an update operator in the prediction process to update the quantization weights of the points in the lower LOD level to improve the accuracy of the prediction. This is because the attribute values of points in the lower LOD level are frequently used to predict the attribute values of points in the higher LOD level, and points in the lower LOD level should have greater influence.

### Operation 1: Partitioning Process.

The partitioning process is to partition the complete LOD level into lower LOD levels L(N) and higher LOD levels H(N). If a point cloud has three levels of LOD, i.e., (LODₗ)_{l=0,1,2}, after partitioning, LOD₂ is the higher LOD level and denoted as H(N), and (LODₗ)_{l=0,1} are the lower LOD levels and denoted as L(N).

### Operation 2: Prediction Process.

The point in the higher LOD level selects the attribute information of the nearest neighbor points from the lower LOD level as the attribute prediction value P (N) of the current point to be encoded. The prediction residual D (N) is denoted as:

$$D ( N ) = H ( N ) - P ( N ) \qquad ( 27 )$$

### Operation 3: Update Process.

The attribute prediction residual D (N) in the higher LOD level is updated to obtain U(N), and the attribute values of the points in the lower LOD level are lifted using U(N), as shown in the formula as follows:

$${L}^{′} ( N ) = L ( N ) + U ( N ) \qquad ( 28 )$$

The above process will iterate continuously until the lowest LOD level according to the order of LOD from high to low.

Since the LOD-based prediction scheme makes the points in the lower LODs have greater influence, the transform scheme based on lifting wavelet transform introduces quantization weights and updates the prediction residual according to the prediction residual D (N) and the distance between the prediction point and the neighboring points. Finally, adaptive quantization is performed on the prediction residual by using the quantization weights in the transform process. It should be noted here that the quantization weight value of each point may be determined by geometric reconstruction at the decoding side, so the quantization weight do not need to be encoded.

### (c) Region Adaptive Hierarchical Transform

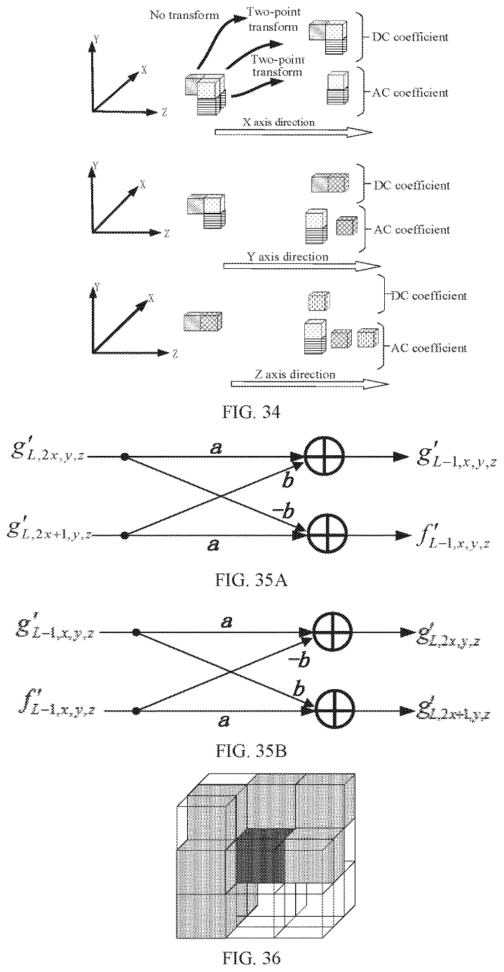

The RAHT is a Haar wavelet transform that may transform the attribute information of the point cloud from the spatial domain to the frequency domain and further reduce the correlation between the attributes of the point cloud. The main idea of the RATH is to transform the nodes in each layer from the three dimensions of X, Y, and Z (as illustrated in FIG. 34) in a bottom-up manner according to the octree structure, and to perform iteration until reaching the root node of the octree. As illustrated in FIG. 33, the basic idea is to perform wavelet transform based on the hierarchical structure of the octree, associate the attribute information with the nodes of the octree, and recursively transform the attributes of the occupied nodes in the same parent node in the bottom-up manner. The nodes in each layer are transformed from the three dimensions of X, Y, and Z until reaching the root node of the octree. During the process of hierarchical transform, the obtained low-pass/low-frequency (DC) coefficients of the nodes at the same layer after transformation are passed to the nodes in the next layer for further transformation, while all high-pass/high-frequency (AC) coefficients may be encoded by the arithmetic encoder.

During the transformation process, the DC coefficient (direct current component) of the nodes at the same layer after transformation will be passed to the previous layer for further transformation, and the AC coefficient (alternating current component) after transformation of each layer will be quantized and encoded. The main transformation process is introduced below.

FIG. 35 is a schematic diagram of a process of a type of RAHT forward transform, and FIG. 35B is a schematic diagram of a process of a type of RAHT inverse transform. For the transform and inverse transform process corresponding to the RAHT, assuming that

$${g}_{L , 2 x , y , z}^{′} and {g}_{L , 2 x + 1 , y , z}^{′}$$

are two attribute DC coefficients that are neighboring points in the L layer. After the linear transformation, the information of the L−1 layer is the AC coefficient

$${f}_{L - 1 , x , y , z}^{′}$$

and the DC coefficient

$${g}_{L - 1 , x , y , z}^{′} ;$$

then, no more transform will be performed on

$${f}_{L - 1 , x , y , z}^{′} ,$$

and quantization encoding will be performed on

$${f}_{L - 1 , x , y , z}^{′}$$

directly;

$${g}_{L - 1 , x , y , z}^{′}$$

will continue to search nearest neighbors for transformation, and it will be passed directly to the L−2 layer if none are found. That is, the RAHT transform is only valid for nodes with neighboring points, and nodes without neighboring points will be passed directly to the previous layer. In the above transformation process, the weights corresponding to

$${g}_{L , 2 x , y , z}^{′} and {g}_{L , 2 x + 2 , y , z}^{′}$$

(the number of non-empty child nodes in a node) are

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 x , y , z}^{′} is {w}_{L - 1 , x , y , z}^{′} ,$$

then the general transformation formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] ; \qquad ( 29 )$$

where T_{w0,w1} in the formula is a transformation matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 30 )$$

The transform matrix will be updated as the weights corresponding to each point change adaptively. The above process will be continuously iterated and updated based on the partition structure of the octree until reaching the root node of the octree.

### Region Adaptive Hierarchical Intra Predicting Transform Encoding

The region adaptive hierarchical predicting transform encoding performs prediction based on the RAHT transform encoding. As illustrated in FIG. 33, the RAHT attribute transform is continuously performed, based on the order of the octree hierarchy, from the voxel level until the root node is obtained, thereby completing the hierarchal transform encoding of the entire attribute. In predicting transform encoding, the attribute predicting transform encoding is also performed based on the order of the octree hierarchy, but the transform is performed continuously from the root node to the voxel level. In each RAHT attribute transform process, the attribute predicting transform encoding is performed based on a 2×2×2 block. FIG. 36 is a schematic diagram illustrating an attribute encoding block. As illustrated in FIG. 36, it can be seen that the block filled with dark color is the current block to be encoded, and the blocks filled with light color are some neighborhood blocks that are co-planar and co-edged with the current block to be encoded.

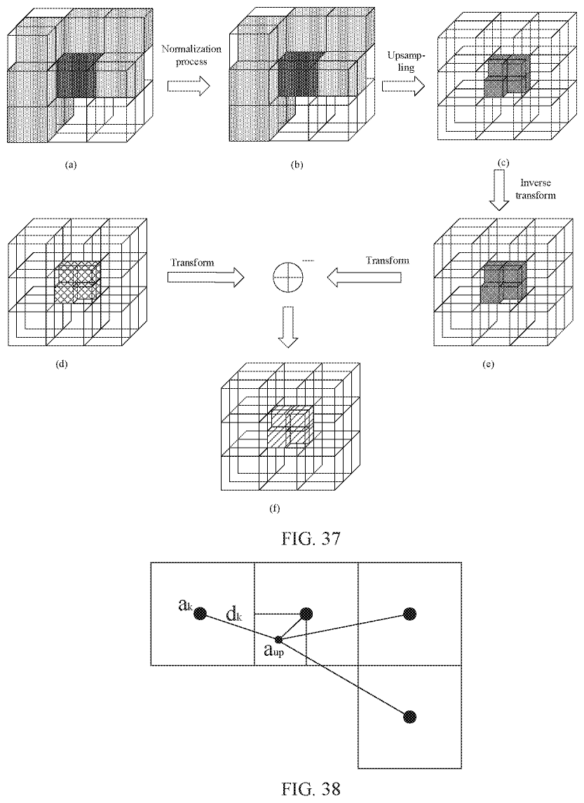

FIG. 37 is a schematic diagram illustrating a principle of RAHT-based attribute predicting transform encoding. First, the attribute of the current block (Anode) may be obtained through the attributes of the points contained in the current node, as illustrated in FIG. 37(a), and the details is as follows:

$${A}_{node} = {\sum }_{p ∈ node} attribute ( p ) \qquad ( 31 )$$

Next, the number of points in the current block is normalized by using the attribute of the current block, to obtain the attribute average value of the current block (anode), as illustrated in FIG. 37(b). The normalization process is as follows:

$${w}_{node} = {\sum }_{p ϵ node} 1 = \# \{ p ∈ node \} \qquad ( 32 )$$

$${a}_{node} = {A}_{node} / {w}_{node} \qquad ( 33 )$$

The attribute average value of the current block is used for the attribute transform encoding.

In addition, the linear weighted prediction is performed on the attribute of each sub-block by using the spatial geometric distance between the neighbor block of the current block and each sub-block of the current block, to obtain the predicted attributes of sub-blocks of the current block, also referring to as the predicted attribute block, as illustrated in FIG. 37(c). Inverse nominalization is performed on the predicted attribute of the current block to obtain the final predicted attribute, as illustrated in FIG. 37(e). FIG. 37(d) illustrates the original attribute of the current block, also referred to as the original attribute block. Finally, the attribute transform is performed on both the predicted attribute and the original attribute of the sub-block to obtain an original AC coefficient and a predicted AC coefficient. An AC coefficient residual is obtained according to the original AC coefficient and the predicted AC coefficient. FIG. 37(f) illustrates the AC coefficient residual of the current block, and the AC coefficient parameters are encoded.

FIG. 38 is a schematic diagram illustrating the neighborhood prediction relationship for a type of attribute prediction. As illustrated in FIG. 38, first, neighbor blocks of the current block (up to 19 neighbor blocks) are determined. Next, the linear weighted prediction is performed on the attribute of each sub-block aᵤₚ by using the spatial geometric distance between the neighbor block and each sub-block of the current block. Finally, a transform is performed on the attribute of the predicted block. The manner of attribute transform is as follows:

$$[ \begin{matrix}* \\ A {C}_{1 , orig} ⋮ \\ A {C}_{k - 1 , orig}\end{matrix} ] = {T}_{node} [ \begin{matrix}{A}_{1} orig / \sqrt{{w}_{1}} ⋮ \\ {A}_{k , orig} / \sqrt{{w}_{k}}\end{matrix} ] \qquad ( 34 )$$

$$[ \begin{matrix}* \\ A {C}_{1 , up} ⋮ \\ A {C}_{k - 1 , up}\end{matrix} ] = {T}_{node} [ \begin{matrix}{A}_{1 , up} / \sqrt{{w}_{1}} ⋮ \\ {A}_{k , up} / \sqrt{{w}_{k}}\end{matrix} ] \qquad ( 35 )$$

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] \qquad ( 36 )$$

### Region Adaptive Hierarchical Inter Predicting Transform Encoding

In the current G-PCC attribute inter prediction encoding, if inter prediction encoding is enabled, an RAHT attribute transform encoding structure is first constructed based on the geometry information of the current node to be encoded. That is, node merging is performed continuously from the voxel level until the root node of the entire RAHT transform tree is obtained, thereby completing the hierarchical structure for the entire attribute transform encoding. Next, based on the RAHT transform structure, partitioning is performed from the root node to obtain N (N is less than or equal to 8) child nodes of each node. In a second scheme of inter prediction, an independent orthogonal transform is first performed on the attributes of the N child nodes by using RAHT transform to obtain DC and AC coefficients. Then, attribute inter prediction is performed on the AC coefficients of the N child nodes in a manner as follows.

In a case where the inter prediction node of the current node is valid, that is, a collocated node exists, the attribute of the prediction node is directly used as the attribute prediction value of the current node to be encoded.

In a case where the current node can find, in the buffer of reference picture, a node at the exact same position as the current node, that is, the collocated node exists, AC coefficients of M child nodes contained in the collocated node are directly used as AC coefficient attribute prediction values of N child nodes of the current node.

1. If the AC coefficient of the prediction node is non-zero, the AC coefficient of the prediction node is directly used as the prediction value.

2. If the AC coefficient of the prediction node is zero, an AC coefficient of a child node corresponding to the intra prediction is used as the prediction value.

In a case where the inter prediction node of the current node is invalid, that is, the collocated node does not exist, an attribute prediction value of an intra neighborhood node is used as the attribute prediction value of the node to be encoded.

In addition, on the basis of the above, the existing RAHT inter encoding would select for each layer the optimal RAHT encoding mode: intra prediction encoding or inter prediction encoding. If the cost of the intra prediction encoding mode is less than that of the inter prediction encoding mode, RAHT intra prediction is performed on the current layer; otherwise, RAHT inter prediction is performed.

In the existing G-PCC attribute RAHT intra encoding, whether to use a predictive encoding scheme for performing the intra prediction on the attribute is determined in the high-level APS syntax element, where the predictive encoding scheme includes parent node prediction and child node prediction. In the existing RAHT intra encoding scheme, when the predictive encoding scheme is enabled, whether the number N of neighborhood nodes of the current node is greater than a certain threshold is first used. Only when the number of neighborhood nodes is greater than the certain threshold is a prediction (intra prediction) on the AC coefficient of the current node performed. If the number N of neighborhood nodes of the current node is less than the certain threshold, it is considered that the current node does not meet the condition for predictive encoding, and only an attribute transform will be performed on the current node. The main advantage of the encoding scheme is that, through using the spatial correlation of the current node, particularly the neighborhood distribution characteristics of the current node, the neighborhood geometric spatial correlation of the current node is effectively taken into consideration, thereby effectively improving the encoding efficiency of point cloud attribute information. However, this encoding scheme does not consider the distribution characteristics of the AC coefficient attribute information of each node itself; instead, it is an encoding scheme in which the attribute prediction of the current sequence is directly determined in the sequence set. In addition, when enabling the predictive encoding scheme, the encoding mode of the current node is determined solely based on the neighborhood geometric spatial correlation of the current node, without effectively considering the attribute distribution characteristics of the current node, thereby resulting in relatively low intra encoding efficiency for the attribute information.

In the existing G-PCC attribute RAHT inter encoding, whether to use an inter predictive encoding scheme or an intra predictive encoding scheme for performing the predictive encoding on the attribute information is determined in the high-layer APS syntax element, and the starting layer index of inter prediction encoding is determined based on the syntax element treeDepth; and for RAHT encoding layer below this depth, only RAHT intra prediction encoding is performed. This attribute encoding scheme has two main problems. The first is that there is no analysis for the distribution of AC coefficients at different RAHT encoding layers in different slices, instead directly determining the attribute inter encoding scheme of the current sequence in the sequence set. The second is that by determining the number of layers for the inter prediction in the APS, since the intra correlation of AC coefficients at lower RAHT encoding layers is stronger than the inter correlation of AC coefficients, inter encoding is often enabled only at the upper RAHT encoding layers. However, this encoding scheme fails to fully and effectively utilize the distribution of AC coefficients at different RAHT attribute encoding layers, thereby resulting in relatively low encoding efficiency for the attribute information.

Based on the above, the embodiments of the present disclosure provide an encoding method and a decoding method. When performing the region adaptive hierarchical transform (RAHT) encoding or RAHT decoding, one or more new encoding and decoding modes are introduced, and the mode selection is performed by comprehensively considering the neighborhood geometry distribution characteristics and the neighborhood attribute distribution characteristics of the node of the current layer, to provide an optimal encoding and decoding mode for the current node, thereby improving the efficiency of RAHT attribute encoding and decoding.

To facilitate understanding of the technical solutions of the embodiments of the present disclosure, the technical solutions of the present disclosure will be described in detail below through exemplary embodiments. The related technologies described above, serving as optional solutions, can be arbitrarily combined with the technical solutions of the embodiments of the present disclosure, all of which fall within the protection scope of the embodiments of the present disclosure. The embodiments of the present disclosure include at least some of the following content. The present disclosure provides an encoding and decoding method, and more specifically, a point cloud encoding and decoding technology.

In a first clause, a decoding method is provided, which is applied in a decoder and includes:
decoding a bitstream to determine a first syntax element flag;
in a case of determining, according to the first syntax element flag, to enable a mode selection when region adaptive hierarchical transform (RAHT) decoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target decoding mode of the node of the current layer from candidate decoding modes according to the neighborhood attribute distribution information, where the candidate decoding modes include: an attribute prediction and transform mode, and an attribute transform mode; and
performing attribute decoding on the node of the current layer according to the target decoding mode, to determine an attribute reconstructed value of the node of the current layer.

In a second clause, according to the first clause, the method further includes:
decoding the bitstream to determine a second syntax element flag;
determining, according to the second syntax element flag, a target prediction mode for the mode selection enabled at the current layer; and
determining the candidate decoding modes according to the target prediction mode.

In a third clause, according to the second clause, where determining the candidate decoding modes according to the target prediction mode includes:
in a case where the target prediction mode is an intra prediction mode, determining that the attribute prediction and transform mode includes an attribute intra prediction and transform mode;
in a case where the target prediction mode is an inter prediction mode, determining that the attribute prediction and transform mode includes an attribute inter prediction and transform mode; and
in a case where the target prediction mode is an inter-intra prediction mode, determining that the attribute prediction and transform mode includes an attribute inter prediction and transform mode, an attribute intra prediction and transform mode, and an attribute inter-intra prediction and transform mode.

In a fourth clause, according to the second clause or the third clause, where determining the neighborhood attribute distribution information of the node of the current layer includes:
determining an attribute reconstructed value of a first reference node of the node of the current layer according to the target prediction mode; and
determining the neighborhood attribute distribution information of the node of the current layer according to the attribute reconstructed value of the first reference node.

In a fifth clause, according to the fourth clause, where
in a case where the target prediction mode is an intra prediction mode, the first reference node includes at least one of: a neighborhood node of a parent node, or a reconstructed neighborhood node at a same layer;
in a case where the target prediction mode is an inter prediction mode, the first reference node includes at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer; and
in a case where the target prediction mode is an inter-intra prediction mode, the first reference node includes at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer.

In a sixth clause, according to the fifth clause, where the neighborhood attribute distribution information includes a difference between the attribute reconstructed value of the first reference node and an attribute reconstructed value of the parent node, and a difference between the attribute reconstructed value of the first reference node and an attribute reconstructed value of the collocated parent node.

In a seventh clause, according to any one of the fourth clause to the sixth clause, where determining the target decoding mode of the node of the current layer from the candidate decoding modes according to the neighborhood attribute distribution information includes:
in response to the neighborhood attribute distribution information meeting a second prediction condition, determining that the target decoding mode is the attribute prediction and transform mode; and
in response to the neighborhood attribute distribution information not meeting the second prediction condition, determining that the target decoding mode is the attribute transform mode.

In an eighth clause, according to the seventh clause, where
in a case where the target prediction mode is an intra prediction mode, the second prediction condition includes a prediction condition corresponding to an attribute intra prediction and transform mode;
in a case where the target prediction mode is an inter prediction mode, the second prediction condition includes a prediction condition corresponding to an attribute inter prediction and transform mode; and
in a case where the target prediction mode is an inter-intra prediction mode, the second prediction condition includes a prediction condition corresponding to an attribute intra prediction and transform mode, a prediction condition corresponding to an attribute inter prediction and transform mode, and a prediction condition corresponding to an attribute inter-intra prediction and transform mode.

In a ninth clause, according to any one of the first clause to the third clause, where determining the neighborhood attribute distribution information of the node of the current layer includes:
decoding the bitstream to determine the neighborhood attribute distribution information.

In a tenth clause, according to the ninth clause, where the neighborhood attribute distribution information includes a third syntax element flag for indicating the target decoding mode.

In an eleventh clause, according to the tenth clause, where the third syntax element flag is used to indicate a target decoding mode of the current layer; or the third syntax element flag is used to indicate a target decoding mode of a coefficient group of the current layer.

In a twelfth clause, according to any one of the first clause to the eleventh clause, where the first syntax element flag, a second syntax element flag, and a third syntax element flag are set in an attribute brick header (ABH) information parameter set.

In a thirteenth clause, according to the second clause, where determining the neighborhood geometry distribution information of the node of the current layer includes:
determining the neighborhood geometry distribution information according to the target prediction mode.

In a fourteenth clause, according to the thirteenth clause, where determining the neighborhood geometry distribution information according to the target prediction mode includes:
in a case where the target prediction mode is an intra prediction mode, determining that the neighborhood geometry distribution information includes a number of neighborhood nodes of a parent node of the node of the current layer, and a number of neighborhood nodes of a grandparent node of the node of the current layer;
in a case where the target prediction mode is an inter prediction mode, determining that the neighborhood geometry distribution information includes occupancy information of a collocated parent node of the node of the current layer, and occupancy information of a parent node of the node of the current layer; and
in a case where the target prediction mode is an inter-intra prediction mode, determining that the neighborhood geometry distribution information includes occupancy information of a collocated parent node of the node of the current layer and occupancy information of a parent node of the node of the current layer, and a number of neighborhood nodes of the parent node of the node of the current layer and a number of neighborhood nodes of a grandparent node of the node of the current layer.

In a fifteenth clause, according to the thirteenth clause, where
in a case where the target prediction mode is an intra prediction mode, the first prediction condition includes that a number of neighborhood nodes of a parent node is greater than a first threshold, and a number of neighborhood nodes of a grandparent node is greater than a second threshold;
in a case where the target prediction mode is an inter prediction mode, the first prediction condition includes that a collocated parent node exists, and occupancy information of the collocated parent node is the same as occupancy information of a parent node; and
in a case where the target prediction mode is an inter-intra prediction mode, the first prediction condition includes that a number of neighborhood nodes of a parent node is greater than a first threshold, a number of neighborhood nodes of a grandparent node is greater than a second threshold, a collocated parent node exists, and occupancy information of the collocated parent node is the same as occupancy information of the parent node.

In a sixteenth clause, according to the first clause, where in a case where the target decoding mode is the attribute prediction and transform mode, performing the attribute decoding on the node of the current layer according to the target decoding mode to determine the attribute reconstructed value of the node of the current layer includes:
determining an attribute prediction value of the node of the current layer;
performing an attribute transform according to the attribute prediction value of the node of the current layer, to obtain an alternating current (AC) coefficient prediction value of the node of the current layer;
decoding the bitstream to determine an AC coefficient residual value of the node of the current layer;
determining an AC coefficient reconstructed value of the node of the current layer according to the AC coefficient prediction value and the AC coefficient residual value of the node of the current layer; and
performing an inverse transform according to the AC coefficient reconstructed value and a direct current (DC) coefficient reconstructed value of a parent node of the node of the current layer, to determine the attribute reconstructed value of the node of the current layer.

In a seventeenth clause, according to the sixteenth clause, where determining the attribute prediction value of the node of the current layer includes:
in a case where the attribute prediction and transform mode is an attribute intra prediction, determining a first intra prediction mode; and
determining a first attribute prediction value of the node of the current layer according to the first intra prediction mode;
or
in a case where the attribute prediction and transform mode is an attribute inter prediction, determining a first inter prediction mode; and
determining a second attribute prediction value of the node of the current layer according to the first inter prediction mode;
or
in a case where the attribute prediction and transform mode is an attribute inter-intra prediction, determining a first inter-intra prediction mode; and
determining a third attribute prediction value of the node of the current layer according to the first inter-intra prediction mode.

In an eighteenth clause, according to the seventeenth clause, where
the first intra prediction mode includes at least one of: an intra parent node prediction mode, an intra same-layer node prediction mode, or an intra parent node and same-layer node prediction mode;
the first inter prediction mode includes at least one of: an inter collocated parent node prediction mode, an inter collocated node prediction mode, or an inter collocated parent node and collocated node prediction mode; and
the first inter-intra prediction mode includes at least one of: an intra prediction mode, an inter prediction mode, or an inter-intra fusion prediction mode.

In a nineteenth clause, according to the first clause, where in a case where the target decoding mode is the attribute transform mode, performing the attribute decoding on the node of the current layer according to the target decoding mode, to determine the attribute reconstructed value of the node of the current layer includes:
decoding the bitstream to determine an AC coefficient reconstructed value of the node of the current layer; and
performing an inverse transform according to the AC coefficient reconstructed value and a DC coefficient reconstructed value of a parent node of the node of the current layer, to determine the attribute reconstructed value of the node of the current layer.

In a twentieth clause, according to any one of the first clause to the nineteenth clause, the method further includes:
in response to the neighborhood geometry distribution information not meeting the first prediction condition, determining that the target decoding mode of the node of the current layer is the attribute transform mode; and
performing attribute decoding on the node of the current layer according to the attribute transform mode, to determine the attribute reconstructed value of the node of the current layer.

In a twenty-first clause, an encoding method is provided, which is applied in an encoder and includes:
determining a first syntax element flag;
in a case of determining, according to the first syntax element flag, to enable a mode selection when region adaptive hierarchical transform (RAHT) encoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target encoding mode of the node of the current layer from candidate encoding modes according to the neighborhood attribute distribution information, where the candidate encoding modes include: an attribute prediction and transform mode, and an attribute transform mode;
performing attribute encoding on the node of the current layer according to the target encoding mode, to determine an attribute reconstructed value of the node of the current layer; and
encoding the first syntax element flag, and signalling obtained encoded bits into a bitstream.

In a twenty-second clause, according to the twenty-first clause, the method further includes:
determining, according to a second syntax element flag, a target prediction mode for the mode selection enabled at the current layer;
determining the candidate encoding modes according to the target prediction mode; and
encoding the second syntax element flag, and signalling obtained encoded bits into the bitstream.

In a twenty-third clause, according to the twenty-second clause, where determining the candidate encoding modes according to the target prediction mode includes:
in a case where the target prediction mode is an intra prediction mode, determining that the attribute prediction and transform mode includes an attribute intra prediction and transform mode;
in a case where the target prediction mode is an inter prediction mode, determining that the attribute prediction and transform mode includes an attribute inter prediction and transform mode; and
in a case where the target prediction mode is an inter-intra prediction mode, determining that the attribute prediction and transform mode includes an attribute inter prediction and transform mode, an attribute intra prediction and transform mode, and an attribute inter-intra prediction and transform mode.

In a twenty-fourth clause, according to the twenty-second clause or the twenty-third clause, where determining the neighborhood attribute distribution information of the node of the current layer includes:
determining an attribute reconstructed value of a first reference node of the node of the current layer according to the target prediction mode; and
determining the neighborhood attribute distribution information of the node of the current layer according to the attribute reconstructed value of the first reference node.

In a twenty-fifth clause, according to the twenty-fourth clause, where
in a case where the target prediction mode is an intra prediction mode, the first reference node includes at least one of: a neighborhood node of a parent node, or a reconstructed neighborhood node at a same layer;
in a case where the target prediction mode is an inter prediction mode, the first reference node includes at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer; and
in a case where the target prediction mode is an inter-intra prediction mode, the first reference node includes at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer.

In a twenty-sixth clause, according to the twenty-fifth clause, where the neighborhood attribute distribution information includes a difference between the attribute reconstructed value of the first reference node and an attribute reconstructed value of the parent node, and a difference between the attribute reconstructed value of the first reference node and an attribute reconstructed value of the collocated parent node.

In a twenty-seventh clause, according to any one of the twenty-fourth clause to the twenty-sixth clause, where determining the target encoding mode of the node of the current layer from the candidate encoding modes according to the neighborhood attribute distribution information includes:
in response to the neighborhood attribute distribution information meeting a second prediction condition, determining that the target encoding mode is the attribute prediction and transform mode; and
in response to the neighborhood attribute distribution information not meeting the second prediction condition, determining that the target encoding mode is the attribute transform mode.

In a twenty-eighth clause, according to the twenty-seventh clause, where
in a case where the target prediction mode is an intra prediction mode, the second prediction condition includes a prediction condition corresponding to an attribute intra prediction and transform mode;
in a case where the target prediction mode is an inter prediction mode, the second prediction condition includes a prediction condition corresponding to an attribute inter prediction and transform mode; and
in a case where the target prediction mode is an inter-intra prediction mode, the second prediction condition includes a prediction condition corresponding to an attribute intra prediction and transform mode, a prediction condition corresponding to an attribute inter prediction and transform mode, and a prediction condition corresponding to an attribute inter-intra prediction and transform mode.

In a twenty-ninth clause, according to any one of the twenty-first clause to the twenty-third clause, where the neighborhood attribute distribution information includes an attribute original value of the node of the current layer; and
determining the target encoding mode of the node of the current layer from the candidate encoding modes according to the neighborhood attribute distribution information includes:
performing attribute encoding on the node of the current layer according to each candidate encoding mode, to determine the attribute reconstructed value of the node of the current layer;
performing a cost calculation according to the attribute reconstructed value of the node of the current layer and the attribute original value of the node of the current layer, to determine a respective cost value corresponding to each candidate encoding mode;
determining, according to the respective cost value corresponding to each candidate encoding mode, that a candidate encoding mode corresponding to a minimum cost value is the target encoding mode of the node of the current layer;
determining a third syntax element flag according to the target encoding mode, where the third syntax element flag is used to indicate the target encoding mode; and
encoding the third syntax element flag, and signalling obtained encoded bits into a bitstream.

In a thirtieth clause, according to the twenty-ninth clause, where the third syntax element flag is used to indicate a target encoding mode of the current layer; or the third syntax element flag is used to indicate a target encoding mode of a coefficient group of the current layer.

In a thirty-first clause, according to the twenty-ninth clause, where performing the cost calculation according to the attribute reconstructed value of the node of the current layer and the attribute original value of the node of the current layer, to determine the respective cost value corresponding to each candidate encoding mode includes:
performing the cost calculation according to attribute reconstructed values and attribute original values of all nodes in the current layer, or attribute reconstructed values and attribute original values of all nodes in a coefficient group of the current layer, to determine a respective cost value corresponding to the current layer under each candidate encoding mode or a respective cost value corresponding to the coefficient group of the current layer under each candidate coding mode.

In a thirty-second clause, according to any one of the twenty-first clause to the thirty-first clause, where the first syntax element flag, a second syntax element flag, and a third syntax element flag are set in an attribute brick header (ABH) information parameter set.

In a thirty-third clause, according to the thirty-second clause, where determining the neighborhood geometry distribution information of the node of the current layer includes:
determining the neighborhood geometry distribution information according to the target prediction mode.

In a thirty-fourth clause, according to the thirty-third clause, where determining the neighborhood geometry distribution information according to the target prediction mode includes:
in a case where the target prediction mode is an intra prediction mode, determining that the neighborhood geometry distribution information includes a number of neighborhood nodes of a parent node of the node of the current layer, and a number of neighborhood nodes of a grandparent node of the node of the current layer;
in a case where the target prediction mode is an inter prediction mode, determining that the neighborhood geometry distribution information includes occupancy information of a collocated parent node of the node of the current layer, and occupancy information of a parent node of the node of the current layer; and
in a case where the target prediction mode is an inter-intra prediction mode, determining that the neighborhood geometry distribution information includes occupancy information of a collocated parent node of the node of the current layer and occupancy information of a parent node of the node of the current layer, and a number of neighborhood nodes of the parent node of the node of the current layer and a number of neighborhood nodes of a grandparent node of the node of the current layer.

In a thirty-fifth clause, according to the thirty-third clause, where
in a case where the target prediction mode is an intra prediction mode, the first prediction condition includes that a number of neighborhood nodes of a parent node is greater than a first threshold, and a number of neighborhood nodes of a grandparent node is greater than a second threshold;
in a case where the target prediction mode is an inter prediction mode, the first prediction condition includes that a collocated parent node exists, and occupancy information of the collocated parent node is the same as occupancy information of a parent node; and
in a case where the target prediction mode is an inter-intra prediction mode, the first prediction condition includes that a number of neighborhood nodes of a parent node is greater than a first threshold, a number of neighborhood nodes of a grandparent node is greater than a second threshold, a collocated parent node exists, and occupancy information of the collocated parent node is the same as occupancy information of the parent node.

In a thirty-sixth clause, according to the twenty-first clause, where in a case where the target encoding mode is the attribute prediction and transform mode, performing the attribute encoding on the node of the current layer according to the target encoding mode, to determine the attribute reconstructed value of the node of the current layer includes:
determining an attribute prediction value of the node of the current layer;
performing an attribute transform according to the attribute prediction value of the node of the current layer, to obtain an alternating current (AC) coefficient prediction value of the node of the current layer;
determining an AC coefficient residual value of the node of the current layer;
determining an AC coefficient reconstructed value of the node of the current layer according to the AC coefficient prediction value and the AC coefficient residual value of the node of the current layer;
performing an inverse transform according to the AC coefficient reconstructed value and a direct current (DC) coefficient reconstructed value of a parent node of the node of the current layer, to determine the attribute reconstructed value of the node of the current layer; and
encoding the AC coefficient residual value, and signalling obtained encoded bits into the bitstream.

In a thirty-seventh clause, according to the thirty-sixth clause, where determining the attribute prediction value of the node of the current layer includes:
in a case where the attribute prediction and transform mode is an attribute intra prediction, determining a first intra prediction mode; and
determining a first attribute prediction value of the node of the current layer according to the first intra prediction mode;
or
in a case where the attribute prediction and transform mode is an attribute inter prediction, determining a first inter prediction mode; and
determining a second attribute prediction value of the node of the current layer according to the first inter prediction mode;
or
in a case where the attribute prediction and transform mode is an attribute inter-intra prediction, determining a first inter-intra prediction mode; and
determining a third attribute prediction value of the node of the current layer according to the first inter-intra prediction mode.

In a thirty-eighth clause, according to the thirty-seventh clause, where
the first intra prediction mode includes at least one of: an intra parent node prediction mode, an intra same-layer node prediction mode, or an intra parent node and same-layer node prediction mode;
the first inter prediction mode includes at least one of: an inter collocated parent node prediction mode, an inter collocated node prediction mode, or an inter collocated parent node and collocated node prediction mode; and
the first inter-intra prediction mode includes at least one of: an intra prediction mode, an inter prediction mode, or an inter-intra fusion prediction mode.

In a thirty-ninth clause, according to the twenty-first clause, where in a case where the target encoding mode is the attribute transform mode, performing the attribute encoding on the node of the current layer according to the target encoding mode, to determine the attribute reconstructed value of the node of the current layer includes:
determining an AC coefficient reconstructed value of the node of the current layer; and
performing an inverse transform according to the AC coefficient reconstructed value and a DC coefficient reconstructed value of a parent node of the node of the current layer, to determine the attribute reconstructed value of the node of the current layer.

In a fortieth clause, according to any one of the twenty-first clause to the thirty-ninth clause, the method further includes:
in response to the neighborhood geometry distribution information not meeting the first prediction condition, determining that the target encoding mode of the node of the current layer is the attribute transform mode; and
performing attribute encoding on the node of the current layer according to the attribute transform mode, to determine the attribute reconstructed value of the node of the current layer.

The various embodiments of the present disclosure are described with reference to the drawings.

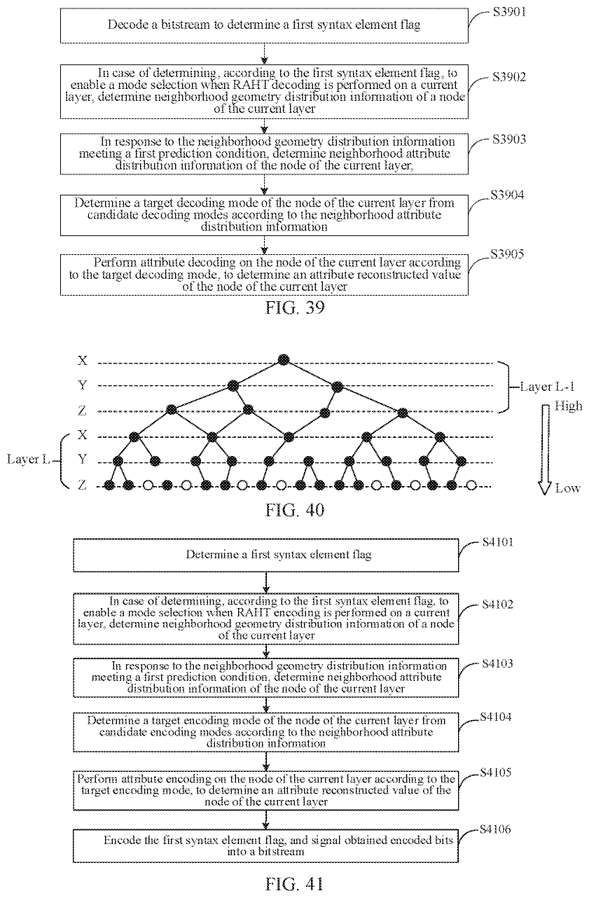

In an embodiment of the present disclosure, referring to FIG. 39, a schematic diagram of a flowchart of a decoding method provided in an embodiment of the present disclosure is illustrated. As illustrated in FIG. 39, the method may include the following operations.

In S3901, a bitstream is decoded to determine a first syntax element flag.

It should be noted that, when encoding the point cloud attribute information, it is indicated, through the first syntax element flag, whether to enable a mode selection function when RAHT decoding is performed on a current sequence, a current slice, or other decoding units. In some embodiments, the first syntax element flag is a high-level syntax element and is set in an attribute brick header (ABH) information parameter set. That is, the bitstream is decoded to determine the attribute brick header information parameter set; and the first syntax element flag is determined from the attribute brick header information parameter set.

Exemplarily, when the first syntax element flag is a first value, it is determined to enable the mode selection function when performing the RAHT decoding. That is, when performing the RAHT decoding, a target decoding mode is selected from candidate decoding modes. When the first syntax element flag is a second value, it is determined not to enable the mode selection function when performing the RAHT decoding, and attribute decoding is performed by using the existing RAHT decoding scheme.

In some embodiments, it is indicated, through the first syntax element flag, whether to enable the intra prediction mode selection function when RAHT decoding is performed on the current sequence, the current slice, or other decoding units. In still other embodiments, it is indicated, through the indication of the first syntax element flag, whether to enable the inter prediction mode selection function when RAHT decoding is performed on the current sequence, the current slice, or other decoding units. In still other embodiments, it is indicated, through the indication of the first syntax element flag, whether to enable an inter-intra prediction mode selection function when RAHT decoding is performed on the current sequence, the current slice, or other decoding units. Here, the inter-intra prediction mode may be understood as that any one of the following may be used when performing an attribute prediction: an intra prediction mode, an inter prediction mode, and an inter-intra fusion prediction mode.

The inter-intra fusion prediction mode may merge an inter prediction value and an intra prediction value of the RAHT decoding layer attribute, to obtain an optimal prediction value based on different weights, thereby further improving the RAHT encoding efficiency of point cloud attributes. Assuming that an RAHT intra prediction value of a current node is predIntraVal and an inter prediction value of the current node is predInterVal, the final prediction value predVal is: predVal=w1*predIntraVal+w2*predInter Val.

It should be noted that RAHT decoding refers to performing hierarchically partitioning on reconstructed geometry information of a current decoding unit based on an octree hierarchy and performing attribute decoding on each RAHT decoding layer. At present, the order of attribute RAHT decoding proceeds from the root node, progressively partitioning down to the voxel level (1×1×1), thereby completing the attribute encoding and attribute reconstruction of the entire point cloud. As illustrated in FIG. 40, we define each layer obtained by performing one downsampling operation along the Z, Y, and X directions as an RAHT decoding layer.

In S3902, in a case of determining, according to the first syntax element flag, to enable the mode selection when region adaptive hierarchical transform decoding is performed on a current layer, neighborhood geometry distribution information of a node of the current layer is determined.

It should be noted that the neighborhood geometry distribution information is used to represent geometry distribution characteristics of a reference node of the node of the current layer. Determining whether the neighborhood geometry distribution information meets a first prediction condition may refer to determining whether the neighborhood geometry distribution characteristics of the node of the current layer match preset neighborhood geometry distribution characteristics. If the first prediction condition is met, a target decoding mode is further determined according to the neighborhood attribute distribution information of the node of the current layer.

In some embodiments, the method may further include: decoding the bitstream to determine a second syntax element flag; determining the target prediction mode for the mode selection enabled at the current layer according to the second syntax element flag; and determining the neighborhood geometry distribution information according to the target prediction mode. The second syntax element flag may be used to indicate a target prediction mode for the mode selection enabled at any decoding unit to which the current layer belongs, and corresponding neighborhood geometry distribution information under different prediction modes may differ. In the embodiments of the present disclosure, the mode selection may also be enabled at the decoding unit under a specific prediction mode.

In some embodiments, the target prediction mode may include one of: an intra prediction mode, an inter prediction mode, and an inter-intra prediction mode. Exemplarily, determining the neighborhood geometry distribution information according to the target prediction mode includes: in a case where the target prediction mode is the intra prediction mode, determining that the neighborhood geometry distribution information includes a number of neighborhood nodes of a parent node of the node of the current layer and a number of neighborhood nodes of a grandparent node of the node of the current layer; in a case where the target prediction mode is the inter prediction mode, determining that the neighborhood geometry distribution information includes occupancy information of a collocated parent node of the node of the current layer and occupancy information of a parent node of the node of the current layer; and in a case where the target prediction mode is the inter-intra prediction mode, determining that the neighborhood geometry distribution information includes occupancy information of a collocated parent node of the node of the current layer and occupancy information of a parent node of the node of the current layer, and a number of neighborhood nodes of a parent node of the node of the current layer and a number of neighborhood nodes of a grandparent node of the node of the current layer.

Exemplarily, in the case where the target prediction mode is the intra prediction mode, the first prediction condition includes that the number of neighborhood nodes of the parent node is greater than a first threshold, and the number of neighborhood nodes of the grandparent node is greater than a second threshold. In the case where the target prediction mode is the inter prediction mode, the first prediction condition includes that a collocated parent node exists, and occupancy information of the collocated parent node is the same as occupancy information of the parent node. In the case where the target prediction mode is the inter-intra prediction mode, the first prediction condition includes that the number of neighborhood nodes of the parent node is greater than the first threshold, the number of neighborhood nodes of the grandparent node is greater than the second threshold, a collocated parent node exists, and occupancy information of the collocated parent node is the same as occupancy information of the parent node.

It should be noted that for the intra prediction mode, different thresholds may be set for different decoding layers based on a hierarchical depth.

In S3903, in response to the neighborhood geometry distribution information meeting the first prediction condition, the neighborhood attribute distribution information of the node of the current layer is determined.

It should be noted that the node of the current layer refers to any node in the current layer. In the embodiments of the present disclosure, for the node whose neighborhood geometry distribution information meets the first prediction condition, the mode selection is further performed according to the neighborhood attribute distribution information, to determine the optimal decoding mode.

The neighborhood attribute distribution information is used to represent the attribute distribution characteristics of the reference node of the node of the current layer. In some embodiments, the attribute distribution characteristics may be attribute variation characteristics or attribute difference characteristics of the reference node. When the attribute variation is small, it represents that attribute prediction may be performed on the node of the current layer; and when the attribute variation is large, it represents that attribute prediction cannot be performed on the node of the current layer.

In S3904, according to the neighborhood attribute distribution information, the target decoding mode of the node of the current layer is determined from candidate decoding modes; where the candidate decoding modes include: an attribute prediction and transform mode, and an attribute prediction mode.

In some embodiments, the bitstream is decoded to determine the neighborhood attribute distribution information of the node of the current layer. The neighborhood attribute distribution information may be determined and transmitted to the decoding side by the encoding side. Exemplarily, the encoding side makes a decision on the candidate decoding modes according to the neighborhood attribute distribution information of the node of the current layer, to determine a target encoding mode (which corresponds to the target decoding mode at the decoding side), and encodes an index of the target encoding mode. The decoding side decodes the mode index to determine a target decoding mode. It should be understood that since the target decoding mode is determined according to the neighborhood attribute distribution information of the node of the current layer, the index of the target decoding mode may also serve as information that represents the neighborhood attribute distribution characteristics.

The neighborhood attribute distribution information may include a third syntax element flag for indicating the target decoding mode. The third syntax element flag may be a syntax element flag corresponding to each node of the current layer, or a syntax element flag corresponding to a part or all of nodes of the current layer, or a syntax element flag corresponding to multiple RAHT decoding layers.

In some embodiments, the third syntax element flag is used to indicate a target decoding mode of the current layer. That is, all nodes in the current layer select the target decoding mode for decoding when performing the mode selection.

In other embodiments, the third syntax element flag is used to indicate a target decoding mode of a coefficient group of the current layer. That is, all nodes in the coefficient group select the target decoding mode for decoding when performing the mode selection. In this scheme, coefficient group-based partitioning is first performed on the nodes of the current layer to be encoded, to obtain different coefficient groups. Assuming that the number of nodes in each coefficient group is N, the encoding side selects an optimal encoding mode for each coefficient group, and for each coefficient group, the corresponding encoding mode also should be transmitted to the decoding side, so that reconstruction is performed on the attribute information using the decoding mode corresponding to each coefficient group at the decoding side.

It should be noted that a length of the third syntax element flag may be determined according to the number of candidate decoding modes. The third syntax element flag may be a high-level syntax element and set in the attribute brick header information parameter set. That is, the bitstream is decoded to determine the attribute brick header information parameter set, and the third syntax element flag is determined from the attribute brick header information parameter set.

In still other embodiments, determining the neighborhood attribute distribution information of the node of the current layer includes: obtaining an attribute reconstructed value of a first reference node of the node of the current layer; and determining the neighborhood attribute distribution information of the node of the current layer according to the attribute reconstructed value of the first reference node. That is, the neighborhood attribute distribution information may be determined by the decoding side according to the attribute reconstructed value of a reconstructed first reference node of the node of the current layer. The optimal decoding mode is implicitly derived according to the attribute reconstructed value of the reconstructed node, where the optimal decoding mode does not need to be determined through transmitting the mode index by the encoding side.

Determining the neighborhood attribute distribution information of the node of the current layer includes: determining the attribute reconstructed value of the first reference node of the node of the current layer according to the target prediction mode; and determining the neighborhood attribute distribution information of the node of the current layer according to the attribute reconstructed value of the first reference node.

The neighborhood attribute distribution information is related to the target prediction mode. Exemplarily, in the case where the target prediction mode is the intra prediction mode, the first reference node includes at least one of: a neighborhood node of a parent node; or a reconstructed neighborhood node at a same layer. In the case where the target prediction mode is the inter prediction mode, the first reference node includes at least one of: a collocated parent node in a reference picture and a parent node; a neighborhood node of a collocated parent node in a reference picture and a neighborhood node of a parent node; or a reconstructed collocated neighborhood node at a same layer in a reference picture and a reconstructed neighborhood node at a same layer. In the case where the target prediction mode is the inter-intra prediction mode, the first reference node include at least one of: a collocated parent node in a reference picture and a parent node; a neighborhood node of a collocated parent node in a reference picture and a neighborhood node of the parent node; or a reconstructed collocated neighborhood node at a same layer in a reference picture and a reconstructed neighborhood node at a same layer.

Exemplarily, for the intra prediction mode, the neighborhood attribute distribution information includes a difference between the attribute reconstructed value of the first reference node and an attribute reconstructed value of the parent node. For the inter prediction mode, the neighborhood attribute distribution information includes a difference between the attribute reconstructed value of the first reference node and an attribute reconstructed value of the collocated parent node. For the inter-intra prediction mode, the neighborhood attribute distribution information includes the difference between the attribute reconstructed value of the first reference node and the attribute reconstructed value of the collocated parent node, and the difference between the attribute reconstructed value of the first reference node and the attribute reconstructed value of the parent node.

The calculation function used for computing the difference may include: sum of absolute differences (SAD), sum of absolute transformed differences (SATD), mean squared error (MSE), sum of squared differences (SSD), mean absolute deviation (MAD), mean squared deviation (MSD), the absolute values of transform coefficients, such as the absolute values of discrete cosine transform (DCT) coefficients, and Hadamard transform, which are not limited here. For example, in a case where the SAD between the attribute reconstructed value of the parent node of the current node and the attribute reconstructed value of the neighborhood node of the parent node of the current node falls within a certain range, it is considered that the neighborhood attribute distribution characteristic of the current node is relatively smooth. Based on such a distribution characteristic, it may be implicitly inferred that the current node uses a predictive encoding mode; otherwise, it is considered that the attribute distribution of the neighborhood range of the current node is relatively fluctuating, and an attribute transform mode will be used.

In still other embodiments, in response to the neighborhood geometry distribution information meeting the first prediction condition, a manner may first be determined from an explicit indexing manner and an implicit derivation manner, and then the optimal decoding mode is further determined.

It should also be noted that in the embodiments of the present disclosure, in response to the neighborhood geometry distribution information not meeting the first prediction condition, it is determined that the target decoding mode of the node of the current layer is a preset decoding mode. The preset decoding mode may be one of the candidate decoding modes provided in the embodiments of the present disclosure, or may be other decoding modes. Exemplarily, the preset decoding mode is the attribute transform mode.

In some embodiments, the method further includes: decoding the bitstream to determine the second syntax element flag; determining the target prediction mode for the mode selection enabled at the current layer according to the second syntax element flag; and determining the candidate decoding modes according to the target prediction mode. The corresponding candidate decoding modes under different prediction modes may differ.

In some embodiments, determining the candidate decoding modes according to the target prediction mode includes: in a case where the target prediction mode is the intra prediction mode, determining that the attribute prediction and transform mode includes an attribute intra prediction and transform mode; in a case where the target prediction mode is the inter prediction mode, determining that the attribute prediction and transform mode includes an attribute inter prediction and transform mode; and in a case where the target prediction mode is the inter-intra prediction mode, determining that the attribute prediction and transform mode includes an attribute inter prediction and transform mode, an attribute intra prediction and transform mode, and an attribute inter-intra prediction and transform mode. In other embodiments, in the case where the target prediction mode is the inter-intra prediction mode, it is determined that the attribute prediction and transform mode includes the attribute inter prediction and transform mode, and the attribute intra prediction and transform mode. In still other embodiments, in the case where the target prediction mode is the inter-intra prediction mode, it is determined that the attribute prediction and transform mode includes the attribute inter prediction and transform mode, and the attribute inter-intra prediction and transform mode.

In some embodiments, the target decoding mode of the node of the current layer is determined from the candidate decoding modes according to the third syntax element flag.

In other embodiments, in response to the neighborhood attribute distribution information meeting a second prediction condition, it is determined that the target decoding mode is the attribute prediction and transform mode; and in response to the neighborhood attribute distribution information not meeting the second prediction condition, it is determined that the target decoding mode is the attribute transform mode. The second prediction condition serves as a second determination condition of whether to perform attribute prediction. The second prediction condition is used to determine whether the neighborhood attribute distribution characteristics of the node of the current layer conform to the preset neighborhood attribute distribution characteristics for performing attribute prediction. When both the neighborhood geometry distribution characteristics and the neighborhood attribute distribution characteristics meet the prediction condition, the target decoding mode is determined.

It should be noted that when there are two or more attribute prediction and transform modes, a corresponding number of second prediction conditions may also be set. Exemplarily, in the case where the target prediction mode is the intra prediction mode, the second prediction condition includes a prediction condition corresponding to the attribute intra prediction and transform mode. In the case where the target prediction mode is the inter prediction mode, the second prediction condition includes a prediction condition corresponding to the attribute inter prediction and transform mode. In the case where the target prediction mode is the inter-intra prediction mode, the second prediction condition includes a prediction condition corresponding to the attribute intra prediction and transform mode, a prediction condition corresponding to the attribute inter prediction and transform mode, and a prediction condition corresponding to the attribute inter-intra prediction and transform mode.

For the intra prediction mode, the second prediction condition may include that the difference between the attribute reconstructed value of the neighborhood node of the parent node and the attribute reconstructed value of the parent node is less than a first difference threshold. For the inter prediction mode, the second prediction condition may include that the difference between the attribute reconstructed value of the neighborhood node of the collocated parent node and the attribute reconstructed value of the collocated parent node is less than a second difference threshold. For the inter-intra fusion prediction mode, the second prediction condition may include that the difference between the attribute reconstructed value of the neighborhood node of the parent node and the attribute reconstructed value of the parent node is less than the first difference threshold, and the difference between the attribute reconstructed value of the neighborhood node of the collocated parent node and the attribute reconstructed value of the collocated parent node is less than the second difference threshold.

In S3905, attribute decoding is performed on the node of the current layer according to the target decoding mode, to determine the attribute reconstructed value of the node of the current layer.

In some embodiments, in the case where the target decoding mode is the attribute prediction and transform mode, the decoding process may include: determining the attribute prediction value of the node of the current layer; performing an attribute transform according to the attribute prediction value of the node of the current layer, to obtain an AC coefficient prediction value of the node of the current layer; decoding the bitstream to determine an AC coefficient residual value of the node of the current layer; determining an AC coefficient reconstructed value of the node of the current layer according to the AC coefficient prediction value of the node of the current layer and the AC coefficient residual value of the node of the current layer; and performing an inverse transform based on the AC coefficient reconstructed value of the node of the current layer and a DC coefficient reconstructed value of a parent node of the node of the current layer, to determine the attribute reconstructed value of the node of the current layer.

Exemplarily, determining the attribute prediction value of the node of the current layer includes: in a case of the attribute prediction and transform mode being the attribute intra prediction, determining a first intra prediction mode; and determining a first attribute prediction value of the node of the current layer according to the first intra prediction mode; alternatively, in a case of the attribute prediction and transform mode being the attribute inter prediction, determining a first inter prediction mode, and determining a second attribute prediction value of the node of the current layer according to the first inter prediction mode; alternatively, in a case of the attribute prediction and transform mode being the attribute inter-intra prediction, determining a first inter-intra prediction mode, and determining a third attribute prediction value of the node of the current layer according to the first inter-intra prediction mode. In other words, under different prediction modes, different attribute prediction modes may be used to determine the attribute prediction value of the current node.

Exemplarily, the first intra prediction mode includes at least one of: an intra parent node prediction mode, an intra same-layer node prediction mode, or an intra parent node and same-layer node prediction mode. The first inter prediction mode includes at least one of: an inter collocated parent node prediction mode, an inter collocated node prediction mode, or an inter collocated parent node and collocated node prediction mode. The first inter-intra prediction mode includes at least one of: an intra prediction mode, an inter prediction mode, or an inter-intra fusion prediction mode.

Exemplarily, in a case where the inter prediction node of the current node is valid, that is, a collocated node exists, the attribute of the prediction node is directly used as the attribute prediction value of the current node to be encoded.

In a case where the current node can find, in the buffer of reference picture, a node at the exact same position as the current node, that is, the collocated node exists, AC coefficients of M child nodes contained in the collocated node are directly used as AC coefficient attribute prediction values of N child nodes of the current node.
1. If the AC coefficient of the prediction node is non-zero, the AC coefficient of the prediction node is directly used as the prediction value.
2. If the AC coefficient of the prediction node is zero, an AC coefficient of a child node corresponding to the intra prediction is used as the prediction value.

In a case where the inter prediction node of the current node is invalid, that is, the collocated node does not exist, an attribute prediction value of an intra neighborhood node is used as the attribute prediction value of the node to be encoded.

In another embodiment of the present disclosure, referring to FIG. 41, a schematic diagram of a flowchart of an encoding method provided in an embodiment of the present disclosure is illustrated. As illustrated in FIG. 41, the method may include the following operations.

In S4101, a first syntax element flag is determined.

It should be noted that, when encoding the point cloud attribute information, it is indicated, through the first syntax element flag, whether to enable a mode selection function when RAHT encoding is performed on a current sequence, a current slice, or other encoding units. In some embodiments, the first syntax element flag is a high-level syntax element and is set in an attribute brick header (ABH) information parameter set. That is, the first syntax element flag is encoded in the attribute brick header information parameter set.

Exemplarily, when the first syntax element flag is a first value, it is determined to enable the mode selection function when performing the RAHT encoding. That is, when performing the RAHT encoding, a target encoding mode is selected from candidate encoding modes. When the first syntax element flag is a second value, it is determined not to enable the mode selection function when performing the RAHT encoding, and attribute encoding is performed by using the existing RAHT encoding scheme.

In some embodiments, it is indicated, through the first syntax element flag, whether to enable the intra prediction mode selection function when RAHT encoding is performed on the current sequence, the current slice, or other encoding units. In still other embodiments, it is indicated, through the indication of the first syntax element flag, whether to enable the inter prediction mode selection function when RAHT encoding is performed on the current sequence, the current slice, or other encoding units. In still other embodiments, it is indicated, through the indication of the first syntax element flag, whether to enable an inter-intra prediction mode selection function when RAHT encoding is performed on the current sequence, the current slice, or other encoding units. Here, the inter-intra prediction mode may be understood as that any one of the following may be used when performing an attribute prediction: an intra prediction mode, an inter prediction mode, and an inter-intra fusion prediction mode.

It should be noted that RAHT encoding refers to performing hierarchical partitioning on reconstructed geometry information of a current encoding mode based on an octree hierarchy and performing attribute encoding on each RAHT encoding layer. At present, the order of attribute RAHT encoding proceeds from the root node, progressively partitioning down to the voxel level (1×1×1), thereby completing the attribute encoding and attribute reconstruction of the entire point cloud. As illustrated in FIG. 40, we define each layer obtained by performing one downsampling operation along the Z, Y, and X directions as an RAHT encoding layer.

In S4102, in a case of determining, according to the first syntax element flag, to enable the mode selection when region adaptive hierarchical transform encoding is performed on a current layer, neighborhood geometry distribution information of a node of the current layer is determined.

It should be noted that the neighborhood geometry distribution information is used to represent geometry distribution characteristics of a reference node of the node of the current layer. Determining whether the neighborhood geometry distribution information meets a first prediction condition may refer to determining whether the neighborhood geometry distribution characteristics of the node of the current layer match preset neighborhood geometry distribution characteristics. If the first prediction condition is met, a target encoding mode is further determined according to the neighborhood attribute distribution information of the node of the current layer.

In some embodiments, the method may further include: determining, according to a second syntax element flag, a target prediction mode for the mode selection enabled at the current layer; and determining the candidate encoding modes according to the target prediction mode; and encoding the second syntax element flag, and signalling encoded bits into a bitstream. The second syntax element flag may be used to indicate a target prediction mode for the mode selection enabled at any encoding unit to which the current layer belongs, and corresponding neighborhood geometry distribution information under different prediction modes may differ. In the embodiments of the present disclosure, the mode selection may also be enabled at an encoding unit under a specific prediction mode.

In some embodiments, the target prediction mode may include one of: an intra prediction mode, an inter prediction mode, and an inter-intra prediction mode. Exemplarily, determining the neighborhood geometry distribution information according to the target prediction mode includes: in a case where the target prediction mode is the intra prediction mode, determining that the neighborhood geometry distribution information includes a number of neighborhood nodes of a parent node of the node of the current layer and a number of neighborhood nodes of a grandparent node of the node of the current layer; in a case where the target prediction mode is the inter prediction mode, determining that the neighborhood geometry distribution information includes occupancy information of a collocated parent node of the node of the current layer and occupancy information of a parent node of the node of the current layer; and in a case where the target prediction mode is the inter-intra prediction mode, determining that the neighborhood geometry distribution information includes occupancy information of a collocated parent node of the node of the current layer and occupancy information of a parent node of the node of the current layer, and a number of neighborhood nodes of a parent node of the node of the current layer and a number of neighborhood nodes of a grandparent node of the node of the current layer.

Exemplarily, in the case where the target prediction mode is the intra prediction mode, the first prediction condition includes that the number of neighborhood nodes of the parent node is greater than a first threshold, and the number of neighborhood nodes of the grandparent node is greater than a second threshold. In the case where the target prediction mode is the inter prediction mode, the first prediction condition includes that a collocated parent node exists, and occupancy information of the collocated parent node is the same as occupancy information of the parent node. In the case where the target prediction mode is the inter-intra prediction mode, the first prediction condition includes that the number of neighborhood nodes of the parent node is greater than the first threshold, the number of neighborhood nodes of the grandparent node is greater than the second threshold, a collocated parent node exists, and occupancy information of the collocated parent node is the same as occupancy information of the parent node.

It should be noted that for the intra prediction mode, different thresholds may be set for different decoding layers based on a hierarchical depth.

In S4103, in response to the neighborhood geometry distribution information meeting the first prediction condition, the neighborhood attribute distribution information of the node of the current layer is determined.

It should be noted that the node of the current layer refers to any node in the current layer. In the embodiments of the present disclosure, for the node whose neighborhood geometry distribution information meets the first prediction condition, the mode selection is further performed according to the neighborhood attribute distribution information, to determine the optimal encoding mode.

The neighborhood attribute distribution information is used to represent the attribute distribution characteristics of the reference node of the node of the current layer. In some embodiments, the attribute distribution characteristics may be attribute variation characteristics or attribute difference characteristics of the reference node. When the attribute variation is small, it represents that attribute prediction may be performed on the node of the current layer; and when the attribute variation is large, it represents that attribute prediction cannot be performed on the node of the current layer.

In S4104, according to the neighborhood attribute distribution information, the target encoding mode of the node of the current layer is determined from candidate encoding modes; where the candidate encoding modes include: an attribute prediction and transform mode, and an attribute prediction mode.

Exemplarily, in some embodiments, the method further includes: encoding the neighborhood attribute distribution information of the node of the current layer. The neighborhood attribute distribution information may be determined and transmitted to the decoding side by the encoding side. Exemplarily, the encoding side makes a decision on the candidate encoding modes according to the neighborhood attribute distribution information of the node of the current layer, to determine a target encoding mode, and encodes an index of the target encoding mode. The decoding side decodes the mode index to determine a target decoding mode. It should be understood that since the target decoding mode is determined according to the neighborhood attribute distribution information of the node of the current layer, the index of the target decoding mode may also serve as information that represents the neighborhood attribute distribution characteristics.

In some embodiments, the neighborhood attribute distribution information includes an attribute original value of the node of the current layer. Determining the target encoding mode of the node of the current layer from the candidate encoding modes according to the neighborhood attribute distribution information includes: performing attribute encoding on the node of the current layer according to each candidate encoding mode, to determine the attribute reconstructed value of the node of the current layer; performing a cost calculation according to the attribute reconstructed value of the node of the current layer and the attribute original value of the node of the current layer, to determine a respective cost value corresponding to each candidate encoding mode; determining, according to the respective cost value corresponding to each candidate encoding mode, that a candidate encoding mode corresponding to a minimum cost value is the target encoding mode of the node of the current layer; determining a third syntax element flag according to the target encoding mode, where the third syntax element flag is used to indicate the target encoding mode; and encoding the third syntax element flag, and signalling obtained encoded bits into a bitstream.

In some embodiments, the cost function used may be a rate-distortion optimization (RDO) cost. By using the RDO algorithm to select the optimal encoding mode for predictive encoding, the encoding efficiency of point cloud attributes can be improved.

Exemplarily, performing the cost calculation according to the attribute reconstructed value of the node of the current layer and the attribute original value of the node of the current layer, to determine the respective cost value corresponding to each candidate encoding mode includes: performing the cost calculation according to attribute reconstructed values and attribute original values of all nodes in the current layer, or attribute reconstructed values and attribute original values of all nodes in a coefficient group of the current layer, to determine a respective cost value corresponding to the current layer under each candidate encoding mode or a respective cost value corresponding to the coefficient group of the current layer under each candidate encoding mode.

At the encoding side, predictive encoding is performed on the attribute information of the node of the current layer by using two prediction modes based on the rate-distortion optimization algorithm. Finally, the optimal encoding mode of the current layer is obtained by using the rate-distortion optimization algorithm, and the optimal encoding mode is then transmitted to the decoding side. The decoding side performs a reconstruction restoration on the attribute information of the node of the current layer to be decoded by using the decoding mode obtained through parsing. In the rate-distortion optimization algorithm, the distortion D between a reconstructed attribute of each prediction mode and an original attribute of each prediction mode is first calculated. Next, an encoded bitstream R required for each decoding mode is obtained. The rate-distortion cost is calculated as follows:

$$J = D + λ xR ; \qquad ( 37 )$$

where λ may be calculated through the attribute quantization parameter. The current manner for calculating λ is as follows:

$$λ = {2}^{\frac{Q P - 4}{6}} \times N ; \qquad ( 38 )$$

where the parameter N is currently set to different values according to reflectance and color.

The encoding mode of each layer is finally added to an attribute brick header (ABH) parameter set.

In other embodiments, the cost function used may also be the sum of absolute differences (SAD), sum of absolute transformed differences (SATD), mean squared error (MSE), sum of squared differences (SSD), mean absolute deviation (MAD), mean squared deviation (MSD), the absolute values of transform coefficients, such as the absolute values of discrete cosine transform (DCT) coefficients, or the Hadamard transform, which is not specifically limited here.

The neighborhood attribute distribution information may include a third syntax element flag for indicating the target encoding mode. The third syntax element flag may be a syntax element flag corresponding to each node of the current layer, or a syntax element flag corresponding to a part or all of nodes of the current layer, or a syntax element flag corresponding to multiple RAHT encoding layers.

In some embodiments, the third syntax element flag is used to indicate a target encoding mode of the current layer. That is, all nodes in the current layer select the target encoding mode for encoding when performing the mode selection.

In other embodiments, the third syntax element flag is used to indicate a target encoding mode of a coefficient group of the current layer. That is, all nodes in the coefficient group select the target encoding mode for encoding when performing the mode selection. In this scheme, coefficient group-based partitioning is first performed on the nodes of the current layer to be encoded, to obtain different coefficient groups. Assuming that the number of nodes in each coefficient group is N, the encoding side selects an optimal encoding mode for each coefficient group, and for each coefficient group, the corresponding encoding mode also should be transmitted to the decoding side, so that reconstruction is performed on the attribute information by using the encoding mode corresponding to each coefficient group at the decoding side.

It should be noted that a length of the third syntax element flag may be determined according to the number of candidate encoding modes. The third syntax element flag may be a high-level syntax element and set in the attribute brick header information parameter set.

In still other embodiments, determining the neighborhood attribute distribution information of the node of the current layer includes: obtaining an attribute reconstructed value of a first reference node of the node of the current layer; and determining the neighborhood attribute distribution information of the node of the current layer according to the attribute reconstructed value of the first reference node. That is, the neighborhood attribute distribution information may be determined by the decoding side according to the attribute reconstructed value of a reconstructed first reference node of the node of the current layer. The optimal encoding mode is implicitly derived according to the attribute reconstructed value of the reconstructed node, where the optimal decoding mode does not need to be determined through transmitting the mode index by the encoding side.

Determining the neighborhood attribute distribution information of the node of the current layer includes: determining the attribute reconstructed value of the first reference node of the node of the current layer according to the target prediction mode; and determining the neighborhood attribute distribution information of the node of the current layer according to the attribute reconstructed value of the first reference node.

The neighborhood attribute distribution information is related to the target prediction mode. Exemplarily, in the case where the target prediction mode is the intra prediction mode, the first reference node includes at least one of: a neighborhood node of a parent node; or a reconstructed neighborhood node at a same layer. In the case where the target prediction mode is the inter prediction mode, the first reference node includes at least one of: a collocated parent node in a reference picture and a parent node; a neighborhood node of a collocated parent node in a reference picture and a neighborhood node of a parent node; or a reconstructed collocated neighborhood node at a same layer in a reference picture and a reconstructed neighborhood node at a same layer. In the case where the target prediction mode is the inter-intra prediction mode, the first reference node include at least one of: a collocated parent node in a reference picture and a parent node; a neighborhood node of a collocated parent node in a reference picture and a neighborhood node of the parent node; or a reconstructed collocated neighborhood node at a same layer in a reference picture and a reconstructed neighborhood node at a same layer.

Exemplarily, for the intra prediction mode, the neighborhood attribute distribution information includes a difference between the attribute reconstructed value of the first reference node and a attribute reconstructed value of the parent node. For the inter prediction mode, the neighborhood attribute distribution information includes a difference between the attribute reconstructed value of the first reference node and a attribute reconstructed value of the collocated parent node. For the inter-intra prediction mode, the neighborhood attribute distribution information includes the difference between the attribute reconstructed value of the first reference node and the attribute reconstructed value of the collocated parent node, and the difference between the attribute reconstructed value of the first reference node and the attribute reconstructed value of the parent node.

The calculation function used for computing the difference may include: sum of absolute differences (SAD), sum of absolute transformed differences (SATD), mean squared error (MSE), sum of squared differences (SSD), mean absolute deviation (MAD), mean squared deviation (MSD), the absolute values of transform coefficients, such as the absolute values of discrete cosine transform (DCT) coefficients, and Hadamard transform, which are not specifically limited here.

In still other embodiments, in response to the neighborhood geometry distribution information meeting the first prediction condition, a manner may first be determined from an explicit indexing manner and an implicit derivation manner, and then the optimal encoding mode is further determined.

It should also be noted that in the embodiments of the present disclosure, in response to the neighborhood geometry distribution information not meeting the first prediction condition, it is determined that the target encoding mode of the node of the current layer is a preset encoding mode. The preset encoding mode may be one of the candidate encoding modes provided in the embodiments of the present disclosure, or may be other encoding modes. Exemplarily, the preset encoding mode is the attribute transform mode.

In some embodiments, the method further includes: determining the candidate encoding modes according to the target prediction mode. The corresponding candidate encoding modes under different prediction modes may differ.

In some embodiments, determining the candidate encoding modes according to the target prediction mode includes: in a case where the target prediction mode is the intra prediction mode, determining that the attribute prediction and transform mode includes an attribute intra prediction and transform mode; in a case where the target prediction mode is the inter prediction mode, determining that the attribute prediction and transform mode includes an attribute inter prediction and transform mode; and in a case where the target prediction mode is the inter-intra prediction mode, determining that the attribute prediction and transform mode includes an attribute inter prediction and transform mode, an attribute intra prediction and transform mode, and an attribute inter-intra prediction and transform mode.

In some embodiments, the target encoding mode of the node of the current layer is determined from the candidate encoding modes according to the third syntax element flag.

In other embodiments, in response to the neighborhood attribute distribution information meeting a second prediction condition, it is determined that the target encoding mode is the attribute prediction and transform mode; and in response to the neighborhood attribute distribution information not meeting the second prediction condition, it is determined that the target encoding mode is the attribute transform mode. The second prediction condition serves as a second determination condition of whether to perform attribute prediction. The second prediction condition is used to determine whether the neighborhood attribute distribution characteristics of the node of the current layer conform to the preset neighborhood attribute distribution characteristics for performing attribute prediction. When both the neighborhood geometry distribution characteristics and the neighborhood attribute distribution characteristics meet the prediction condition, the target encoding mode is determined.

It should be noted that when there are two or more attribute prediction and transform modes, a corresponding number of second prediction conditions may also be set. Exemplarily, in the case where the target prediction mode is the intra prediction mode, the second prediction condition includes a prediction condition corresponding to the attribute intra prediction and transform mode. In the case where the target prediction mode is the inter prediction mode, the second prediction condition includes a prediction condition corresponding to the attribute inter prediction and transform mode. In the case where the target prediction mode is the inter-intra prediction mode, the second prediction condition includes a prediction condition corresponding to the attribute intra prediction and transform mode, a prediction condition corresponding to the attribute inter prediction and transform mode, and a prediction condition corresponding to the attribute inter-intra prediction and transform mode.

For the intra prediction mode, the second prediction condition may include that the difference between the attribute reconstructed value of the neighborhood node of the parent node and the attribute reconstructed value of the parent node is less than a first difference threshold. For the inter prediction mode, the second prediction condition may include that the difference between the attribute reconstructed value of the neighborhood node of the collocated parent node and the attribute reconstructed value of the collocated parent node is less than a second difference threshold. For the inter-intra fusion prediction mode, the second prediction condition may include that the difference between the attribute reconstructed value of the neighborhood node of the parent node and the attribute reconstructed value of the parent node is less than the first difference threshold, and the difference between the attribute reconstructed value of the neighborhood node of the collocated parent node and the attribute reconstructed value of the collocated parent node is less than the second difference threshold.

In S4105, attribute encoding is performed on the node of the current layer according to the target encoding mode, to determine the attribute reconstructed value of the node of the current layer.

In S4106, the first syntax element flag is encoded, and obtained encoded bits are signaled into the bitstream.

In some embodiments, in the case where the target encoding mode is the attribute prediction and transform mode, the encoding process may include: determining the attribute prediction value of the node of the current layer; performing an attribute transform according to the attribute prediction value of the node of the current layer, to obtain an AC coefficient prediction value of the node of the current layer; determining an AC coefficient residual value of the node of the current layer; determining an AC coefficient reconstructed value of the node of the current layer according to the AC coefficient prediction value of the node of the current layer and the AC coefficient residual value of the node of the current layer; performing an inverse transform according to the AC coefficient reconstructed value of the node of the current layer and a DC coefficient reconstructed value of a parent node of the node of the current layer, to determine the attribute reconstructed value of the node of the current layer; and encoding the AC coefficient residual value, and signalling the obtained encoded bits into the bitstream.

Exemplarily, determining the attribute prediction value of the node of the current layer includes: in a case of the attribute prediction and transform mode being the attribute intra prediction, determining a first intra prediction mode; and determining a first attribute prediction value of the node of the current layer according to the first intra prediction mode; alternatively, in a case of the attribute prediction and transform mode being the attribute inter prediction, determining a first inter prediction mode, and determining a second attribute prediction value of the node of the current layer according to the first inter prediction mode; alternatively, in a case of the attribute prediction and transform mode being the attribute inter-intra prediction, determining a first inter-intra prediction mode, and determining a third attribute prediction value of the node of the current layer according to the first inter-intra prediction mode. In other words, under different prediction modes, different attribute prediction modes may be used to determine the attribute prediction value of the current node.

Exemplarily, the first intra prediction mode includes at least one of: an intra parent node prediction mode, an intra same-layer node prediction mode, or an intra parent node and same-layer node prediction mode. The first inter prediction mode includes at least one of: an inter collocated parent node prediction mode, an inter collocated node prediction mode, or an inter collocated parent node and collocated node prediction mode. The first inter-intra prediction mode includes at least one of: an intra prediction mode, an inter prediction mode, or an inter-intra fusion prediction mode.

Exemplarily, in a case where the inter prediction node of the current node is valid, that is, a collocated node exists, the attribute of the prediction node is directly used as the attribute prediction value of the current node to be encoded.

In a case where the current node can find, in the buffer of reference picture, a node at the exact same position as the current node, that is, the collocated node exists, AC coefficients of M child nodes contained in the collocated node are directly used as AC coefficient attribute prediction values of N child nodes of the current node.

1. If the AC coefficient of the prediction node is non-zero, the AC coefficient of the prediction node is directly used as the prediction value.

2. If the AC coefficient of the prediction node is zero, an AC coefficient of a child node corresponding to the intra prediction is used as the prediction value.

In a case where the inter prediction node of the current node is invalid, that is, the collocated node does not exist, an attribute prediction value of an intra neighborhood node is used as the attribute prediction value of the node to be encoded.

In summary, in the embodiments of the present disclosure, the G-PCC attribute RAHT intra encoding is improved. Through introducing one or more new intra encoding and decoding modes, first, the attribute intra predictive encoding scheme and the attribute transform encoding scheme, i.e., attribute prediction (intra parent node prediction and intra same-layer node prediction) encoding scheme and the attribute transform encoding scheme, are combined. In addition, before encoding the AC coefficients of different RAHT encoding layers, the rate-distortion optimization algorithm is used at the encoding side to obtain the optimal encoding mode of the current RAHT encoding layer, i.e., predictive encoding, and transform encoding. Finally, the optimal encoding mode of the current RAHT encoding layer is transmitted to the decoding side. The decoding side then adaptively restores the AC coefficient of the current layer by using the encoding mode of the current RAHT layer, thereby completing the entire attribute RAHT encoding process and ultimately improving the RAHT attribute encoding efficiency.

The algorithm at the encoding side is as follows.

In operation 1, it is adaptively determined, according to the number of neighborhood nodes of the current layer and the number of neighborhood nodes of the parent node of the current layer, whether the node of the current layer is capable of using the attribute intra prediction.

In operation 2, in a case where the node of the current layer is capable of using the attribute intra prediction, then for the current layer, the rate-distortion optimization algorithm is introduced to calculate a respective cost of each encoding mode by encoding each node of the current layer, to obtain the optimal encoding mode; or the optimal encoding mode is derived and determined according to the attribute distribution information of a reconstructed reference node.

In operation 3, predictive encoding is finally performed on the attribute of the node of the current layer by using the optimal coding mode, to obtain the attribute reconstructed value. It should be noted that if the rate-distortion optimization algorithm is introduced for mode selection in operation 2, and the reconstructed value of the optimal encoding mode is cached, the cached attribute reconstructed value may be directly obtained here.

In operation 4, indication information of the optimal encoding mode is signaled into the bitstream. It should be noted that this operation may be omitted if the implicit derivation manner is used by the operation 2.

The algorithm at the decoding side is as follows.

In operation 1, it is adaptively determined, according to the number of neighborhood nodes of the current layer and the number of neighborhood nodes of the parent node of the current layer, whether the node of the current layer is capable of using the attribute intra prediction.

In operation 2, in a case where the node of the current layer is capable of using the attribute intra prediction, the bitstream is decoded to obtain the optimal decoding mode of the current layer.

In operation 3, the attribute of the node of the current layer is decoded by using the optimal decoding mode.

In the embodiments of the present disclosure, when performing the RAHT intra encoding on the attribute, an encoding mode is introduced for each RAHT encoding layer to adaptively select either the attribute prediction and transform mode, or the attribute transform mode, and the encoding mode is finally transmitted to the decoding side which then reconstructs the point cloud attributes by using the encoding mode. In the present solution, the key is to introduce an encoding mode for each RAHT encoding layer, use the rate-distortion optimization selection algorithm at the encoding side to obtain the optimal encoding mode, and then reconstruct the point cloud attributes by using the decoding mode at the decoding side. The encoding mode of each layer is currently stored in the ABH, and the decoding mode of the RAHT encoding layer is obtained from the ABH at the decoding side, where the manner for encoding the parameter is not limited here. In addition, the predictive encoding manner for each node is not limited (e.g., intra parent node prediction encoding or intra same-layer node intra prediction encoding); instead, the intra encoding mode of the attribute of the current node is determined by considering the distribution characteristics of the AC coefficients obtained after transformation.

In the embodiments of the present disclosure, the G-PCC attribute RAHT inter encoding is improved. Through introducing one or more new inter encoding and decoding modes, first, three attribute predictive encoding schemes as follows are combined: an inter prediction scheme, an inter prediction plus intra prediction scheme, and a transform encoding scheme; in addition, before encoding the AC coefficients of different RAHT encoding layers, the rate-distortion optimization algorithm is used at the encoding side to obtain the optimal encoding mode of the current RAHT encoding layer, i.e., ‘the second scheme of inter prediction encoding’ plus transform encoding, intra prediction encoding plus transform encoding, or only the use of transform encoding; finally, the optimal encoding mode of the current RAHT encoding layer is transmitted to the decoding side. The decoding side then uses the encoding mode of the current RAHT layer to adaptively restore the AC coefficient of the current layer, thereby completing the entire attribute RAHT encoding process and ultimately improving the RAHT attribute encoding efficiency.

The algorithm at the encoding side is as follows.

In operation 1, it is adaptively determined, according to the number of neighborhood nodes of the current layer and the number of neighborhood nodes of the parent node of the current layer, whether the node of the current layer is capable of using the attribute inter prediction.

In operation 2, in a case where the node of the current layer is capable of using the attribute prediction and may perform the attribute inter prediction, then for the current layer, the rate-distortion optimization algorithm is introduced to calculate a respective cost of each prediction encoding mode by encoding each node of the current layer, to obtain the optimal encoding mode.

In operation 3, the optimal encoding mode is finally used to encode the attribute of the node of the current layer.

In operation 4, the indication information of the optimal encoding mode is signaled into the bitstream.

The algorithm at the decoding side is as follows.

In operation 1, it is adaptively determined, according to the number of neighborhood nodes of the current layer and the number of neighborhood nodes of the parent node of the current layer, whether the node of the current layer is capable of using the attribute inter prediction.

In operation 2, in a case where the node of the current layer is capable of using the attribute prediction and may perform the attribute inter prediction, the node obtains the optimal predictive decoding mode of the current layer.

In operation 3, the optimal predictive decoding mode is finally used to perform predictive decoding on the attribute of the node of the current layer.

In the embodiments of the present disclosure, when performing the RAHT inter encoding on the attribute, an encoding mode is introduced for each RAHT encoding layer to adaptively select the inter-intra prediction and transform mode, the intra prediction and transform mode, or the transform encoding mode; and then the encoding mode is finally transmitted to the decoding side which then reconstructs the point cloud attributes by using the encoding mode. In the present solution, the key is to introduce an encoding mode for each RAHT encoding layer, use the rate-distortion optimization selection algorithm at the encoding side to obtain the optimal encoding mode, and then reconstruct the point cloud attributes by using the decoding mode at the decoding side. The encoding mode of each layer is currently stored in the ABH, and the decoding mode of the RAHT encoding layer is obtained from the ABH at the decoding side, where the manner for encoding the parameter is not limited here.

Table 1 illustrates the test results of the attribute encoding efficiency using the embodiments of the present disclosure. It can be seen that after introducing the rate-distortion optimization algorithm, for sequences capable of using the attribute inter prediction, the attribute encoding pixel depth (bit per pixel, BPP) is reduced by approximately 3.9%, significantly improving the encoding efficiency of point cloud attributes.

TABLE 1
which illustrates test results of attribute encoding efficiency
using the embodiments of the present disclosure

| Frame Index | Anchor | Proposal | BPP |
|---|---|---|---|
| 0 | 21376 | 21128 | 98.8% |
| 1 | 18313 | 17632 | 96.2% |
| 2 | 17933 | 17175 | 95.7% |
| 3 | 17745 | 16698 | 94.1% |
| 4 | 18151 | 17516 | 96.5% |
| 5 | 17902 | 17341 | 96.8% |
| 6 | 17500 | 16519 | 94.3% |
| 7 | 18072 | 17422 | 96.4% |

In the embodiments of the present disclosure, the description of the syntax elements in the attribute brick header information (attribute data unit header syntax) is illustrated in Table 2.

TABLE 2

| attribute_data_unit_header( ) { | Descriptor | Semantics |
|---|---|---|
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if(lod_dist_log2_offset_present) | | |
| lod_dist_log2_offset | se(v) | 10.6.2 |
| if(last_comp_pred_enabled && AttrDim == 3) | | |
| for(dpth = 0; dpth ≤ lod_max_levels_minus1; | | |
| dpth++) | | |
| last_comp_pred_coeff_diff[dpth] | se(v) | 10.6.10.1 |
| if(inter_comp_pred_enabled) | | |
| for(dpth = 0; dpth ≤ lod_max_levels_minus1; | | |
| dpth++) | | |
| for(c = 1; c < AttrDim; c++) | | |
| inter_comp_pred_coeff_diff[dpth][c] | se(v) | 10.6.10.1 |
| if(attr_qp_offsets_present) | | |
| for(qc = 0; qc < Min(2, AttrDim); qc++) | | |
| attr_qp_offset[qc] | se(v) | 10.7.1 |
| attr_qp_layers_present | u(1) | 10.7.1 |
| if(attr_qp_layers_present) { | | |
| attr_qp_layer_cnt_minus1 | ue(v) | 10.7.1 |
| for(dpth = 0; dpth ≤ attr_qp_layer_cnt_minus1; | | |
| dpth++) | | |
| for(qc = 0; qc < Min(2, AttrDim); qc++) | | |
| attr_qp_layer_offset[dpth][ qc] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(i = 0; i < attr_qp_region_cnt; i++) { | | |
| if(-attr_coord_conv_enabled) { | | |
| for(k = 0; k <3; k++) | | |
| attr_qp_region_origin_xyz[i][k] | u(v) | 10.7.1 |
| for(k = 0; k < 3; k++) | | |
| attr_qp_region_size_minus1_xyz[i][k] | u(v) | 10.7.1 |
| } else { | | |
| for(k = 0; k < 3; k++) | | |
| attr_qp_region_origin_rpi[i][k] | u(v) | 10.7.1 |
| for(k = 0; k < 3; k++) | | |
| attr_qp_region_size_minus1_rpi[i][k] | u(v) | 10.7.1 |
| } | | |
| for(ps = 0; ps < Min(2, AttrDim); ps++) | | |
| attr_qp_region_offset[ i][ps] | se(v) | 10.7.1 |
| } | | |
| disableAttrInterPred | u(1) | |
| if(attr_coding_type == 0&& !disableAttrInterPred) | | |
| if(raht_prediction_enabled){ | | |
| attr_code_mode_cnt | ue(v) | |
| for(i = 0; i < attr_code_mode_cnt; i++) | | |
| attr_code_mode[i] | u(1) | |
| } | | |
| byte_alignment( ) | | |
| } | | |

The attr_coding_type indicates an attribute encoding type. The attr_coding_type==0 may be understood as indicating that the current slice uses RAHT encoding. The disableAttrInterPred is used to indicate whether a mode selection is enabled for the inter prediction mode; when false, it indicates that the mode selection is enabled for the inter prediction mode, and when true, it indicates that the mode selection is disabled for the inter prediction mode. The raht_prediction_enabled is used to indicate whether a mode selection is enabled for the intra prediction mode; when true, it indicates that the mode selection is enabled for the intra prediction mode, and when false, it indicates that the mode selection is disabled for the intra prediction mode. The attr_code_mode[i] is used to indicate a target encoding mode corresponding to an i-th layer of the current slice.

By adopting the above technical solution, when performing the region adaptive hierarchical transform (RAHT) encoding or RAHT decoding, one or more new encoding and decoding modes are introduced, and the mode selection is performed by comprehensively considering the neighborhood geometry distribution characteristics and the neighborhood attribute distribution characteristics of the node of the current layer, to provide an optimal encoding and decoding mode for the current node, thereby improving the efficiency of RAHT attribute encoding and decoding.

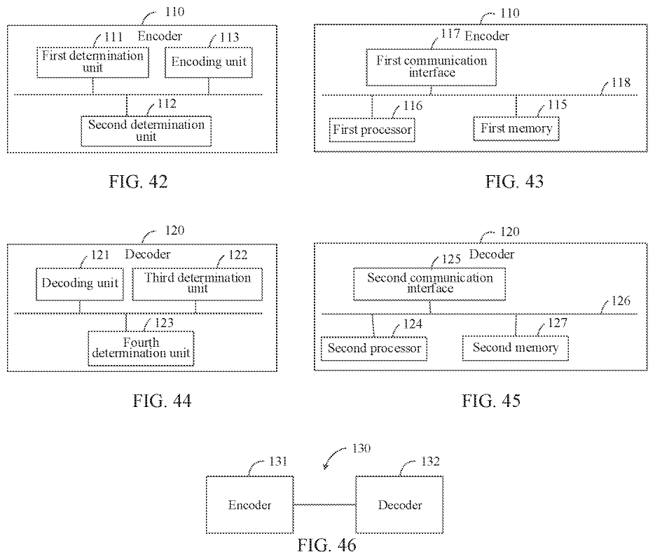

In yet another embodiment of the present disclosure, based on the same inventive concept as the above embodiments, referring to FIG. 42, a schematic structural diagram of a composition of an encoder provided in an embodiment of the present disclosure is illustrated. As illustrated in FIG. 42, the encoder 110 may include a first determination unit 111, a second determination unit 112, and an encoding unit 113, where
the first determination unit 111 is configured to determine a first syntax element flag;
the first determination unit 111 is further configured to: in a case of determining, according to the first syntax element flag, to enable a mode selection when region adaptive hierarchical transform encoding is performed on a current layer, determine neighborhood geometry distribution information of a node of the current layer;
the first determination unit 111 is further configured to: in response to the neighborhood geometry distribution information meeting a first prediction condition, determine neighborhood attribute distribution information of the node of the current layer;
the second determination unit 112 is configured to determine a target encoding mode of the node of the current layer from candidate encoding modes according to the neighborhood attribute distribution information, where the candidate encoding modes include: an attribute prediction and transform mode, and an attribute transform mode;
the second determination unit 112 is configured to: perform attribute encoding on the node of the current layer according to the target encoding mode, to determine an attribute reconstructed value of the node of the current layer; and
the encoding unit 113 is configured to encode the first syntax element flag, and signal obtained encoded bits into a bitstream.

It can be understood that various function units of the encoder also perform the encoding method of any of the above embodiments, which are not repeated here.

It should be understood that, in the embodiments of the present disclosure, a “unit” may be a part of a circuit, a part of a processor, a part of a program or software, and so on. Certainly, the “unit” may also be a module or be non-modular. In addition, various components in the embodiments may be integrated into a single processing unit, or various units may physically exist in a separate manner, or two or more units may be integrated into a single unit. The integrated unit may be implemented either in the form of hardware or in the form of software functional modules.

If the integrated unit is implemented in the form of software functional modules and is not sold or used as an independent product, it may be stored in a non-transitory computer-readable storage medium. Based on such an understanding, the technical solution of the embodiments essentially, or the part thereof that contributes to the prior art, or all or part of the technical solution, may be embodied in the form of a software product. The computer software product is stored in a storage medium and includes a number of instructions for enabling a computer device (which may be a personal computer, a server, or a network device, etc.) or a processor to perform all or some of the operations of the methods in the embodiments. The storage medium includes various media capable of storing program code, such as a USB flash drive, a portable hard drive, a read-only memory (ROM), a random access memory (RAM), a magnetic disk, or an optical disc.

Accordingly, the embodiments of the present disclosure provide a non-transitory computer-readable storage medium, which is applied to the encoder 110. The non-transitory computer-readable storage medium stores a computer program that, when executed by a first processor, implements the method of any one of the above embodiments.

Based on the composition of the encoder 110 and the non-transitory computer-readable storage medium, referring to FIG. 43, a hardware structural diagram of the encoder 110 provided in the embodiments of the present disclosure is illustrated. As illustrated in FIG. 43, the encoder 110 may include: a first memory 115, a first processor 116, a first communication interface 117, and a first bus system 118. The first memory 115, the first processor 116, and the first communication interface 117 are coupled together via the first bus system 118. It can be understood that the first bus system 118 is configured to implement connection and communication between these components. In addition to a data bus, the first bus system 118 further includes a power bus, a control bus, and a status signal bus. However, for the sake of clarity, all various buses are labeled as the first bus system 118 in FIG. 20, where
the first communication interface 117 is configured to receive or transmit a signal in the process of transmitting or receiving information with other external network elements;
the first memory 115 is configured to store a computer program executable on a first processor; and
the first processor 116 is configured to, when executing the computer program, perform:
determine a first syntax element flag,
in a case of determining, according to the first syntax element flag, to enable a mode selection when region adaptive hierarchical transform encoding is performed on a current layer, determine neighborhood geometry distribution information of a node of the current layer,
in response to the neighborhood geometry distribution information meeting a first prediction condition, determine neighborhood attribute distribution information of the node of the current layer,
determining a target encoding mode of the node of the current layer from candidate encoding modes according to the neighborhood attribute distribution information, where the candidate encoding modes include: an attribute prediction and transform mode, and an attribute transform mode;
perform attribute encoding on the node of the current layer according to the target encoding mode, to determine an attribute reconstructed value of the node of the current layer; and
encode the first syntax element flag, and signal obtained encoded bits into a bitstream.

It may be understood that the first memory 115 in the embodiments of the present disclosure may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM), which acts as external cache memory. By way of example and not limitation, many forms of RAM are available, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), or a direct rambus RAM (DRRAM). The first memory 115 of the systems and methods described herein is intended to include, but not be limited to, these and any other suitable types of memories.

The first processor 116 may be an integrated circuit chip with signal processing capabilities. During implementation, various operations of the above method may be completed by an integrated logic circuit of hardware in the first processor 116 or by instructions in software form. The first processor 116 may be a general-purpose processor, a digital signal processor (DSP), an application specific integrated circuit (ASIC), a field programmable gate array (FPGA), or other programmable logic devices, discrete gate or transistor logic devices, or discrete hardware components. The various methods, operations and logic diagrams disclosed in the embodiments of the present application may be implemented or executed. The general-purpose processor may be a microprocessor, or the processor may be any traditional processor or the like. The operations of the method disclosed in the embodiments of the present application may be directly implemented by a hardware decoding processor, or implemented by a combination of hardware and software modules in the decoding processor. The software module may be located in a storage medium mature in the art, such as a random access memory, a flash memory, a read-only memory, a programmable read-only memory, or an electrically erasable programmable memory, a register, or the like. The storage medium is located in the first memory 115, and the first processor 116 reads the information in the first memory 115 and completes the operations of the above method in combination with its hardware.

It should be understood that the embodiments described herein may be implemented by hardware, software, firmware, middleware, microcode, or a combination thereof. For hardware implementation, the processing unit may be implemented in one or more application specific integrated circuits (ASICs), digital signal processors (DSPs), DSP devices (DSPDs), programmable logic devices (PLDs), field-programmable gate arrays (FPGAs), general-purpose processors, controllers, microcontrollers, microprocessors, other electronic units for performing the functions described in the present application, or combinations thereof. For software implementation, the technology described in the present application may be implemented through modules (e.g., procedures, functions) that perform the functions described in the present application. The software codes may be stored in a memory and executed by a processor. The memory may be implemented within the processor or external to the processor.

Optionally, as another embodiment, the first processor 116 is further configured to, when running the computer program, perform the encoding method of any of the above embodiments.

The embodiments provide an encoder. In the encoder, through performing the mode selection by comprehensively considering the neighborhood geometry distribution characteristics and neighborhood attribute distribution characteristics of node of the current layer, the optimal encoding mode is provided for the current node, thereby improving the efficiency of RAHT attribute encoding

The embodiments of the present disclosure further provide a non-transitory computer-readable storage medium, which stores a bitstream generated by the encoding method of any of the above embodiments.

The embodiments of the present disclosure further provide a bitstream, which is generated by performing bit encoding according to information to be encoded; where the information to be encoded includes at least one of: a first syntax element flag, a second syntax element flag, a third syntax element flag, or coefficient residual information.

In yet another embodiment of the present disclosure, based on the same inventive concept as the above embodiments, referring to FIG. 44, a schematic structural diagram of a composition of a decoder provided in an embodiment of the present disclosure is illustrated. As illustrated in FIG. 44, the decoder 120 may include: a decoding unit 121, a third determination unit 122, and a fourth determination unit 123, where
the decoding unit 121 is configured to decode a bitstream to determine a first syntax element flag;
the third determination unit 122 is configured to: in a case of determining, according to the first syntax element flag, to enable a mode selection when region adaptive hierarchical transform decoding is performed on a current layer, determine neighborhood geometry distribution information of a node of the current layer;
the third determination unit 122 is further configured to: in response to the neighborhood geometry distribution information meeting a first prediction condition, determine neighborhood attribute distribution information of the node of the current layer;
the fourth determination unit 123 is configured to determine a target decoding mode of the node of the current layer from candidate decoding modes according to the neighborhood attribute distribution information, where the candidate decoding modes include: an attribute prediction and transform mode, and an attribute transform mode; and
the fourth determination unit 123 is further configured to perform attribute decoding on the node of the current layer according to the target decoding mode, to determine an attribute reconstructed value of the node of the current layer.

It can be understood that various functional units of the decoder also performs the decoding method of any of the above embodiments, which are not repeated here.

It should be understood that in the embodiment, a “unit” may be a part of a circuit, a part of a processor, a part of a program or software, and so on. Certainly, the “unit” may also be a module or be non-modular. In addition, various components in the embodiments may be integrated into a single processing unit, or various units may physically exist in a separate manner, or two or more units may be integrated into a single unit. The integrated unit may be implemented either in the form of hardware or in the form of software functional modules.

If the integrated unit is implemented in the form of software functional module and is not sold or used as an independent product, it may be stored in a non-transitory computer-readable storage medium. Based on such an understanding, the embodiment provides a non-transitory computer-readable storage medium, which is applied to the decoder 120. The non-transitory computer-readable storage medium stores a computer program that, when executed by a second processor, implements the method of any one of the above embodiments.

Based on the composition of the decoder 120 and the non-transitory computer-readable storage medium, referring to FIG. 45, a hardware structural diagram of the decoder 120 provided in the embodiments of the present disclosure is illustrated. As illustrated in FIG. 45, the decoder 120 may include: a second memory 127, a second processor 124, a second communication interface 125, and a second bus system 126. The second memory 127, the second processor 124, and the second communication interface 125 are coupled together via the second bus system 126. It can be understood that the second bus system 126 is configured to implement connection and communication between these components. In addition to a data bus, the second bus system 126 further includes a power bus, a control bus, and a status signal bus. However, for the sake of clarity, all various buses are labeled as the second bus system 126 in FIG. 22, where the second communication interface 125 is configured to receive or transmit a signal in the process of transmitting or receiving information with other external network elements; and the second memory 127 is configured to store a computer program executable on the second processor.

In some embodiments, the second processor 124 is configured to, when running the computer program, perform the following operations:
decoding a bitstream to determine a first syntax element flag;
in a case of determining, according to the first syntax element flag, to enable a mode selection when region adaptive hierarchical transform decoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target decoding mode of the node of the current layer from candidate decoding modes according to the neighborhood attribute distribution information, where the candidate decoding modes include: an attribute prediction and transform mode, and an attribute transform mode; and
performing attribute decoding on the node of the current layer according to the target decoding mode, to determine an attribute reconstructed value of the node of the current layer.

Optionally, as another embodiment, the second processor 124 is further configured to, when running the computer program, perform the method of any of the above embodiments.

It should be understood that the hardware function of the second memory 127 is similar to that of the first memory 115, and the hardware function of the second processor 124 is similar to that of the first processor 116, which will not be repeated here.

The embodiments provide a decoder. In the decoder, through performing the mode selection by comprehensively considering the neighborhood geometry distribution characteristics and the neighborhood attribute distribution characteristics of the node of the current layer, the optimal decoding mode is provided for the current node, thereby improving the efficiency of RAHT attribute decoding.

In yet another embodiment of the present disclosure, referring to FIG. 46, a schematic structural diagram of a composition of an encoding and decoding system provided in the embodiment of the present disclosure. As illustrated in FIG. 46, the encoding and decoding system 130 may include an encoder 131 and a decoder 132.

In the embodiments of the present disclosure, the encoder 131 may be the encoder described in any of the above embodiments, and the decoder 132 may be the decoder described in any of the above embodiments.

It should be noted that in the present disclosure, the terms “including/comprising” “containing” or any other variation thereof are intended to cover a non-exclusive inclusion, such that a process, method, article, or apparatus that includes a list of elements does not include only those elements but may include other elements not expressly listed or elements inherent to such process, method, article, or apparatus. Without more limitations, an element limited by the sentence “include/comprises a . . . ” does not preclude the existence of additional identical elements in the process, method, article, or apparatus that includes the element.

The numbering of the above embodiments of the present disclosure is for description only and does not represent the superiority or inferiority of the embodiments.

The methods disclosed in the several method embodiments provided in the present disclosure may be arbitrarily combined without conflict to obtain new method embodiments.

The features disclosed in the several product embodiments provided in the present disclosure may be arbitrarily combined without conflict to obtain new product embodiments.

The features disclosed in the several method or device embodiments provided in the present disclosure may be arbitrarily combined without conflict to obtain new method embodiments or device embodiments.

The foregoing descriptions are merely exemplary implementations of the present disclosure, but the protection scope of the present disclosure is not limited thereto. Any change or substitution that would be readily conceived by a person skilled in the art shall fall within the protection scope of the present disclosure, provided that such change or substitution remains within the technical scope disclosed in the present disclosure. Therefore, the protection scope of the present disclosure shall be subject to the protection scope of the claims.

### INDUSTRIAL APPLICABILITY

The embodiments of the present disclosure provide an encoding method, a decoding method, an encoder, a decoder, and a storage medium. The method includes: in a case of determining to enable a mode selection when region adaptive hierarchical transform decoding is performed on a current layer, determining neighborhood geometry distribution information of a node of the current layer; in response to the neighborhood geometry distribution information meeting a first prediction condition, determining neighborhood attribute distribution information of the node of the current layer; determining a target decoding mode of the node of the current layer from candidate decoding modes according to the neighborhood attribute distribution information; and performing attribute decoding on the node of the current layer according to the target decoding mode, to determine an attribute reconstructed value of the node of the current layer. Through performing the mode selection by comprehensively considering the neighborhood geometry distribution characteristics and the neighborhood attribute distribution characteristics of the node of the current layer, the optimal encoding and decoding mode is provided for the current node, thereby improving the efficiency of RAHT attribute encoding and decoding.

What is claimed is:

1. A decoding method, applied in a decoder and comprising:
decoding a bitstream to determine a first syntax element flag;
in a case of determining, according to the first syntax element flag, to enable a mode selection when region adaptive hierarchical transform (RAHT) decoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target decoding mode of the node of the current layer from candidate decoding modes according to the neighborhood attribute distribution information, wherein the candidate decoding modes comprise: an attribute prediction and transform mode, and an attribute transform mode; and
performing attribute decoding on the node of the current layer according to the target decoding mode, to determine an attribute reconstructed value of the node of the current layer.

2. The method according to claim 1, further comprising:
decoding the bitstream to determine a second syntax element flag;
determining, according to the second syntax element flag, a target prediction mode for the mode selection enabled at the current layer; and
determining the candidate decoding modes according to the target prediction mode.

3. The method according to claim 2, wherein determining the neighborhood attribute distribution information of the node of the current layer comprises:
determining an attribute reconstructed value of a first reference node of the node of the current layer according to the target prediction mode; and
determining the neighborhood attribute distribution information of the node of the current layer according to the attribute reconstructed value of the first reference node.

4. The method according to claim 3, wherein
in a case where the target prediction mode is an intra prediction mode, the first reference node comprises at least one of: a neighborhood node of a parent node, or a reconstructed neighborhood node at a same layer;
in a case where the target prediction mode is an inter prediction mode, the first reference node comprises at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer; and
in a case where the target prediction mode is an inter-intra prediction mode, the first reference node comprises at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer.

5. The method according to claim 4, wherein the neighborhood attribute distribution information comprises a difference between the attribute reconstructed value of the first reference node and an attribute reconstructed value of the parent node, and a difference between the attribute reconstructed value of the first reference node and an attribute reconstructed value of the collocated parent node.

6. The method according to claim 3, wherein determining the target decoding mode of the node of the current layer from the candidate decoding modes according to the neighborhood attribute distribution information comprises:
in response to the neighborhood attribute distribution information meeting a second prediction condition, determining that the target decoding mode is the attribute prediction and transform mode; and
in response to the neighborhood attribute distribution information not meeting the second prediction condition, determining that the target decoding mode is the attribute transform mode.

7. The method according to claim 1, wherein determining the neighborhood attribute distribution information of the node of the current layer comprises:
decoding the bitstream to determine the neighborhood attribute distribution information,
wherein the neighborhood attribute distribution information comprises a third syntax element flag for indicating the target decoding mode,
wherein the third syntax element flag is used to indicate a target decoding mode of the current layer; or the third syntax element flag is used to indicate a target decoding mode of a coefficient group of the current layer.

8. The method according to claim 1, wherein the first syntax element flag, a second syntax element flag, and a third syntax element flag are set in an attribute brick header (ABH) information parameter set.

9. The method according to claim 2, wherein determining the neighborhood geometry distribution information of the node of the current layer comprises:
determining the neighborhood geometry distribution information according to the target prediction mode.

10. The method according to claim 1, wherein in a case where the target decoding mode is the attribute prediction and transform mode, performing the attribute decoding on the node of the current layer according to the target decoding mode to determine the attribute reconstructed value of the node of the current layer comprises:
determining an attribute prediction value of the node of the current layer;
performing an attribute transform according to the attribute prediction value of the node of the current layer, to obtain an alternating current (AC) coefficient prediction value of the node of the current layer;
decoding the bitstream to determine an AC coefficient residual value of the node of the current layer;
determining an AC coefficient reconstructed value of the node of the current layer according to the AC coefficient prediction value and the AC coefficient residual value of the node of the current layer; and
performing an inverse transform according to the AC coefficient reconstructed value and a direct current (DC) coefficient reconstructed value of a parent node of the node of the current layer, to determine the attribute reconstructed value of the node of the current layer.

11. The method according to claim 10, wherein determining the attribute prediction value of the node of the current layer comprises:
in a case where the attribute prediction and transform mode is an attribute intra prediction, determining a first intra prediction mode; and
determining a first attribute prediction value of the node of the current layer according to the first intra prediction mode;
or
in a case where the attribute prediction and transform mode is an attribute inter prediction, determining a first inter prediction mode; and
determining a second attribute prediction value of the node of the current layer according to the first inter prediction mode;
or
in a case where the attribute prediction and transform mode is an attribute inter-intra prediction, determining a first inter-intra prediction mode; and
determining a third attribute prediction value of the node of the current layer according to the first inter-intra prediction mode.

12. The method according to claim 11, wherein
the first intra prediction mode comprises at least one of: an intra parent node prediction mode, an intra same-layer node prediction mode, or an intra parent node and same-layer node prediction mode;
the first inter prediction mode comprises at least one of: an inter collocated parent node prediction mode, an inter collocated node prediction mode, or an inter collocated parent node and collocated node prediction mode; and
the first inter-intra prediction mode comprises at least one of: an intra prediction mode, an inter prediction mode, or an inter-intra fusion prediction mode.

13. The method according to claim 1, wherein in a case where the target decoding mode is the attribute transform mode, performing the attribute decoding on the node of the current layer according to the target decoding mode, to determine the attribute reconstructed value of the node of the current layer comprises:
decoding the bitstream to determine an AC coefficient reconstructed value of the node of the current layer; and
performing an inverse transform according to the AC coefficient reconstructed value and a DC coefficient reconstructed value of a parent node of the node of the current layer, to determine the attribute reconstructed value of the node of the current layer.

14. The method according to claim 1, further comprising:
in response to the neighborhood geometry distribution information not meeting the first prediction condition, determining that the target decoding mode of the node of the current layer is the attribute transform mode; and
performing attribute decoding on the node of the current layer according to the attribute transform mode, to determine the attribute reconstructed value of the node of the current layer.

15. An encoding method, applied in an encoder and comprising:
determining a first syntax element flag;
in a case of determining, according to the first syntax element flag, to enable a mode selection when region adaptive hierarchical transform (RAHT) encoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target encoding mode of the node of the current layer from candidate encoding modes according to the neighborhood attribute distribution information, wherein the candidate encoding modes comprise: an attribute prediction and transform mode, and an attribute transform mode;
performing attribute encoding on the node of the current layer according to the target encoding mode, to determine an attribute reconstructed value of the node of the current layer; and
encoding the first syntax element flag, and signalling obtained encoded bits into a bitstream.

16. The method according to claim 15, further comprising:
determining, according to a second syntax element flag, a target prediction mode for the mode selection enabled at the current layer;
determining the candidate encoding modes according to the target prediction mode; and
encoding the second syntax element flag, and signalling obtained encoded bits into the bitstream.

17. The method according to claim 16, wherein determining the neighborhood attribute distribution information of the node of the current layer comprises:
determining an attribute reconstructed value of a first reference node of the node of the current layer according to the target prediction mode; and
determining the neighborhood attribute distribution information of the node of the current layer according to the attribute reconstructed value of the first reference node.

18. The method according to claim 17, wherein
in a case where the target prediction mode is an intra prediction mode, the first reference node comprises at least one of: a neighborhood node of a parent node, or a reconstructed neighborhood node at a same layer;
in a case where the target prediction mode is an inter prediction mode, the first reference node comprises at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer; and
in a case where the target prediction mode is an inter-intra prediction mode, the first reference node comprises at least one of: a collocated parent node in a reference picture and a parent node, a neighborhood node of a collocated parent node in a reference picture and a neighborhood node of a parent node, or a reconstructed collocated neighborhood node at a same layer in a reference picture and a reconstructed neighborhood node at a same layer.

19. The method according to claim 18, wherein the neighborhood attribute distribution information comprises a difference between the attribute reconstructed value of the first reference node and an attribute reconstructed value of the parent node, and a difference between the attribute reconstructed value of the first reference node and an attribute reconstructed value of the collocated parent node.

20. A non-transitory computer-readable storage medium, wherein the non-transitory computer-readable storage medium stores a computer program and a bitstream, wherein the computer program, when executed, implements following operations to generate the bitstream:
determining a first syntax element flag;
in a case of determining, according to the first syntax element flag, to enable a mode selection when region adaptive hierarchical transform (RAHT) encoding is performed on a current layer, determining neighborhood geometry distribution information of a node of the current layer;
in response to the neighborhood geometry distribution information meeting a first prediction condition, determining neighborhood attribute distribution information of the node of the current layer;
determining a target encoding mode of the node of the current layer from candidate encoding modes according to the neighborhood attribute distribution information, wherein the candidate encoding modes comprise: an attribute prediction and transform mode, and an attribute transform mode;
performing attribute encoding on the node of the current layer according to the target encoding mode, to determine an attribute reconstructed value of the node of the current layer; and
encoding the first syntax element flag, and signalling obtained encoded bits into the bitstream.
